(19) United States
(12) Patent Application Publication
(10) Pub. No.: US 2018/0258346 A1
(43) Pub. Date: Sep. 13, 2018

(54) LIQUID-CRYSTALLINE MEDIA HAVING HOMEOTROPIC ALIGNMENT

(71) Applicant: MERCK PATENT GMBH, DARMSTADT (DE)

(72) Inventors: Yong-Kuk YUN, Gyeonggi-Do (KR); Min-Ok JIN, Gyeonggi-Do (KR); Hyun-Jin YOON, Gyeonggi-Do (KR); Mi-Nam PARK, Pyeongtaek-Si (KR); Rocco FORTTE, Frankfurt Am Main (DE); Graziano ARCHETTI, Darmstadt (DE); Thorsten KODEK, Moerfelden-Walldorf (DE); Izumi SAITO, Darmstadt (DE)

(73) Assignee: MERCK PATENT GMBH, DARMSTADT (DE)

(21) Appl. No.: 15/760,522

(22) PCT Filed: Aug. 16, 2016
(86) PCT No.: PCT/EP2016/001397

§ 371 Date: Mar. 15, 2018

(30) Foreign Application Priority Data
Sep. 15, 2015 (EP) 15185271.2

(51) Int. Cl. C09K 19/12; C09K 19/30; C09K 19/54; C09K 19/56

(52) U.S. Cl. CPC C09K 19/12; C09K 19/3003; C09K 2019/0448; C09K 19/56; C09K 19/542

(57) ABSTRACT

The present invention relates to liquid-crystalline media (LC media) comprising a low-molecular-weight component, a self-alignment additive comprising a thiol group and optionally a polymerizable component. The self-alignment additives effect homeotropic (vertical) alignment of the LC media at a surface or the cell walls of a liquid-crystal display (LC display). The invention therefore also encompasses LC displays having homeotropic alignment of the liquid-crystalline medium (LC medium) without alignment layers. The invention discloses novel structures for self-alignment additives which have a thiol functional groups.

The present invention relates to liquid-crystalline media (LC media) comprising a low-molecular-weight component, a self-alignment additive comprising a thiol group and optionally a polymerizable component. The self-alignment additives effect homeotropic (vertical) alignment of the LC media at a surface or the cell surfaces of a liquid-crystal display (LC display). The invention therefore also encompasses LC displays having homeotropic alignment of the liquid-crystalline medium (LC medium) without alignment layers.

The invention discloses novel structures for self-alignment additives which have a thiol functional groups.

The principle of electrically controlled birefringence, the ECB effect or also DAP (deformation of aligned phases) effect, was described for the first time in 1971 (M. F. Schieckel and K. Fahrenschon, “Deformation of nematic liquid crystals with vertical orientation in electrical fields”, Appl. Phys. Lett. 19 (1971), 3912). This was followed by papers by J. F. Kahn (Appl. Phys. Lett. 20 (1972), 1193) and G. Labrunie and J. Robert (J. Appl. Phys. 44 (1973), 4869).

The papers by J. Robert and F. Clerc (SID 80 Digest Techn. Papers (1980), 30), J. Duchene (Displays 7 (1986), 3) and H. Schad (SID 82 Digest Techn. Papers (1982), 244) showed that liquid-crystalline phases must have high values for the ratio of the elastic constants K₃/K₁, high values for the optical anisotropy Δn and values for the dielectric anisotropy of Δε≤−0.5 in order to be suitable for use in high-information display elements based on the ECB effect. Electro-optical display elements based on the ECB effect have homeotropic edge alignment (VA technology=vertically aligned).

Displays which use the ECB effect, as so-called VAN (vertically aligned nematic) displays, for example in the MVA (multi-domain vertical alignment, for example: Yoshide, H. et al., paper 3.1: “MVA LCD for Notebook or Mobile PCs . . . ”, SID 2004 International Symposium, Digest of Technical Papers, XXXV, Book I, pp. 6 to 9, and Liu, C. T. et al., paper 15.1: “A 46-inch TFT-LCD HDTV Technology . . . ”, SID 2004 International Symposium, Digest of Technical Papers, XXXV, Book II, pp. 750 to 753), PVA (patterned vertical alignment, for example: Kim, Sang Soo, paper 15.4: “Super PVA Sets New Stateof-the-Art for LCD-TV”, SID 2004 International Symposium, Digest of Technical Papers, XXXV, Book II, pp. 760 to 763), and ASV (advanced super view, for example: Shigeta, Mitzuhiro and Fukuoka, Hirofumi, paper 15.2: “Development of High Quality LCDTV”, SID 2004 International Symposium, Digest of Technical Papers, XXXV, Book II, pp. 754 to 757) modes, have established themselves as one of the three more recent types of liquid-crystal display that are currently the most important, in particular for television applications, besides IPS (in-plane switching) displays (for example: Yeo, S. D., paper 15.3: “An LC Display for the TV Application”, SID 2004 International Symposium, Digest of Technical Papers, XXXV, Book II, pp. 758 & 759) and the longknown TN (twisted nematic) displays. The technologies are compared in general form, for example, in Souk, Jun, SID Seminar 2004, seminar M-6: “Recent Advances in LCD Technology”, Seminar Lecture Notes, M-6/1 to M-6/26, and Miller, Ian, SID Seminar 2004, seminar M-7: “LCD-Television”, Seminar Lecture Notes, M-7/1 to M-7/32. Although the response times of modern ECB displays have already been significantly improved by addressing methods with overdrive, for example: Kim, Hyeon Kyeong et al., paper 9.1: “A 57-in. Wide UXGA TFT-LCD for HDTV Application”, SID 2004 International Symposium, Digest of Technical Papers, XXXV, Book I, pp. 106 to 109, the achievement of video-compatible response times, in particular on switching of grey shades, is still a problem which has not yet been satisfactorily solved.

Considerable effort is associated with the production of VA displays having two or more domains of different preferential direction. It is an aim of this invention to simplify the production processes and the display devices themselves without giving up the advantages of VA technology, such as relatively short response times and good viewing-angle dependence.

VA displays which comprise LC media having positive dielectric anisotropy are described in S. H. Lee et al. Appl. Phys. Lett. (1997), 71, 2851-2853. These displays use interdigital electrodes arranged on a substrate surface (in-plane addressing electrode configuration having a comb-shaped structure), as employed, inter alia, in the commercially available IPS (in-plane switching) displays (as disclosed, for example, in DE 40 00 451 and EP 0 588 568), and have a homeotropic arrangement of the liquid-crystal medium, which changes to a planar arrangement on application of an electric field.

Further developments of the above-mentioned display can be found, for example, in K. S. Hun et al. J. Appl. Phys. (2008), 104, 084515 (DSIPS: ‘double-side in-plane switching’ for improvements of driver voltage and transmission), M. Jiao et al. App. Phys. Lett (2008), 92, 111101 (DFFS: ‘dual fringe field switching’ for improved response times) and Y. T. Kim et al. Jap. J. App. Phys. (2009), 48, 110205 (VAS: ‘viewing angle switchable’ LCD). In addition, VA-IPS displays are also known under the name positive-VA and HT-VA.

In all such displays (referred to below in general as VA-IPS displays), an alignment layer is applied to both substrate surfaces for homeotropic alignment of the LC medium; the production of this layer has hitherto been associated with considerable effort.

It is an aim of this invention to simplify the production processes themselves without giving up the advantages of VA-IPS technology, such as relatively short response times, good viewing-angle dependence and high contrast.

Industrial application of these effects in electro-optical display elements requires LC phases, which have to satisfy a multiplicity of requirements. Particularly important here are chemical resistance to moisture, air, the materials in the substrate surfaces and physical influences, such as heat, infrared, visible and ultraviolet radiation and direct and alternating electric fields. Furthermore, industrially usable LC phases are required to have a liquid-crystalline mesophase in a suitable temperature range and low viscosity.

VA and VA-IPS displays are generally intended to have very high specific resistance at the same time as a large working-temperature range, short response times and a low threshold voltage, with the aid of which various grey shades can be produced.

In conventional VA and VA-IPS displays, a polyimide layer on the substrate surfaces ensures homeotropic alignment of the liquid crystal. The production of a suitable alignment layer in the display requires considerable effort. In addition, interactions of the alignment layer with the LC medium may impair the electrical resistance of the display. Owing to possible interactions of this type, the number of suitable liquid-crystal components is considerably reduced. It would therefore be desirable to achieve homeotropic alignment of the LC medium without polyimide.

The disadvantage of the active-matrix TN displays frequently used is due to their comparatively low contrast, the relatively high viewing-angle dependence and the difficulty of producing grey shades in these displays.

VA displays have significantly better viewing-angle dependences and are therefore used principally for televisions and monitors.

A further development is the so-called PS (polymer sustained) or PSA (polymer sustained alignment) displays, for which the term “polymer stabilized” is also occasionally used. The PSA displays are distinguished by the shortening of the response times without significant adverse effects on other parameters, such as, in particular, the favorable viewing-angle dependence of the contrast.

In these displays, a small amount (for example 0.3% by weight, typically <1% by weight) of one or more polymerizable compound(s) is added to the LC medium and, after introduction into the LC cell, is polymerized or crosslinked in situ, usually by UV photopolymerization, between the electrodes with or without an applied electrical voltage. The addition of polymerizable mesogenic or liquid-crystalline compounds, also known as reactive mesogens or “RMs”, to the LC mixture has proven particularly suitable. PSA technology has hitherto been employed principally for LC media having negative dielectric anisotropy.

Unless indicated otherwise, the term “PSA” is used below as representative of PS displays and PSA displays.

In the meantime, the PSA principle is being used in diverse classical LC displays. Thus, for example, PSA-VA, PSA-OCB, PSA-IPS, PSA-FFS and PSA-TN displays are known. The polymerization of the polymerizable compound(s) preferably takes place with an applied electrical voltage in the case of PSA-VA and PSA-OCB displays, and with or without an applied electrical voltage in the case of PSA-IPS displays. As can be demonstrated in test cells, the PS(A) method results in a ‘pretilt’ in the cell. In the case of PSA-OCB displays, for example, it is possible for the bend structure to be stabilized so that an offset voltage is unnecessary or can be reduced. In the case of PSA-VA displays, the pretilt has a positive effect on the response times. A standard MVA or PVA pixel and electrode layout can be used for PSA-VA displays. In addition, however, it is also possible, for example, to manage with only one structured electrode side and no protrusions, which significantly simplifies production and at the same time results in very good contrast at the same time as very good light transmission.

PSA-VA displays are described, for example, in JP 10-036847 A, EP 1 170 626 A2, U.S. Pat. No. 6,861,107, U.S. Pat. No. 7,169,449, US 2004/0191428 A1, US 2006/0066793 A1 and US 2006/0103804 A1. PSA-OCB displays are described, for example, in T.-J-Chen et al., Jpn. J. Appl. Phys. (2006), 45, 2702-2704 and S. H. Kim, L.-C-Chien, Jpn. J. Appl. Phys. (2004), 43, 7643-7647. PSA-IPS displays are described, for example, in U.S. Pat. No. 6,177,972 and Appl. Phys. Lett. (1999), 75(21), 3264. PSA-TN displays are described, for example, in Optics Express (2004), 12(7), 1221. PSA-VA-IPS displays are disclosed, for example, in WO 2010/089092 A1.

Like the conventional LC displays described above, PSA displays can be operated as active-matrix or passive-matrix (PM) displays. In the case of active-matrix displays, individual pixels are usually addressed by integrated, non-linear active elements, such as, for example, transistors (for example thin-film transistors or “TFTs”), while in the case of passive-matrix displays, individual pixels are usually addressed by the multiplex method, both methods being known from the prior art.

In particular for monitor and especially TV applications, optimization of the response times, but also of the contrast and luminance (i.e. also transmission), of the LC display is still sought after. The PSA method can provide crucial advantages here. In particular in the case of PSA-VA displays, a shortening of the response times, which correlate with a pretilt which can be measured in test cells, can be achieved without significant adverse effects on other parameters.

In the prior art, polymerizable compounds of the following formula, for example, are used for PSA-VA:

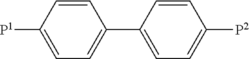

in which P denotes a polymerizable group, usually an acrylate or methacrylate group, as described, for example, in U.S. Pat. No. 7,169,449.

The effort for the production of a polyimide layer, treatment of the layer and improvement with bumps or polymer layers is relatively great. A simplifying technology which on the one hand reduces production costs and on the other hand helps to optimize the image quality (viewing-angle dependence, contrast, response times) would therefore be desirable.

The document WO 2012/038026 A1 describes self-aligning mesogens (self-alignment additives) containing a hydroxyl group or another anchor group which is located on a mesogenic basic structure comprising two or more rings.

However, the existing approaches for obtaining VA display applications without polyimide layer give rise to further improvements.

The present invention relates to an LC medium comprising a low-molecular-weight, non-polymerizable liquid-crystalline component and one or more compounds comprising a thiol group, which compounds are of the formula I,

R¹-[A³-Z³]ₘ-[A²-Z²]ₙ-A¹-R^{a} (I)
in which
A¹, A², A³ each, independently of one another, denote an aromatic, heteroaromatic, alicyclic or heterocyclic group, which may also contain fused rings, and which may also be mono- or polysubstituted by a group L or -Sp-P,
L in each case, independently of one another, denotes H, F, Cl, Br, I, —CN, —NO₂, —NCO, —NCS, —OCN, —SCN, —C(═O)N(R⁰)₂, —C(═O)R⁰, optionally substituted silyl, optionally substituted aryl or cycloalkyl having 3 to 20 C atoms, or straight-chain or branched alkyl, alkoxy, alkylcarbonyl, alkoxycarbonyl, alkylcarbonyloxy or alkoxycarbonyloxy having 1 to 25 C atoms, in which, in addition, one or more H atoms may each be replaced by F or Cl,
P denotes a polymerizable group,
Sp denotes a spacer group (also called spacer) or a single bond,
Z², Z³ in each case, independently of one another, denotes a single bond, —O—, —S—, —CO—, —CO—O—, —OCO—, —O—CO—O—, —OCH₂—, —CH₂O—, —SCH₂—, —CH₂S—, —CF₂O—, —OCF₂—, —CF₂S—, —SCF₂—, —(CH₂)ₙ₁—, —CF₂CH₂—, —CH₂CF₂—, —(CF₂)ₙ₁—, —CH═CH—, —CF═CF—, —C≡C—, —CH═CH—COO—, —OCO—CH═CH—, —(CR⁰R⁰⁰)ₙ₁—, —CH(-Sp-P)—, —CH₂CH(-Sp-P)—, or —CH(-Sp-P)CH(-Sp-P)—,
n1 denotes 1, 2, 3 or 4,
R⁰ in each case, independently of one another, denotes alkyl having 1 to 12 C atoms,
R⁰⁰ in each case, independently of one another, denotes H or alkyl having 1 to 12 C atoms,
m denotes 0, 1, 2, 3, 4, 5 or 6, preferably 0, 1, 2 or 3,
n denotes 0 or 1, preferably 1,
R¹, independently of one another, denotes H, halogen, straight-chain, branched or cyclic alkyl having 1 to 25 C atoms, in which, in addition, one or more non-adjacent CH₂ groups may each be replaced by —O—, —S—, —CO—, —CO—O—, —O—CO—, or —O—CO—O— in such a way that O and/or S atoms are not linked directly to one another and in which, in addition, one or more H atoms may each be replaced by F or Cl, or a group -Sp-P,
R^{a} denotes an anchor group of the formula

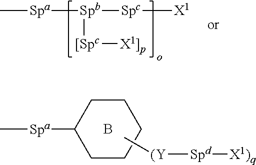

p denotes 1 or 2,
q denotes 2 or 3,
B denotes a substituted or unsubstituted ring system or condensed ring system, preferably a ring system selected from benzene, pyridine, cyclohexane, dioxane or tetrahydropyran,
Y, independently of one another,
   denotes —O—, —S—, —C(O)—, —C(O)O—, —OC(O)—, —NR¹¹— or a single bond,
o denotes 0 or 1, preferably 0,
X¹, independently of one another, denotes —SH, H, alkyl or fluoroalkyl,
   where at least one group X¹ denotes —SH,
R¹¹ denotes alkyl having 1 to 12 C atoms,
Sp^{a}, Sp^{c}, Sp^{d} each, independently of one another, denote a spacer group or a single bond,
and
Sp^{b} denotes a tri- or tetravalent group, preferably CH, N or C.

In addition, the LC medium preferably comprises a polymerized or polymerizable component, where the polymerized component is obtainable by polymerization of a polymerizable component. This component enables the LC medium and in particular its alignment to be stabilised and a desired pretilt optionally to be established. The polymerizable component preferably comprises one or more polymerizable compounds. Suitable polymerizable compounds are disclosed later below. Use is preferably made of those polymerizable compounds which are suitable for the PSA principle.

The invention furthermore relates to a liquid-crystal display (LC display) comprising an LC cell having two substrates and at least two electrodes, where at least one substrate is transparent to light and at least one substrate has one or two electrodes, and a layer of an LC medium according to the invention located between the substrates. The LC display is preferably one of the PSA type.

The invention furthermore relates to novel compounds of the formula I, as disclosed above and below, which are characterized in that they have three or more rings, for example, compounds of the formula I in which n=1 and m≥1.

The invention furthermore relates to a method for effecting homeotropic alignment of a LC medium with respect to a surface delimiting the LC medium comprising adding to said medium one or more compounds of formula (I).

A further aspect of the present invention is a process for the preparation of an LC medium according to the invention, which is characterized in that one or more self-alignment additives (compounds of the formula I) are mixed with a low-molecular-weight, liquid-crystalline component, and optionally one or more polymerizable compounds and optionally a further self-alignment additive (for example of the formula IX, see below) and/or any other additional desired additives are added.

The invention furthermore relates to a process for the production of an LC display comprising an LC cell having two substrates and at least two electrodes, where at least one substrate is transparent to light and at least one substrate has one or two electrodes, comprising the process steps:
filling of the cell with an LC medium according to the invention,
optionally heating, and
polymerization of any optional polymerizable component(s), optionally with application of a voltage to the cell or under the action of an electric field, in one or more process steps.

The use according to the invention of the self-alignment additives as additives of LC media is not tied to particular LC media. The LC medium or the non-polymerizable component present therein can have positive or negative dielectric anisotropy, preferably it has a negative one. The LC medium is preferably nematic, since most displays based on the VA principle comprise nematic LC media.

The self-alignment additive is introduced into the LC medium as additive. It effects homeotropic alignment of the liquid crystal with respect to the substrate surfaces (such as, for example, preferably a surface coated with ITO, or a metal surface). The self-alignment is supported by heating of the substrate and LC medium. At the same time the combination of additive and LC mixture is very stable to elevated temperatures. The heating process is one regularly found in processing of LCD panels, e.g. for end-curing the sealing. No additional process step is needed. In view of the investigations in connection with this invention, it appears that the thiol anchor group interacts with the substrate surface. This causes the alignment additive on the substrate surface to align and induce homeotropic alignment of the liquid crystal. In this view, the anchor group should be sterically accessible, i.e. not surrounded by tertbutyl groups.

The LC cell of the LC display according to the invention preferably has no alignment layer, in particular no polyimide layer for homeotropic alignment of the LC medium. The polymerized component of the LC medium is in this connection not regarded as an alignment layer. In the case where an LC cell nevertheless has an alignment layer or a comparable layer, this layer is, in accordance with the invention, not the cause of the homeotropic alignment. Rubbing of, for example, polyimide layers is, in accordance with the invention, not necessary in order to achieve homeotropic alignment of the LC medium with respect to the substrate surface. The LC display according to the invention is preferably a VA display comprising an LC medium having negative dielectric anisotropy and electrodes arranged on opposite substrates. Alternatively, it is a VA-IPS display comprising an LC medium having positive dielectric anisotropy and interdigital electrodes arranged at least on one substrate.

The self-alignment additives according to the invention provide selectively homeotropic alignment to ITO surfaces or metal surfaces, but reveal no such effect on glass substrates. It is possible to achieve alignment only on selected surfaces by structuring glass with ITO in the desired shape. The LC media comprising the self-alignment additives according to the invention have advantageous stability at low temperature (LTS) compared to other self-alignment additives.

The use of the inventive additives provides a possible solution to avoid ODF (one drop filling) mura in LCD cells. The final alignment can be achieved by heating after the filling was made, which results in even less ODF mura. The advantageous property of the additives also prevents the pre-adsorption of the self-aligning additive inside glass bottles during delivery of the mixture to their place of use.

The self-alignment additive of the formula I is preferably employed in a concentration of less than 10% by weight, particularly preferably ≤5% by weight and very particularly ≤3% by weight. It is preferably employed in a concentration of at least 0.05% by weight, preferably at least 0.2% by weight. The use of 0.1 to 2.5% by weight of the self-alignment additive generally already results in completely homeotropic alignment of the LC layer in the case of the usual cell thicknesses (3 to 4 μm) with the conventional substrate materials and under the conventional conditions of the production processes of an LC display.

Besides the self-alignment additives of the formula I, the LC medium according to the invention may also comprise further self-alignment additives which have a different anchor group than the thiol group. In a preferred embodiment, the LC medium therefore comprises one or more self-alignment additives with a polar group (conventional self-alignment additives). The combined concentration of the self-alignment additives is preferably the values indicated above, i.e., for example, 0.1 to 5% by weight.

The further self-alignment additives can have a structure of the formula IX:

R¹²-[A³¹-Z³¹]ₘ-[A²¹Z²¹]ₙ-A¹-R^{a1} (IX)
in which
A¹¹, A²¹, A³¹ each, independently of one another, denote an aromatic, heteroaromatic, alicyclic or heterocyclic group, which may also contain fused rings, and which may also be mono- or polysubstituted by a group L or -Sp-P,
L in each case, independently of one another, denotes H, F, Cl, Br, I, —CN, —NO₂, —NCO, —NCS, —OCN, —SCN, —C(═O)N(R⁰)₂, —C(═O)R⁰, optionally substituted silyl, optionally substituted aryl or cycloalkyl having 3 to 20 C atoms, straight-chain or branched alkyl, alkoxy, alkylcarbonyl, alkoxycarbonyl, alkylcarbonyloxy or alkoxycarbonyloxy having 1 to 25 C atoms, in which, in addition, one or more H atoms may each be replaced by F or Cl,
P denotes a polymerizable group,
Sp denotes a spacer group or a single bond,
Z²¹, Z³¹ in each case, independently of one another, denotes a single bond, —O—, —S—, —CO—, —CO—O—, —OCO—, —O—CO—O—, —OCH₂—, —CH₂O—, —SCH₂—, —CH₂S—, —CF₂O—, —OCF₂—, —CF₂S—, —SCF₂—, —(CH₂)ₙ₁₁—, —CF₂CH₂—, —CH₂CF₂—, —(CF₂)ₙ₁₁—, —CH═CH—, —CF═CF—, —C≡C—, —CH═CH—COO—, —OCO—CH═CH—, —(CR⁰R⁰⁰)ₙ₁—, —CH(-Sp-P)—, —CH₂CH(-Sp-P)—, or —CH(-Sp-P)CH(-Sp-P)—,
n1 denotes 1, 2, 3 or 4,
R⁰ in each case, independently of one another, denotes alkyl having 1 to 12 C atoms,
R⁰⁰ in each case, independently of one another, denotes H or alkyl having 1 to 12 C atoms,
m denotes 0, 1, 2, 3, 4, 5 or 6, preferably 0, 1, 2 or 3,
n denotes 0 or 1, preferably 1,
R¹² denotes H, halogen, straight-chain, branched or cyclic alkyl having 1 to 25 C atoms, in which, in addition, one or more non-adjacent CH₂ groups may each be replaced by —O—, —S—, —CO—, —CO—O—, —O—CO—, or —O—CO—O— in such a way that O and/or S atoms are not linked directly to one another and in which, in addition, one or more H atoms may each be replaced by F or Cl,
   or a group -Sp-P,
R^{a1} denotes an anchor group of the formula

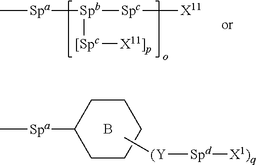

p denotes 1 or 2,
q denotes 2 or 3,
B denotes a substituted or unsubstituted ring system or condensed ring system, preferably a ring system selected from benzene, pyridine, cyclohexane, dioxane or tetrahydropyran,
Y, independently of one another, denotes —O—, —S—, —C(O)—, —C(O)O—, —OC(O)—, —NR¹¹— or a single bond,
o denotes 0 or 1,
X¹¹, independently of one another, denotes H, alkyl, fluoroalkyl, OH, NH₂, NHR¹¹, NR¹¹₂, C(O)OH, or —CHO, where at least one group X¹¹ denotes a radical selected from —OH, —NH₂, NHR¹¹, C(O)OH and —CHO,
R¹¹ denotes alkyl having 1 to 12 C atoms,
Sp^{a}, Sp^{c}, Sp^{d}, Sp each, independently of one another, denote a spacer group or a single bond,
and
Sp^{b} denotes a tri- or tetravalent group, preferably CH, N or C.

In contrast to the formula I, the formula IX comprises other conventional anchor groups, not containing thiol groups, preferably with a hydroxyl or amino group.

Preferred structures of the self-alignment additives I and IX are disclosed in the following parts.

The anchor groups R^{a} or R^{a1} contain by definition one, two or three groups X¹ or X¹¹ respectively, which are intended to serve as bonding element to a surface. The spacer groups are intended to form a flexible bond between the mesogenic group with rings and the group(s) X¹. The structure of the spacer groups is therefore very variable and in the most general case of the formula I not definitively defined. The person skilled in the art will recognize that a multiplicity of possible variations of chains and even combined with rings come into question here.

An anchor group of the formula

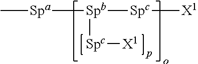

as defined above and below,
preferably stands for an anchor group selected from the following formulae:

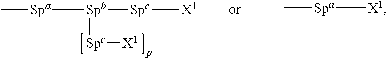

in which in each case independently the groups are as defined above and below,
particularly preferably for a group of the formulae

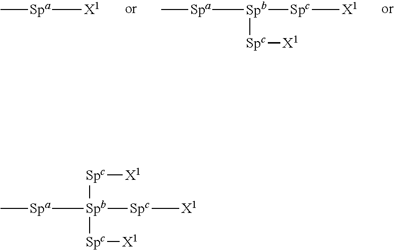

in which in each case independently the groups are as defined above and below, and X¹ can also be replaced for X¹¹ for anchor group R^{a1} in formula IX respectively.

For the compounds of formula (I) an anchor group of formula

-Sp^{a}-X¹

is preferred most.

In the above-depicted anchor groups preferably at least one of the groups Sp^{a} and Sp^{c} is present and is not a single group. In that sense an anchor group of formula R^{a}═—SH, which has no spacer group, is preferably not used.

Particularly preferred thiol group containing anchor groups of the formula R^{a} are selected from the following part-formulae, where the group R^{a} is bonded to the group A¹ of the formula I via the dashed bond:

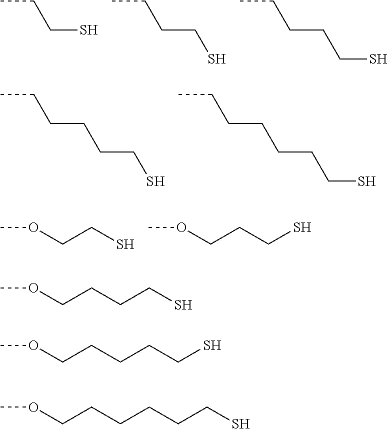

The anchor group R^{a} in the above formulae and sub-formulae preferably contains one SH group.

The term “spacer group” or “spacer”, generally denoted by “Sp” (or Sp^{a/c/d/1/2}) herein, is known to the person skilled in the art and is described in the literature, for example in Pure Appl. Chem. 73(5), 888 (2001) and C. Tschierske, G. Pelzl, S. Diele, Angew. Chem. (2004), 116, 6340-6368. In the present disclosure, the term “spacer group” or “spacer” denotes a connecting group, for example an alkylene group, which connects a mesogenic group to a polymerizable group. Whereas the mesogenic group generally contains rings, the spacer group is generally without ring systems, i.e. is in chain form, where the chain may also be branched. The term chain is applied, for example, to an alkylene group. Substitutions on and in the chain, for example by —O— or —COO—, are generally included. In functional terms, the spacer (the spacer group) is a bridge between linked functional structural parts which facilitates a certain spatial flexibility to one another.

The group Sp^{b} preferably denotes
a trivalent group of the formula selected from CH, C(Me), C(CH₂CH₃) or N, or
the tetravalent group C (tetravalent carbon atom).

The group Sp^{a} preferably denotes a group selected from the formulae —CH₂—, —CH₂CH₂—, —OCH₂CH₂—, —CH₂CH₂CH₂—, —OCH₂CH₂CH₂—, —CH₂CH₂CH₂C H₂—, —OCH₂CH₂CH₂CH₂—, —CH₂CH₂OCH₂CH₂—, —OCH₂CH₂OCH₂CH₂—.

The group Sp^{c} or Sp^{d} preferably denotes a group selected from the formulae —CH₂—, —CH₂CH₂—, —CH₂CH₂CH₂—, —CH₂CH₂CH₂CH₂—, —CH₂CH₂OCH₂CH₂—.

An above-defined anchor group of the formula

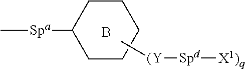

preferably stands for

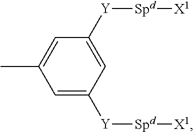

in which Y, Sp^{d} and X¹ are as defined for formula I.

The ring groups A¹, A², A³, A¹¹, A²¹, A³¹ each independently preferably denote 1,4-phenylene, naphthalene-1,4-diyl or naphthalene-2,6-diyl, where, in addition, one or more CH groups in these groups may each be replaced by N, cyclohexane-1,4-diyl, in which, in addition, one or more non-adjacent CH₂ groups may each be replaced by O or S, 3,3′-bicyclobutylidene, 1,4-cyclohexenylene, bicyclo[1.1.1]pentane-1,3-diyl, bicyclo[2.2.2]octane-1,4-diyl, spiro[3.3]heptane-2,6-diyl, piperidine-1,4-diyl, decahydronaphthalene-2,6-diyl, 1,2,3,4-tetrahydronaphthalene-2,6-diyl, indane-2,5-diyl or octahydro-4,7-methanoindane-2,5-diyl, perhydrocyclopenta[a]phenanthrene-3,17-diyl (in particular gonane-3,17-diyl), where all these groups may be unsubstituted or mono- or polysubstituted by a group L or -Sp-P.

Particularly preferably, the groups A¹, A², A³, A¹¹, A²¹, A³¹ each independently denote a group selected from
a) the group consisting of 1,4-phenylene and 1,3-phenylene, in which, in addition, one or more H atoms may be replaced by L or -Sp-P,
b) the group consisting of trans-1,4-cyclohexylene, 1,4-cyclohexenylene and 4,4′-bicyclohexylene, in which, in addition, one or more non-adjacent CH₂ groups may each be replaced by —O— or —S— and in which, in addition, one or more H atoms may each be replaced by F, L, or -Sp-P. The groups A¹ and A² or A¹¹ and A²¹ respectively especially preferably denote a group from the above sub-group a). The groups A¹ and A² or A¹¹ and A²¹ respectively independently very particularly preferably denote 1,4-phenylene or cyclohexane-1,4-diyl, which may be mono- or polysubstituted by a group L or -Sp-P. A¹ or A¹¹ preferably denotes a group selected from the sub-group for definitions a), more preferably 1,4-phenylene.

In the self-alignment additives of formula I or XI the number of rings is preferably 2, 3 or 4, which for example is the case when n is 1 and m is 1, 2 or 3 in formula I or in formula IX.

The LC media comprise preferably one or more compounds of the formula I1,

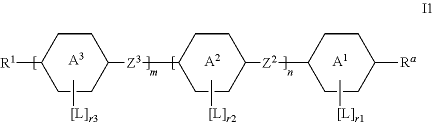

and more preferably of the formulae IA, IB, IC, ID or IE:

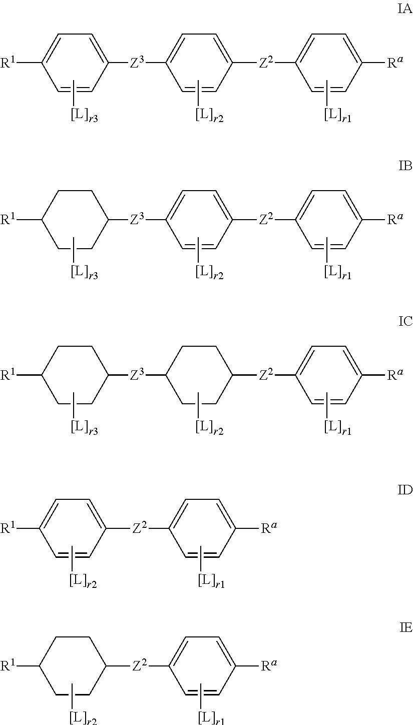

in which in each case independently R¹, R^{a}, A¹, A², A³, Z², Z³, L, m and n are as defined for formula I, and
r1, r2, r3 independently denote 0, 1, 2 or 3, preferably 0, 1 or 2.

In the above formulae the number r1+r2+r3 is preferably 1, 2, 3, or 4, more preferably 1, 2 or 3. More preferably the number r1+r2 is 1, 2 or 3.

Preferred LC media comprise compounds of the formula I are reproduced and illustrated by the following formulae:

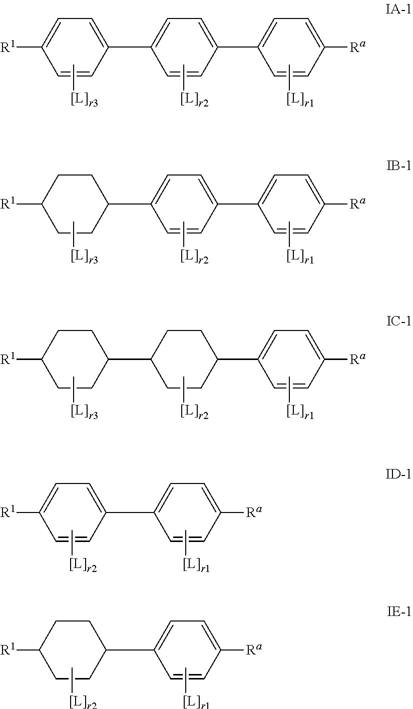

in which L, n and R^{a} independently are as defined for formula I, r1, r2, r3 independently denote 0, 1, 2 or 3, and Z²/Z³ independently are as defined above, and where Z³ preferably denotes a single bond or —CH₂CH₂— and very particularly a single bond. Preferred compounds of the invention are IA, IB and IC and their subformulae.

Very particularly preferred compounds of the formula I are illustrated by the following formulae:

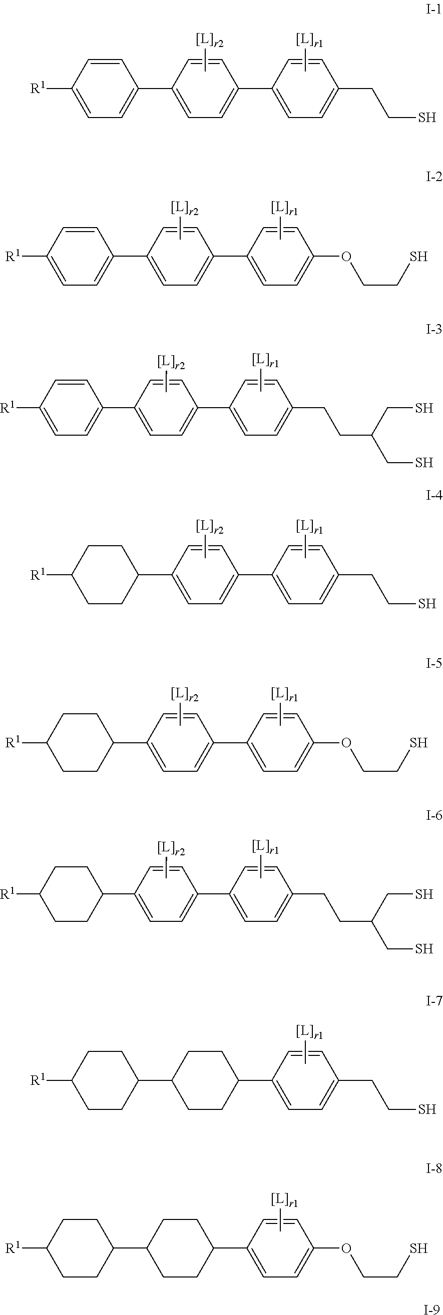

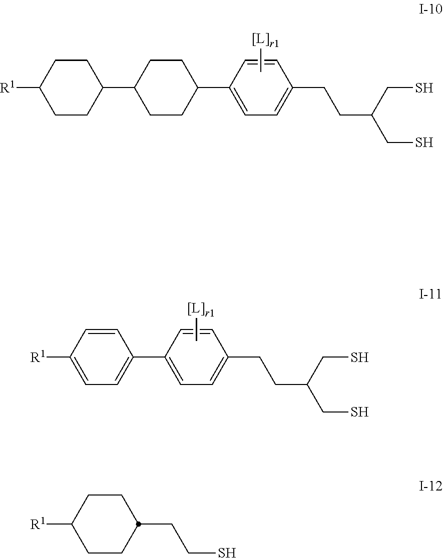

in which R¹, L and R^{a} independently are as defined for formula I. r1, r2, r3 independently denote 0, 1, 2 or 3. L is preferably a group other than H.

The compounds of the formula IX (conventional non-thiol self-alignment additives) preferably encompass compounds of the formulae IXA, IXB, IXC, IXD or IXE:

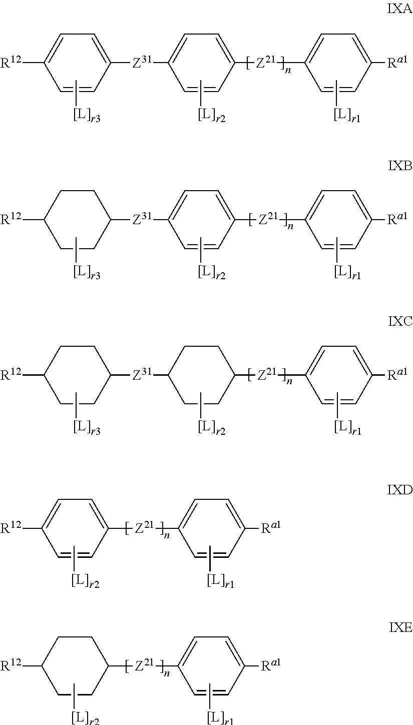

in which R¹², Z²¹, Z³¹, L and n independently are as defined for the above formulae IA to IE,
R^{a1} is a polar anchor group, and
r1, r2, r3 independently denote 0, 1, 2, 3 or 4, preferably 0, 1 or 2.

The preparation of the conventional self-alignment additives is disclosed, for example, in the specification WO 2012/038026 A¹.

The term “aryl” denotes an aromatic carbon group or a group derived therefrom. The term “heteroaryl” denotes “aryl” as defined above containing one or more heteroatoms.

Aryl and heteroaryl groups may be monocyclic or polycyclic, i.e. they may contain one ring (such as, for example, phenyl) or two or more fused rings. At least one of the rings here has an aromatic configuration. Heteroaryl groups contain one or more heteroatoms, preferably selected from O, N, S and Se.

Particular preference is given to mono-, bi- or tricyclic aryl groups having 6 to 25 C atoms and mono-, bi- or tricyclic heteroaryl groups having 2 to 25 C atoms, which optionally contain fused rings. Preference is furthermore given to 5-, 6- or 7-membered aryl and heteroaryl groups, in which, in addition, one or more CH groups may each be replaced by N, S or O in such a way that O atoms and/or S atoms are not linked directly to one another.

Preferred aryl groups are, for example, phenyl, naphthyl, anthracene, phenanthrene, pyrene, dihydropyrene, chrysene, perylene, tetracene, pentacene, benzopyrene, fluorene, indene, indenofluorene, spirobifluorene, etc.

Preferred heteroaryl groups are, for example, 5-membered rings, such as pyrrole, pyrazole, imidazole, 1,2,3-triazole, 1,2,4-triazole, tetrazole, furan, thiophene, selenophene, oxazole, isoxazole, 1,2-thiazole, 1,3-thiazole, 1,2,3-oxadiazole, 1,2,4-oxadiazole, 1,2,5-oxadiazole, 1,3,4-oxadiazole, 1,2,3-thiadiazole, 1,2,4-thiadiazole, 1,2,5-thiadiazole, 1,3,4-thiadiazole, 6-membered rings, such as pyridine, pyridazine, pyrimidine, pyrazine, 1,3,5-triazine, 1,2,4-triazine, 1,2,3-triazine, 1,2,4,5-tetrazine, 1,2,3,4-tetrazine, 1,2,3,5-tetrazine, or condensed groups, such as indole, isoindole, indolizine, indazole, benzimidazole, benzotriazole, purine, naphthimidazole, phenanthrimidazole, pyridimidazole, pyrazinimidazole, quinoxalinimidazole, benzoxazole, naphthoxazole, anthroxazole, phenanthroxazole, isoxazole, benzothiazole, benzofuran, isobenzofuran, dibenzofuran, quinoline, isoquinoline, pteridine, benzo-5,6-quinoline, benzo-6,7-quinoline, benzo-7,8-quinoline, benzoisoquinoline, acridine, phenothiazine, phenoxazine, benzopyridazine, benzopyrimidine, quinoxaline, phenazine, naphthyridine, azacarbazole, benzocarboline, phenanthridine, phenanthroline, thieno[2,3b]thiophene, thieno[3,2b]thiophene, dithienothiophene, isobenzothiophene, dibenzothiophene, benzothiadiazothiophene, coumarin or combinations of these groups.

The (non-aromatic) alicyclic and heterocyclic groups encompass both saturated rings, i.e. those containing exclusively single bonds, and also partially unsaturated rings, i.e. those which may also contain multiple bonds. Heterocyclic rings contain one or more heteroatoms, preferably selected from Si, O, N, S and Se.

The (non-aromatic) alicyclic and heterocyclic groups may be monocyclic, i.e. contain only one ring (such as, for example, cyclohexane), or polycyclic, i.e. contain a plurality of rings (such as, for example, decahydronaphthalene or bicyclooctane). Particular preference is given to saturated groups. Preference is furthermore given to mono-, bi- or tricyclic groups having 3 to 25 C atoms. Preference is furthermore given to 5-, 6-, 7- or 8-membered carbocyclic groups, in which, in addition, one or more C atoms may each be replaced by Si and/or one or more CH groups may each be replaced by N and/or one or more non-adjacent CH₂ groups may each be replaced by —O— or —S—.

Preferred alicyclic and heterocyclic groups are, for example, 5-membered groups, such as cyclopentane, tetrahydrofuran, tetrahydrothiofuran, pyrrolidine, 6-membered groups, such as cyclohexane, cyclohexene, tetrahydropyran, tetrahydrothiopyran, 1,3-dioxane, 1,3-dithiane, piperidine, 7-membered groups, such as cycloheptane, and fused groups, such as tetrahydronaphthalene, decahydronaphthalene, indane, bicyclo[1.1.1]pentane-1,3-diyl, bicyclo[2.2.2]octane-1,4-diyl, spiro[3.3]heptane-2,6-diyl, octahydro-4,7-methanoindane-2,5-diyl.

In connection with the present invention, the term “alkyl” denotes a straight-chain or branched, saturated or unsaturated, preferably saturated, aliphatic hydrocarbon radical having 1 to 15 (i.e. 1, 2, 3, 4, 5, 6, 7, 8, 9, 10, 11, 12, 13, 14 or 15) carbon atoms.

The term “cyclic alkyl” encompasses alkyl groups which have at least one carbocyclic part, i.e., for example, also cycloalkylalkyl, alkylcycloalkyl and alkylcycloalkylalkyl. The carbocyclic groups encompass, for example, cyclopropyl, cyclobutyl, cyclopentyl, cyclohexyl, cycloheptyl, cyclooctyl, etc.

“Halogen” in connection with the present invention stands for fluorine, chlorine, bromine or iodine, preferably for fluorine or chlorine.

The compounds of the formula I can in principle be prepared by the following illustrative synthetic routes (Schemes 1 to 2):

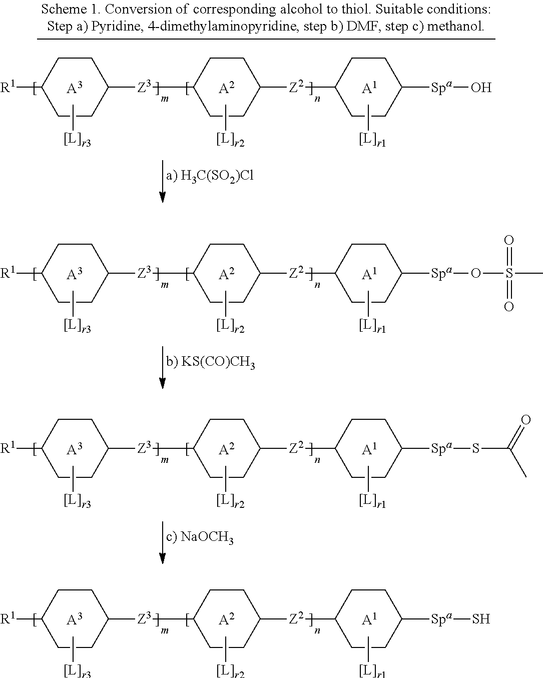

A general route to the thiols of formula I is to convert corresponding alcohols to thiols (Scheme 1). A variety of corresponding alcohols and their preparation are disclosed in WO 2012/038026.

A convenient synthesis to introduce a spacer between the thiol group and the first ring of the mesogenic structure is provided in the following scheme (Scheme 2).

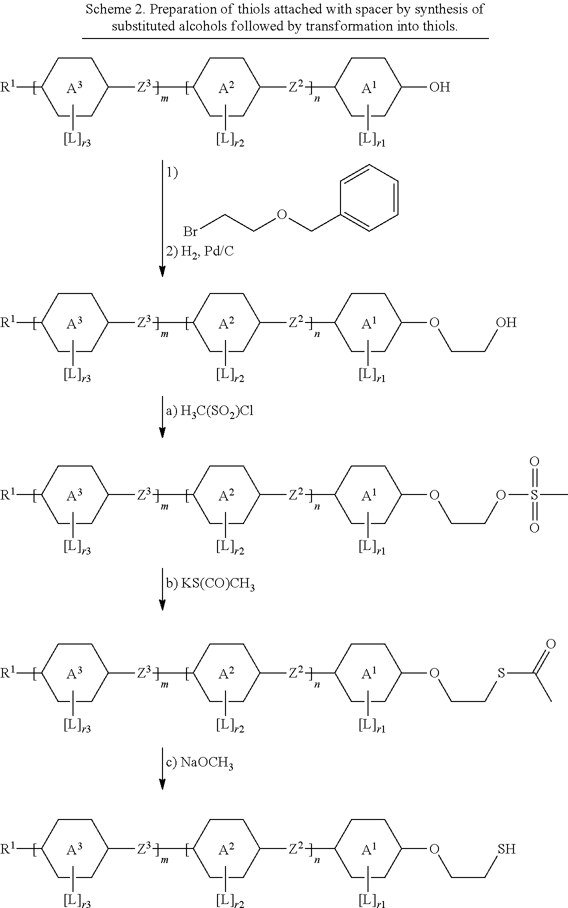

The polymerizable component of the LC medium preferably comprises further polymerizable or (partially) polymerized compounds. These are preferably conventional polymerizable compounds, preferably mesogenic compounds, in particular those which are suitable for the PSA technique. Polymerizable compounds which are preferred for this purpose are the structures indicated below for formula M and the sub-formulae M1, M2, etc. thereof. The polymer formed therefrom is able to stabilize the alignment of the LC medium, optionally form a passivation layer and optionally generate a pre-tilt.

The LC media according to the invention therefore preferably comprise >0 to <5% by weight, particularly preferably 0.05 to 1% by weight and very particularly preferably 0.2 to 1% by weight of polymerizable compounds (without an anchor group R^{a} or R^{a1}), in particular compounds of the formula M as defined below and the preferred formulae falling thereunder.

The polymerization of the polymerizable components is carried out together or in part-steps under different polymerization conditions. The polymerization is preferably carried out under the action of UV light. In general, the polymerization is initiated with the aid of a polymerization initiator and UV light. In the case of the preferred acrylates, virtually complete polymerization is achieved in this way. During the polymerization, a voltage can optionally be applied to the electrodes of the cell or another electric field can be applied in order additionally to influence the alignment of the LC medium.

Particular preference is given to LC media according to the invention which, besides the compounds of the formula I, comprise further self-alignment additives and optionally further polymerizable or (partially) polymerized compounds (without an anchor group). These further self-alignment additives are preferably those as described above, cf. formulae IX, IXA, IXB, IXC, IXD, IXE.

The optionally present further monomers of the polymerizable component of the LC medium are preferably described by the following formula M:

P¹—Sp¹-A²-(Z¹-A¹)ₙ-Sp²-P² M
in which the individual radicals have the following meanings:
P¹, P² each, independently of one another, denote a polymerizable group,
Sp¹, Sp² on each occurrence, identically or differently, denote a spacer group or a single bond,
A¹, A² each, independently of one another, denote a radical selected from the following groups:
   a) the group consisting of trans-1,4-cyclohexylene, 1,4-cyclohexenylene and 4,4′-bicyclohexylene, in which, in addition, one or more non-adjacent CH₂ groups may each be replaced by —O— or —S— and in which, in addition, one or more H atoms may each be replaced by a group L, or a radical of the formula

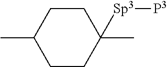

b) the group consisting of 1,4-phenylene and 1,3-phenylene, in which, in addition, one or two CH groups may each be replaced by N and in which, in addition, one or more H atoms may each be replaced by a group L or -Sp³-P,
c) the group consisting of tetrahydropyran-2,5-diyl, 1,3-dioxane-2,5-diyl, tetrahydrofuran-2,5-diyl, cyclobutane-1,3-diyl, piperidine-1,4-diyl, thiophene-2,5-diyl and selenophene-2,5-diyl, each of which may also be mono- or polysubstituted by L,
d) the group consisting of saturated, partially unsaturated or fully unsaturated, and optionally substituted, polycyclic radicals having 5 to 20 cyclic C atoms, one or more of which may, in addition, be replaced by heteroatoms, preferably selected from the group consisting of bicyclo[1.1.1]pentane-1,3-diyl, bicyclo[2.2.2]octane-1,4-diyl, spiro[3.3]heptane-2,6-diyl,

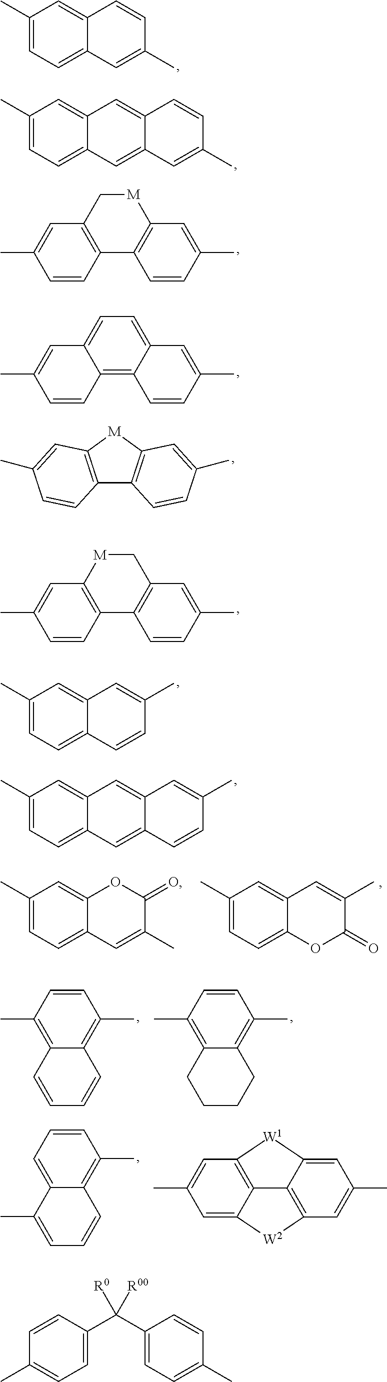

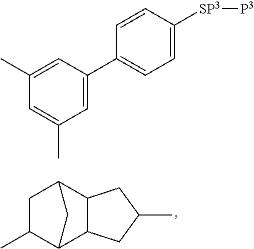

where, in addition, one or more H atoms in these radicals may each be replaced by a group L or -Sp³-P, and/or one or more double bonds may each be replaced by single bonds, and/or one or more CH groups may each be replaced by N,
P³ denotes a polymerizable group,
Sp³ denotes a spacer group,
n denotes 0, 1, 2 or 3, preferably 1 or 2,
Z¹ in each case, independently of one another, denotes —CO—O—, —O—CO—, —CH₂O—, —OCH₂—, —CF₂O—, —OCF₂—, —(CH₂)ₙ— where n is 2, 3 or 4, —O—, —CO—, —C(R^{c}R^{d})—, —CH₂CF₂—, —CF₂CF₂— or a single bond,
L on each occurrence, identically or differently, denotes F, Cl, CN, SCN, SF₅ or straight-chain or branched, in each case optionally fluorinated, alkyl, alkoxy, alkylcarbonyl, alkoxycarbonyl, alkylcarbonyloxy or alkoxycarbonyloxy having 1 to 12 C atoms,
M denotes —O—, —S—, —CH₂—, —CHY¹— or —CY¹Y²—, and
Y¹ and Y² each, independently of one another, denote H, F or straight-chain or branched alkyl having 1 to 12 C atoms, in which, in addition, one or more H atoms may each be replaced by F, or denote Cl or CN, and preferably denote H, F, Cl, CN, OCF₃ or CF₃,
W¹, W² each, independently of one another, denote —CH₂CH₂—, —CH═CH—, —CH₂—O—, —O—CH₂—, —C(R^{c}R^{d})— or —O—,
R^{c} and R^{d} each, independently of one another, denote H, F, CF₃, or alkyl having 1 to 6 C atoms, preferably H, methyl or ethyl.
   where one or more of the groups P¹-Sp¹-, -Sp²-P² and -Sp³-P³ may denote a radical R^{aa}, with the proviso that at least one of the groups P¹—Sp¹-, -Sp²-P² and -Sp³-P³ present does not denote R^{aa},
R^{aa} denotes H, F, Cl, CN or straight-chain or branched alkyl having 1 to 25 C atoms, in which, in addition, one or more non-adjacent CH₂ groups may each be replaced, independently of one another, by C(R⁰)═C(R⁰⁰)—, —C≡C—, —O—, —S—, —CO—, —CO—O—, —O—CO—, or —O—CO—O— in such a way that O and/or S atoms are not linked directly to one another, and in which, in addition, one or more H atoms may each be replaced by F, Cl, CN or P¹-Sp¹-, particularly preferably straight-chain or branched, optionally mono- or polyfluorinated alkyl, alkoxy, alkenyl, alkynyl, alkylcarbonyl, alkoxycarbonyl or alkylcarbonyloxy having 1 to 12 C atoms (where the alkenyl and alkynyl radicals contain at least two C atoms and the branched radicals contain at least three C atoms), where the groups —OH, —NH₂, —SH, —NHR, —C(O)OH and —CHO are not present in R^{aa}, and
R⁰, R⁰⁰ each, independently of one another, denote H, F or straight-chain or branched alkyl having 1 to 12 C atoms, in which, in addition, one or more H atoms may each be replaced by F.

The polymerizable group P, P¹, P² or P³ in the formulae above and below is a group which is suitable for a polymerization reaction, such as, for example, free-radical or ionic chain polymerization, polyaddition or polycondensation, or for a polymer-analogous reaction, for example addition or condensation onto a main polymer chain. Particular preference is given to groups for chain polymerization, in particular those containing a C═C double bond or —C≡C— triple bond, and groups which are suitable for polymerization with ring opening, such as, for example, oxetane or epoxide groups.

Preferred groups P/P¹/P²/P³ are selected from the group consisting of CH₂═CW¹—CO—O—, CH₂═CW¹—CO—,

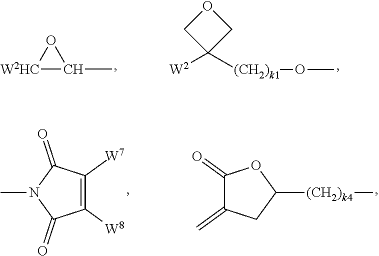

CH₂═CW²—(O)ₖ₃—, CW¹═CH—CO—(O)ₖ₃—, CH₃—CH═CH—O—, (CH₂═CH)₂CH—OCO—, (CH₂═CH—CH₂)₂CH—OCO—, (CH₂═CH)₂CH—O—, (CH₂═CH—CH₂)₂N—, (CH₂═CH—CH₂)₂N—CO—, CH₂═CH(COO)ₖ₁-Phe-(O)ₖ₂—, CH₂═CH—(CO)ₖ₁-Phe-(O)ₖ₂—, Phe-CH═CH—, HOOC— and W⁴W⁵W⁶Si—, in which W¹ denotes H, F, Cl, CN, CF₃, phenyl or alkyl having 1 to 5 C atoms, in particular H, F, Cl or CH₃, W² denotes H or alkyl having 1 to 5 C atoms, in particular H, methyl, ethyl or n-propyl, W⁴, W⁵ and W⁶ each, independently of one another, denote Cl, oxaalkyl or oxacarbonylalkyl having 1 to 5 C atoms, W⁷ and W⁸ each, independently of one another, denote H, Cl or alkyl having 1 to 5 C atoms, Phe denotes 1,4-phenylene, which is optionally substituted by one or more radicals L as defined above which are other than P-Sp-, k₁, k₂ and k₃ each, independently of one another, denote 0 or 1, k₃ preferably denotes 1, and k₄ denotes an integer from 1 to 10.

Particularly preferred groups P/P¹/P²/P³ are selected from the group consisting of CH₂═CW¹—CO—O—, CH₂═CW¹—CO—,

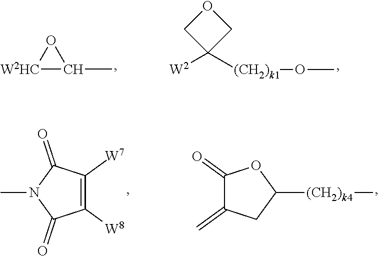

CH₂═CW²—O—, CW¹═CH—CO—(O)ₖ₃—, (CH₂═CH)₂CH—OCO—, (CH₂═CH—CH₂)₂CH—OCO—, (CH₂═CH)₂CH—O—, (CH₂═CH—CH₂)₂N—, (CH₂═CH—CH₂)₂N—CO—, CH₂═CW¹—CO—NH—, —CH₂═CH—(COO)ₖ₁-Phe-(O)ₖ₂—, CH₂═CH—(CO)ₖ₁-Phe-(O)ₖ₂—, Phe-CH═CH— and W⁴W⁵W⁶Si—, in which W¹ denotes H, F, Cl, CN, CF₃, phenyl or alkyl having 1 to 5 C atoms, in particular H, F, Cl or CH₃, W² denotes H or alkyl having 1 to 5 C atoms, in particular H, methyl, ethyl or n-propyl, W⁴, W⁵ and W⁶ each, independently of one another, denote Cl, oxaalkyl or oxacarbonylalkyl having 1 to 5 C atoms, W⁷ and W⁸ each, independently of one another, denote H, Cl or alkyl having 1 to 5 C atoms, Phe denotes 1,4-phenylene, k₁, k₂ and k₃ each, independently of one another, denote 0 or 1, k₃ preferably denotes 1, and k₄ denotes an integer from 1 to 10.

Very particularly preferred groups P/P¹/P²/P³ are selected from the group consisting of CH₂═CW¹—CO—O—, in particular CH₂═CH—CO—O—, CH₂═C(CH₃)—CO—O— and CH₂═CF—CO—O—, furthermore CH₂═CH—O—, (CH₂═CH)₂CH—O—CO—, (CH₂═CH)₂CH—O—,

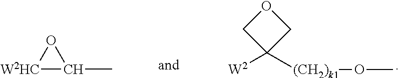

Very particularly preferred groups P/P¹/P²/P³ are therefore selected from the group consisting of acrylate, methacrylate, fluoroacrylate, furthermore vinyloxy, chloroacrylate, oxetane and epoxide groups, and of these in turn preferably an acrylate or methacrylate group.

Preferred spacer groups Sp, Sp¹ or Sp² are a single bond or selected from the formula Sp″—X″, so that the radical P^{1/2}-Sp^{1/2}- conforms to the formula P^{1/2}-Sp″—X″—, where
Sp″ denotes alkylene having 1 to 20, preferably 1 to 12, C atoms, which is optionally mono- or polysubstituted by F, Cl, Br, I or CN and in which, in addition, one or more non-adjacent CH₂ groups may each be replaced, independently of one another, by —O—, —S—, —Si(R⁰R⁰⁰)—, —CO—, —CO—O—, —O—CO—, —O—CO—O—, —S—CO—, —CO—S—, —N(R⁰)—CO—O—, —O—CO—N(R⁰⁰)—, —N(R⁰⁰)—CO—N(R⁰⁰)—, —CH═CH— or —C≡C— in such a way that O and/or S atoms are not linked directly to one another,
X″ denotes —O—, —S—, —CO—, —CO—O—, —O—CO—, —O—CO—O—, —CO—N(R⁰⁰)—, —N(R⁰)—CO—, —N(R⁰⁰)—CO—N(R⁰⁰)—, —OCH₂—, —CH₂O—, —SCH₂—, —CH₂S—, —CF₂O—, —OCF₂—, —CF₂S—, —SCF₂—, —CF₂CH₂—, —CH₂CF₂—, —CF₂CF₂—, —CH═N—, —N═CH—, —N═N—, —CH═CR⁰—, —CY²═CY³—, —C≡C—, —CH═CH—CO—O—, —O—CO—CH═CH— or a single bond,
R⁰ in each case independently denotes H, F or straight-chain or branched alkyl having 1 to 12 C atoms, in which, in addition, one or more H atoms may each be replaced by F,
R⁰⁰ in each case independently denotes alkyl having 1 to 12 C atoms,
R⁰⁰⁰ in each case independently denotes H or alkyl having 1 to 12 C atoms, and
Y² and Y³ each, independently of one another, denote H, F, Cl or CN.
X″ is preferably —O—, —S—, —CO—, —COO—, —OCO—, —O—COO— or a single bond.

Typical spacer groups Sp″ are, for example, a single bond, —(CH₂)ₚ₁—, —(CH₂CH₂O)_{q1}—CH₂CH₂—, —CH₂CH₂—S—CH₂CH₂—, or —(SiR⁰⁰R⁰⁰⁰—O)ₚ₁—, in which p1 is an integer from 1 to 12, q1 is an integer from 1 to 3, and R⁰⁰ and R⁰⁰⁰ have the meanings indicated above.

Particularly preferred groups -Sp″—X″— are —(CH₂)ₚ₁—, —(CH₂)ₚ₁—O—, —(CH₂)ₚ₁-O—CO—, —(CH₂)ₚ₁—O—CO—O—, in which p1 and q1 have the meanings indicated above.

Particularly preferred groups Sp″ are, for example, in each case straight-chain ethylene, propylene, butylene, pentylene, hexylene, heptylene, octylene, nonylene, decylene, undecylene, dodecylene, octadecylene, ethyleneoxyethylene, methyleneoxybutylene, ethylenethioethylene, ethylene-N-methyliminoethylene, 1-methylalkylene, ethenylene, propenylene and butenylene.

The substances of the formula M preferably contain no —OH, —NH₂, —SH, —NHR¹¹, —C(O)OH and —CHO radicals.

Suitable and preferred (co)monomers for use in displays according to the invention are selected, for example, from the following formulae:

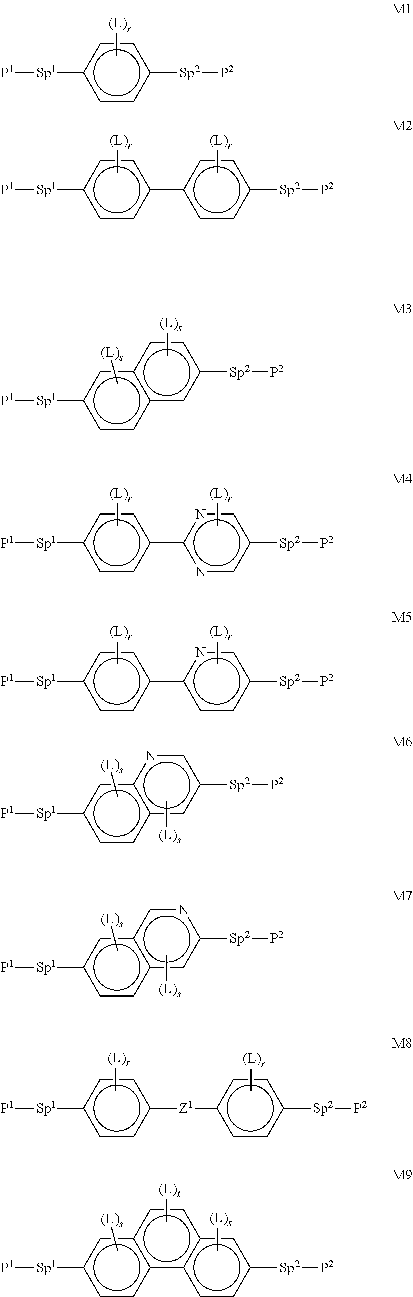

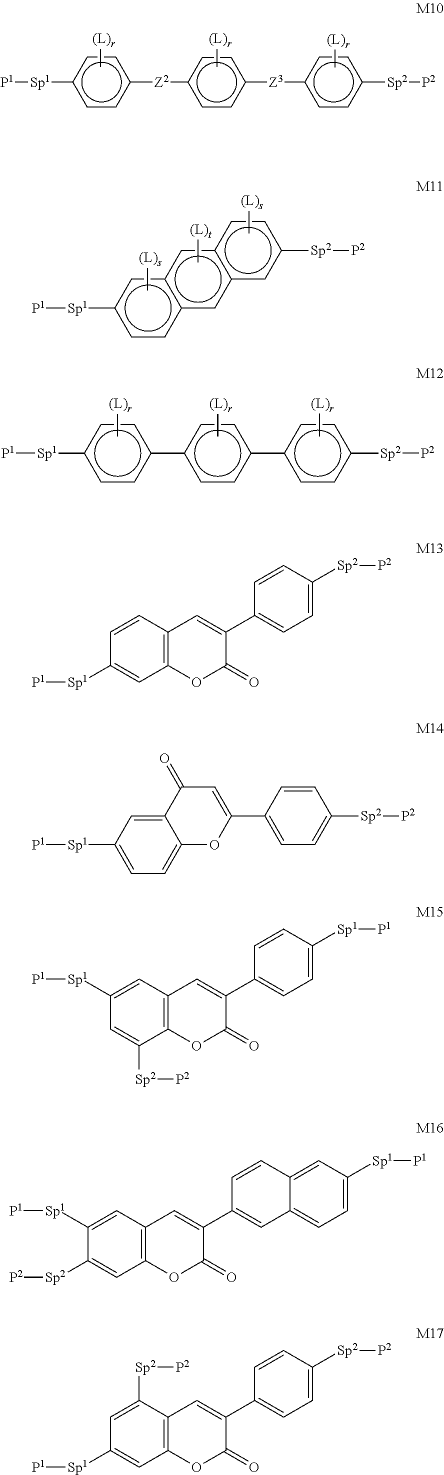

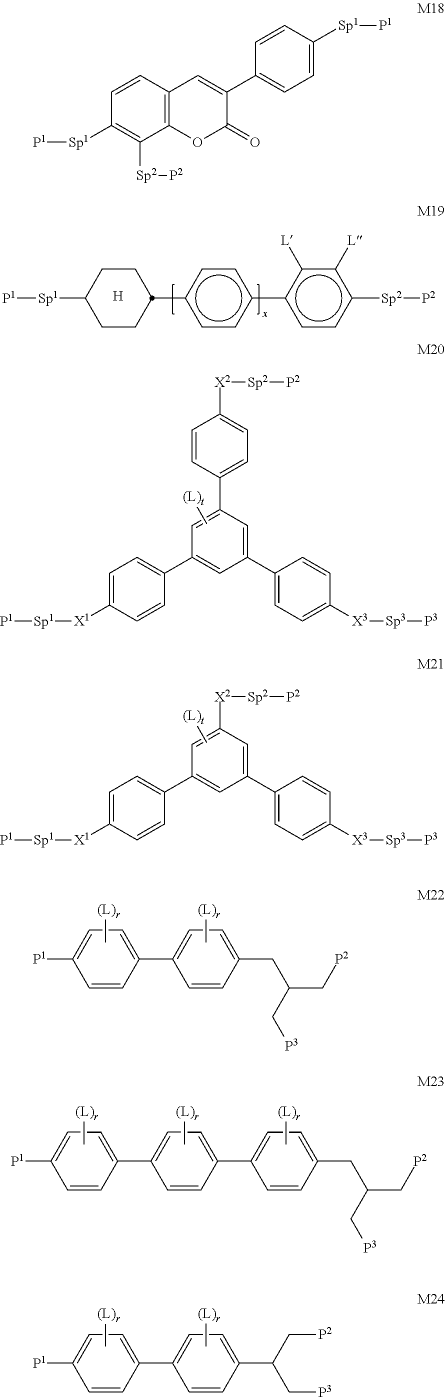

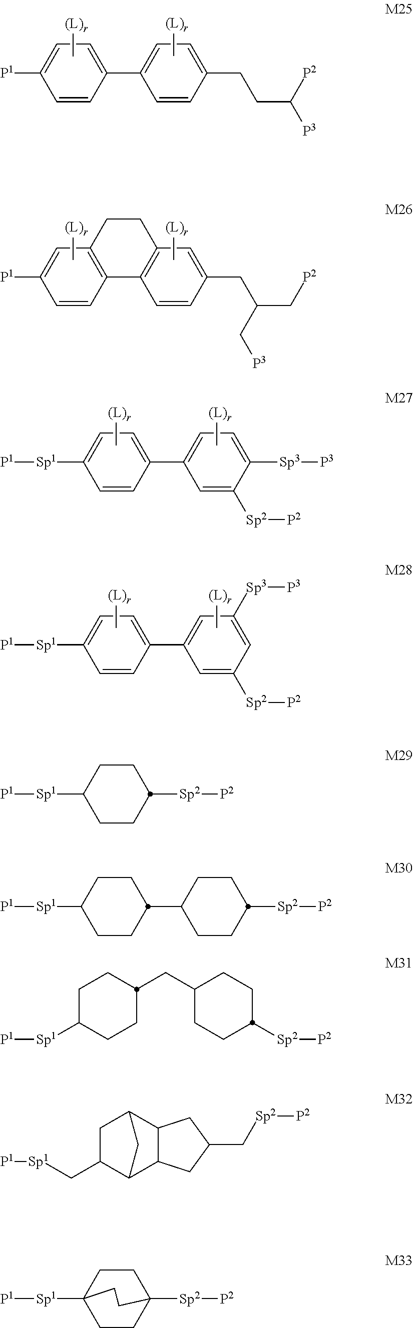

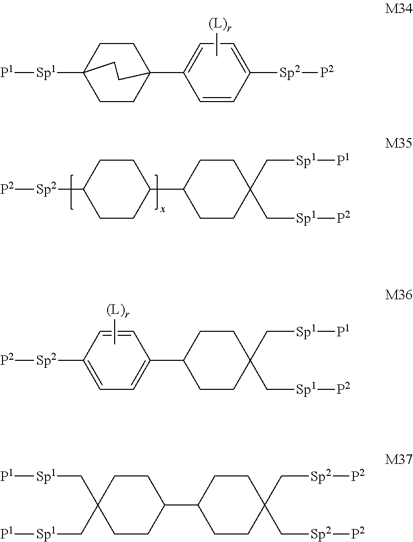

in which the individual radicals have the following meanings:
P¹, P² and P³ each, independently of one another, denote a polymerizable group, preferably having one of the meanings indicated above and below for P, preferably an acrylate, methacrylate, fluoroacrylate, oxetane, vinyloxy or epoxide group,
Sp¹, Sp² and Sp³ each, independently of one another, denote a single bond or a spacer group, preferably having one of the meanings as indicated above and below for formula M, and particularly preferably —(CH₂)ₚ₁—, —(CH₂)ₚ₁—O—, —(CH₂)ₚ₁—CO—O—
   or —(CH₂)ₚ₁—O—CO—O—, in which p1 is an integer from 1 to 12, and wherein the bonding between groups —(CH₂)ₚ₁—O—, —(CH₂)ₚ₁—CO—O— and —(CH₂)ₚ₁—O—CO—O— and the adjacent ring occurs via the 0 atom,
      where, in addition, one or more of the radicals P¹-Sp¹-, P²—Sp²- and P³—Sp³- may denote a radical R^{aa}, with the proviso that at least one of the radicals P¹-Sp¹-, P²—Sp²- and P³—Sp³- present does not denote R^{aa},
R^{aa} denotes H, F, Cl, CN or straight-chain or branched alkyl having 1 to 25 C atoms, in which, in addition, one or more non-adjacent CH₂ groups may each be replaced, independently of one another, by C(R⁰)═C(R⁰)—, —C≡C—, —O—, —S—, —CO—, —CO—O—, —O—CO—, or —O—CO—O— in such a way that O and/or S atoms are not linked directly to one another, and in which, in addition, one or more H atoms may each be replaced by F, Cl, CN or P¹-Sp¹-, preferably straight-chain or branched, optionally mono- or polyfluorinated alkyl, alkoxy, alkenyl, alkynyl, alkylcarbonyl, alkoxycarbonyl or alkylcarbonyloxy having 1 to 12 C atoms (where the alkenyl and alkynyl radicals have at least two C atoms and the branched radicals have at least three C atoms), where —OH, —NH₂, —SH, —NHR, —C(O)OH and —CHO are not present in the group R^{aa},
R⁰, R⁰⁰ each, independently of one another and on each occurrence identically or differently, denote H or alkyl having 1 to 12 C atoms,
X¹, X² and X³ each, independently of one another, denote —CO—O—, O—CO— or a single bond,
Z¹ denotes —O—, —CO—, —C(R^{y}R^{z})— or —CF₂CF₂—,
Z² and Z³ each, independently of one another, denote —CO—O—, —O—CO—, —CH₂O—, —OCH₂—, —CF₂O—, —OCF₂— or —(CH₂)ₙ— where n is 2, 3 or 4,
R^{y} and R^{z} each, independently of one another, denote H, F, CH₃ or CF₃,
L on each occurrence, identically or differently, denotes F, Cl, CN, SCN, SF₅ or straight-chain or branched, optionally mono- or polyfluorinated alkyl, alkoxy, alkenyl, alkynyl, alkylcarbonyl, alkoxycarbonyl, alkylcarbonyloxy or alkoxycarbonyloxy having 1 to 12 C atoms, preferably F,
L′ and L″ each, independently of one another, denote H, F or Cl,
r denotes 0, 1, 2, 3 or 4,
s denotes 0, 1, 2 or 3,
t denotes 0, 1 or 2,
x denotes 0 or 1.

In the compounds of the formulae M1 to M37, the ring group

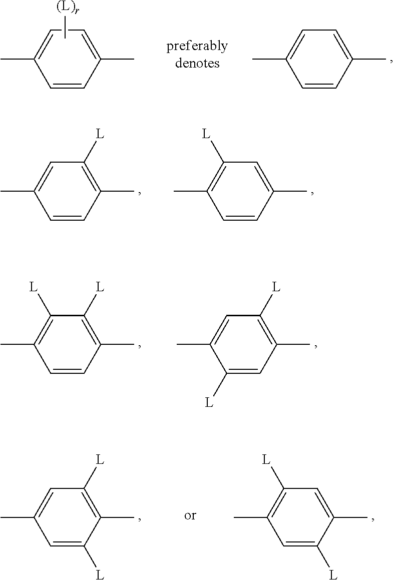

in which L, on each occurrence identically or differently, has one of the above meanings and preferably denotes F, Cl, CN, NO₂, CH₃, C₂H₅, C(CH₃)₃, CH(CH₃)₂, CH₂CH(CH₃)C₂H₅, OCH₃, OC₂H₅, COCH₃, COC₂H₅, COOCH₃, COOC₂H₅, CF₃, OCF₃, OCHF₂, OC₂F₅ or P-Sp-, particularly preferably F, Cl, CN, CH₃, O₂H₅, OCH₃, COCH₃, OCF₃ or P-Sp-, very particularly preferably F, Cl, CH₃, OCH₃, COCH₃ or OCF₃, in particular F or CH₃.

The LC medium or the polymerizable component preferably comprises one or more compounds selected from the group of the formulae M1-M28, particularly preferably from the group of the formulae M2-M15, very particularly preferably from the group of the formulae M2, M3, M9, M14 and M15. The LC medium or the polymerizable component preferably comprises no compounds of the formula M10 in which either of Z² and Z³ denote —(CO)O— or —O(CO)—.

For the production of PSA displays, the polymerizable compounds are polymerized or crosslinked (if a polymerizable compound contains two or more polymerizable groups) by in-situ polymerization in the LC medium between the substrates of the LC display, optionally with application of a voltage. The polymerization can be carried out in one step. It is also possible firstly to carry out the polymerization with application of a voltage in a first step in order to produce a pretilt angle, and subsequently, in a second polymerization step, to polymerize or crosslink the compounds which have not fully reacted in the first step without an applied voltage (“end curing”).

Suitable and preferred polymerization methods are, for example, thermal or photopolymerization, preferably photopolymerization, in particular UV photopolymerization. One or more initiators can optionally also be added here. Suitable conditions for the polymerization and suitable types and amounts of initiators are known to the person skilled in the art and are described in the literature. Suitable for free-radical polymerization are, for example, the commercially available photoinitiators Irgacure651®, Irgacure184®, Irgacure907®, Irgacure369® or Darocure1173® (Ciba AG). If an initiator is employed, its proportion is preferably 0.001 to 5% by weight, particularly preferably 0.001 to 1% by weight.

The polymerizable component or the LC medium may also comprise one or more stabilizers in order to prevent undesired spontaneous polymerization of the RMs, for example during storage or transport. Suitable types and amounts of stabilizers are known to the person skilled in the art and are described in the literature. Particularly suitable are, for example, the commercially available stabilizers from the Irganox® series (Ciba AG), such as, for example, Irganox® 1076. If stabilizers are employed, their proportion, based on the total amount of the RMs or the polymerizable component, is preferably 10 10,000 ppm, particularly preferably 50-500 ppm.

Besides the self-alignment additives described above and the optional polymerizable compounds (M) described above, the LC media for use in the LC displays according to the invention comprise an LC mixture (“host mixture”) comprising one or more, preferably two or more, low-molecular-weight (i.e. monomeric or unpolymerized) compounds. The latter are stable or unreactive with respect to a polymerization reaction under the conditions used for the polymerization of the polymerizable compounds. In principle, any dielectrically negative LC mixture which is suitable for use in conventional VA displays is suitable as host mixture. The proportion of the host mixture for liquid-crystal displays is generally 95% by weight or more, preferably 97% by weight or more

Suitable LC mixtures are known to the person skilled in the art and are described in the literature. LC media for VA displays having negative dielectric anisotropy are described in EP 1 378 557 A1 or WO 2013/004372.

Preferred embodiments of the liquid-crystalline medium having negative dielectric anisotropy according to the invention are indicated below: LC medium which additionally comprises one or more compounds selected from the group of the compounds of the formulae A, B and C,

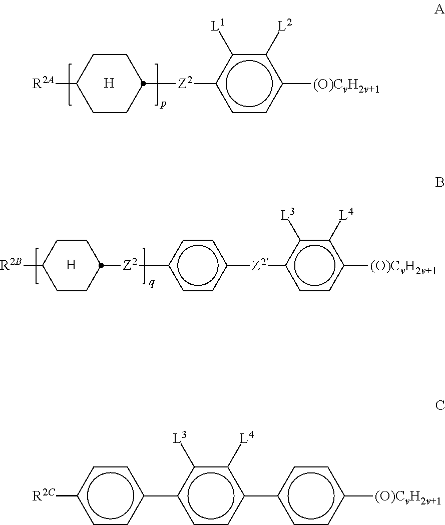

in which
R^{2A}, R^{2B} and R^{2C} each, independently of one another, denote H, an alkyl radical having up to 15 C atoms which is unsubstituted, monosubstituted by CN or CF₃ or at least monosubstituted by halogen, where, in addition, one or more CH₂ groups in these radicals may each be replaced by —O—, —S—,

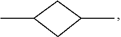

—C≡C—, —CF₂O—, —OCF₂—, —OC—O— or —O—CO— in such a way that O atoms are not linked directly to one another,
L¹⁻⁴ each, independently of one another, denote F, Cl, CF₃ or CHF₂,
Z² and Z^{2′} each, independently of one another, denote a single bond, —CH₂CH₂—, —CH═CH—, —CF₂O—, —OCF₂—, —CH₂O—, —OCH₂—, —COO—, —OCO—, —C₂F₄—, —CF═CF— or —CH═CHCH₂O—,
(O) denotes —O— or a single bond,
p denotes 1 or 2, preferably 1,
q denotes 0 or 1, and
v denotes 1 to 6.

In the compounds of the formula B, Z² can have identical or different meanings. In the compounds of the formula B, Z² and Z^{2′} can have identical or different meanings. In the compounds of the formulae A, B and C, R^{2A}, R^{2B} and R^{2C} each preferably denote alkyl having 1-6 C atoms, in particular CH₃, C₂H₅, n-C₃H₇, n-C₄H₉, n-C₅H₁₁.

In the compounds of the formulae A and B, L¹, L², L³ and L⁴ preferably denote L¹=L²=F and L³=L⁴=F, furthermore L¹=F and L²=Cl, L¹=Cl and L²=F, L³=F and L⁴=Cl, L³=Cl and L⁴=F. Z² and Z^{2′} in the formulae A and B preferably each, independently of one another, denote a single bond, furthermore a —C₂H₄— bridge.

If Z²═—C₂H₄— in the formula B, Z^{2′} is preferably a single bond, or if Z^{2′}═—C₂H₄—, Z² is preferably a single bond. In the compounds of the formulae A and B, (O)CᵥH₂ᵥ₊₁ preferably denotes OCᵥH₂ᵥ₊₁, furthermore CᵥH₂ᵥ₊₁. In the compounds of the formula C, (O)CᵥH₂ᵥ₊₁ preferably denotes CᵥH₂ᵥ₊₁. In the compounds of the formula C, L³ and L⁴ preferably each denote F.

Preferred compounds of the formulae A, B and C are, for example:

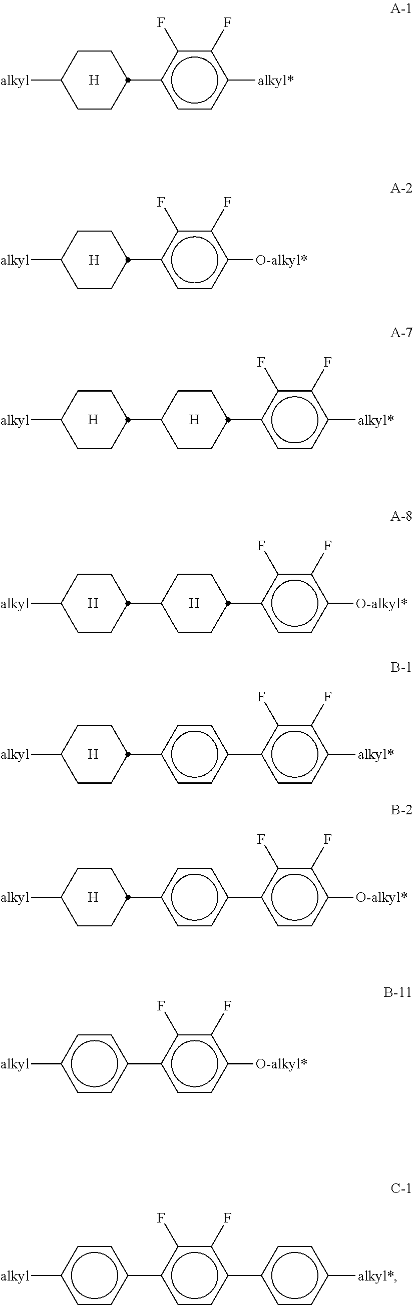

in which alkyl and alkyl* each, independently of one another, denote a straight-chain alkyl radical having 1-6 C atoms.

The LC medium preferably has a Δε of −1.5 to −8.0, in particular −2.5 to −6.0.

The values of the birefringence Δε in the liquid-crystal mixture are generally between 0.07 and 0.16, preferably between 0.08 and 0.12. The rotational viscosity γ₁ at 20° C. before the polymerization is preferably ≤165 mPa·s, in particular ≤140 mPa·s.

Preferred embodiments of the liquid-crystalline medium according to the invention having negative dielectric anisotropy are indicated below:

LC medium which additionally comprises one or more compounds of the formulae II and/or III:

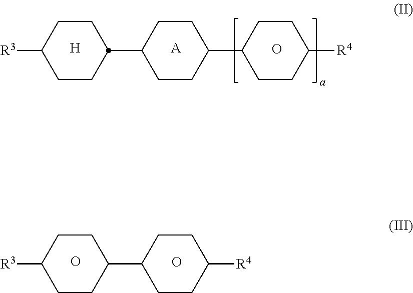

in which
ring A denotes 1,4-phenylene or trans-1,4-cyclohexylene,
a is 0 or 1,
R³ in each case, independently of one another, denotes alkyl having 1 to 9 C atoms or alkenyl having 2 to 9 C atoms, preferably alkenyl having 2 to 9 C atoms, and
R⁴ in each case, independently of one another, denotes an unsubstituted or halogenated alkyl radical having 1 to 12 C atoms, where, in addition, one or two non-adjacent CH₂ groups may each be replaced by —O—, —CH═CH—, —CH═CF—, —(CO)—, —O(CO)— or —(CO)O— in such a way that O atoms are not linked directly to one another, and preferably denotes alkyl having 1 to 12 C atoms or alkenyl having 2 to 9 C atoms.

The compounds of the formula II are preferably selected from the group consisting of the following formulae:

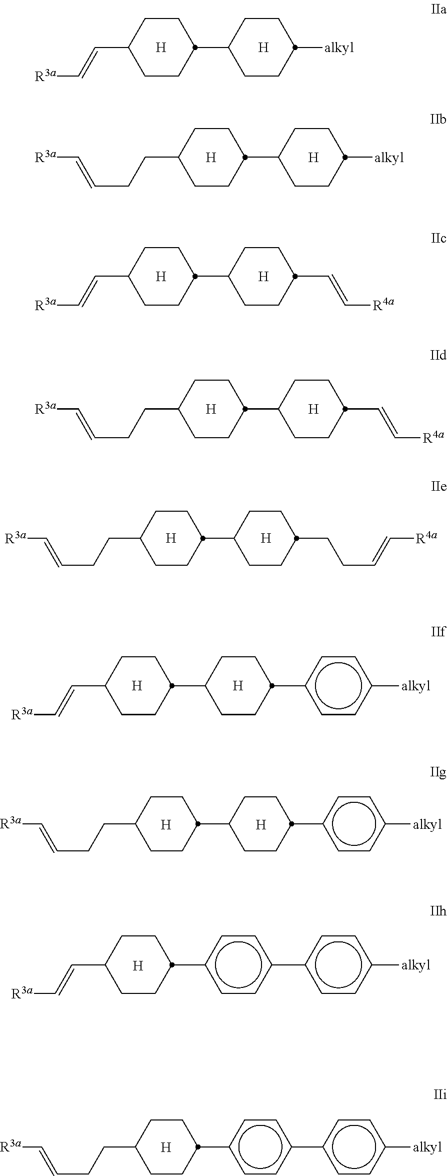

in which R^{3a} and R^{4a} each, independently of one another, denote H, CH₃, C₂H₅ or C₃H₇, and “alkyl” denotes a straight-chain alkyl group having 1 to 8, preferably 1, 2, 3, 4 or 5, C atoms. Particular preference is given to compounds of the formulae IIa and IIIf, in particular those in which R^{3a} denotes H or CH₃, preferably H, and compounds of the formula IIc, in particular those in which R^{3a} and R^{4a} denote H, CH₃ or O₂H₅.

The nematic phase of the LC medium in accordance with the invention preferably has a nematic phase in a temperature range from 10° C. or less to 60° C. or more, particularly preferably from 0 or less to 70° C. or more.

For the purposes of the present application, the two formulae for substituted benzene rings

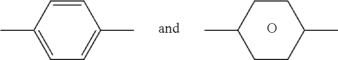

are equivalent. 1,4-substituted cyclohexane is represented by

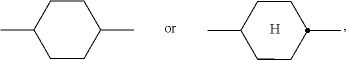

which is preferably in the 1,4-trans-configuration.

The following abbreviations are used:

(n, m, z: in each case, independently of one another, 1, 2, 3, 4, 5 or 6)

TABLE A

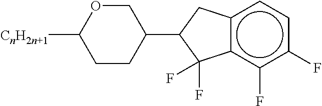

AIK-n-F

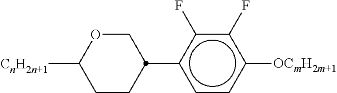

AIY-n-Om

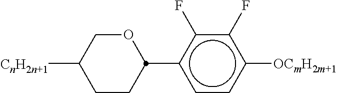

AY-n-Om

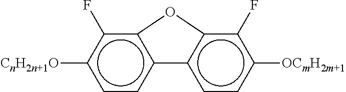

B-nO-Om

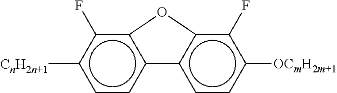

B-n-Om

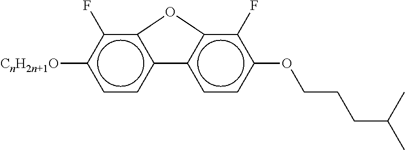

B-nO-O5i

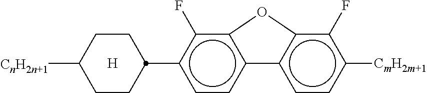

CB-n-m

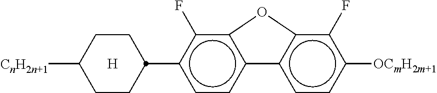

CB-n-Om

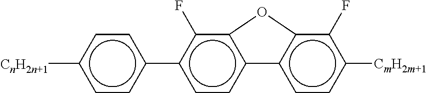

PB-n-m

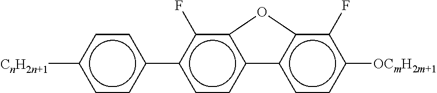

PB-n-Om

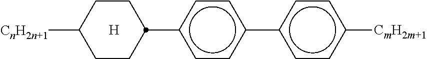

BCH-nm

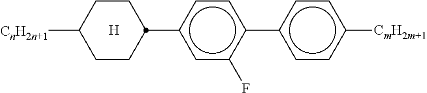

BCH-nmF

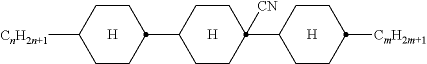

BCN-nm

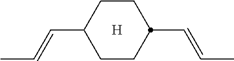

C-1V-V1

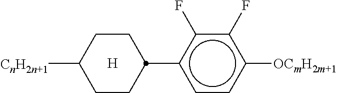

CY-n-Om

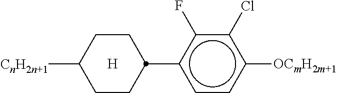

CY(F,Cl)-n-Om

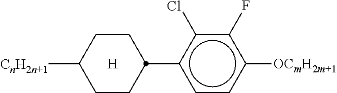

CY(Cl,F)-n-Om

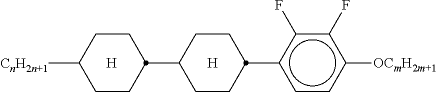

CCY-n-Om

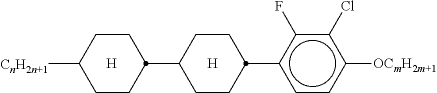

CCY(F,Cl)-n-Om

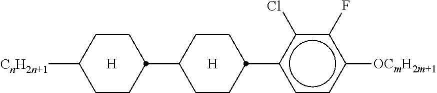

CCY(Cl,F)-n-Om

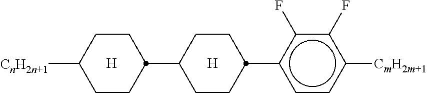

CCY-n-m

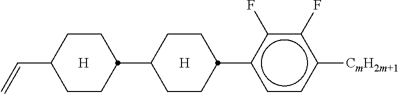

CCY-V-m

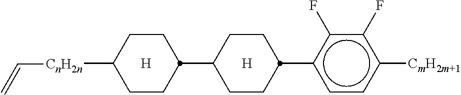

CCY-Vn-m

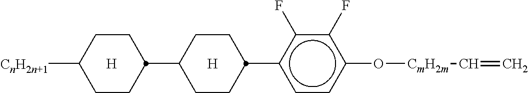

CCY-n-OmV

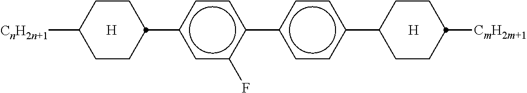

CBC-nmF

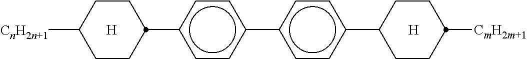

CBC-nm

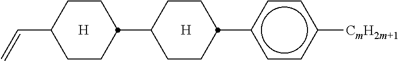

CCP-V-m

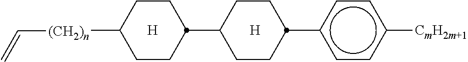

CCP-Vn-m

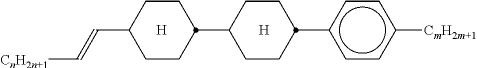

CCP-nV-m

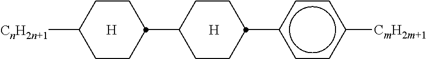

CCP-n-m

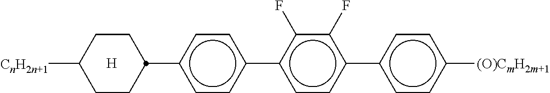

CPYP-n-(O)m

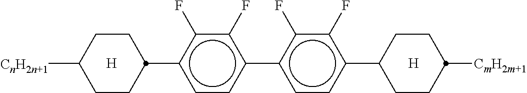

CYYC-n-m

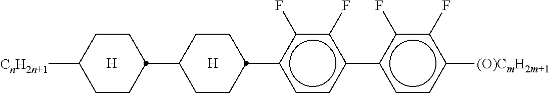

CCYY-n-(O)m

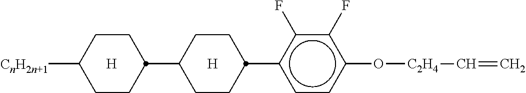

CCY-n-O2V

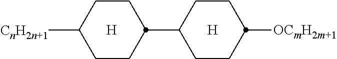

CCH-nOm

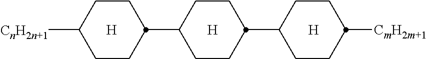

CCC-n-m

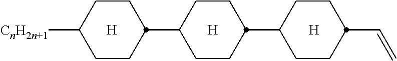

CCC-n-V

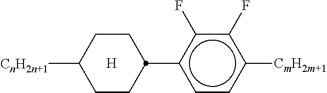

CY-n-m

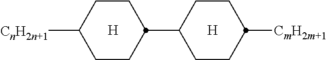

CCH-nm

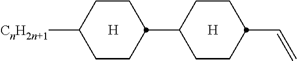

CC-n-V

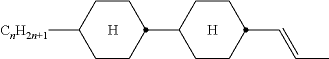

CC-n-V1

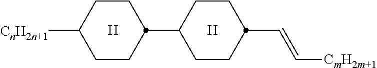

CC-n-Vm

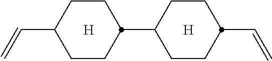

CC-V-V

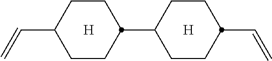

CC-V-V1

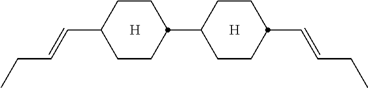

CC-2V-V2

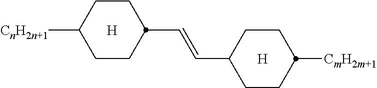

CVC-n-m

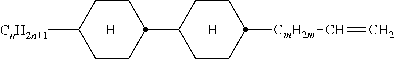

CC-n-mV

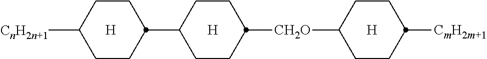

CCOC-n-m

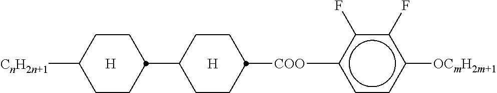

CP-nOmFF

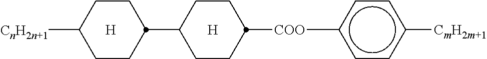

CH-nm

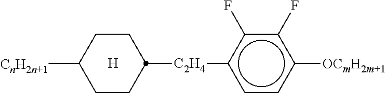

CEY-n-Om

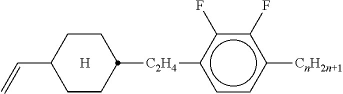

CEY-V-n

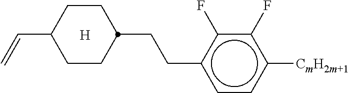

CVY-V-n

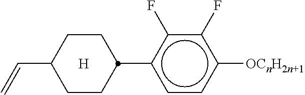

CY-V-On

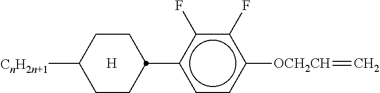

CY-n-O1V

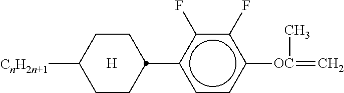

CY-n-OC(CH₃)═CH₂

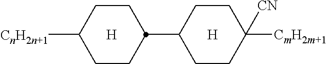

CCN-nm

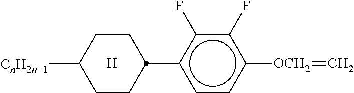

CY-n-OV

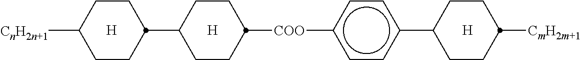

CCPC-nm

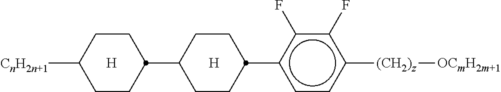

CCY-n-zOm

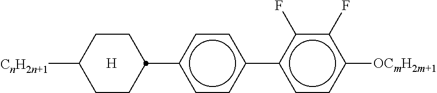

CPY-n-Om

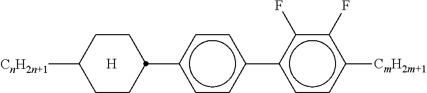

CPY-n-m

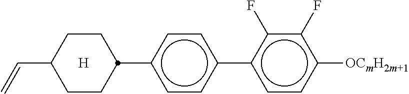

CPY-V-Om

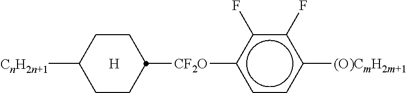

CQY-n-(O)m

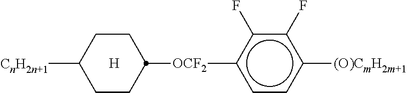

CQIY-n-(O)m

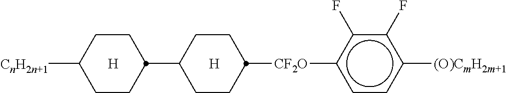

CCQY-n-(O)m

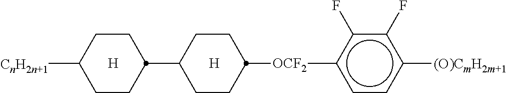

CCQIY-n-(O)m

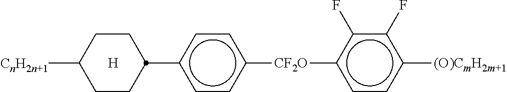

CPQY-n-(O)m

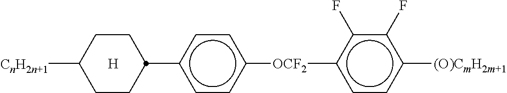

CPQIY-n-(O)m

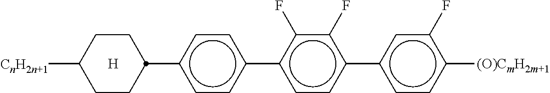

CPYG-n-(O)m

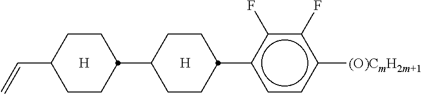

CCY-V-Om

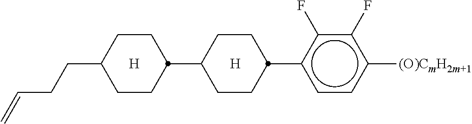

CCY-V2-(O)m

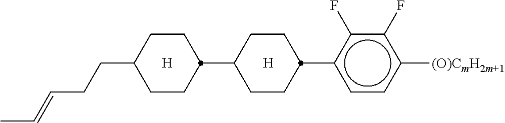

CCY-1V2-(O)m

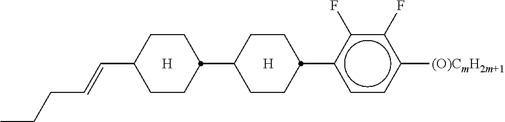

CCY-3V-(O)m

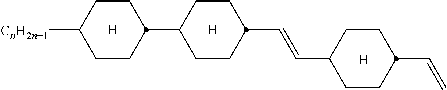

CCVC-n-V

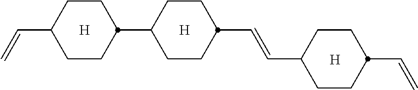

CCVC-V-V

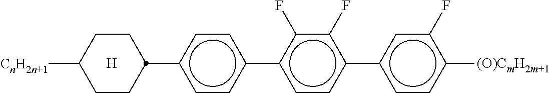

CPYG-n-(O)m

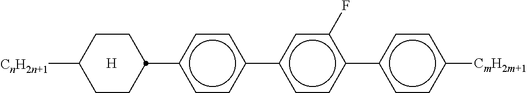

CPGP-n-m

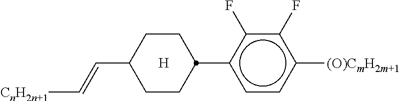

CY-nV-(O)m

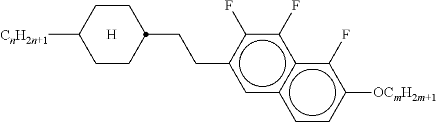

CENaph-n-Om

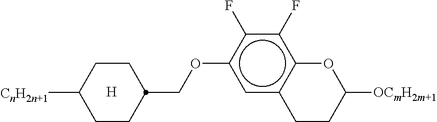

COChrom-n-Om

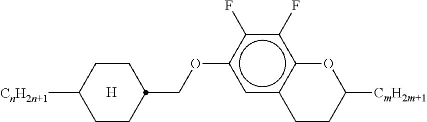

COChrom-n-m

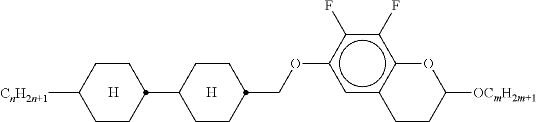

CCOChrom-n-Om

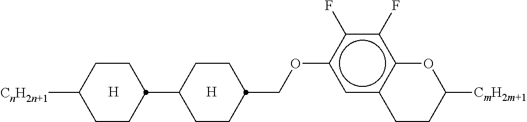

CCOChrom-n-m

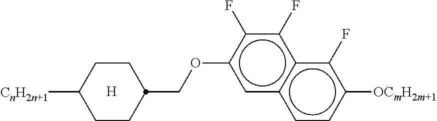

CONaph-n-Om

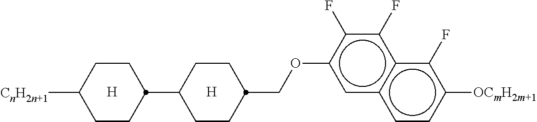

CCONaph-n-Om

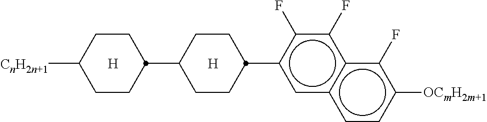

CCNaph-n-Om

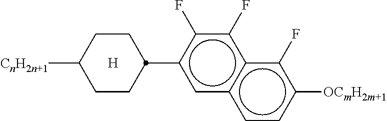

CNaph-n-Om

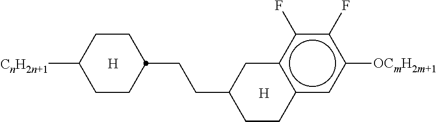

CETNaph-n-Om

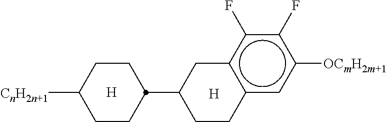

CTNaph-n-Om

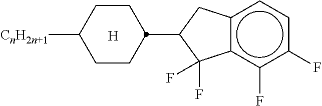

CK-n-F

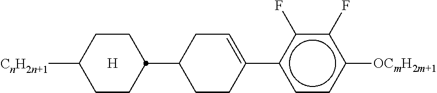

CLY-n-Om

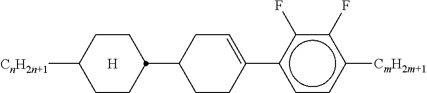

CLY-n-m

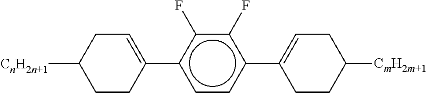

LYLI-n-m

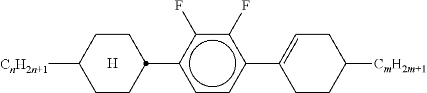

CYLI-n-m

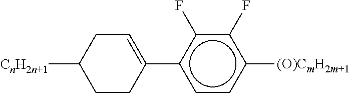

LY-n-(O)m

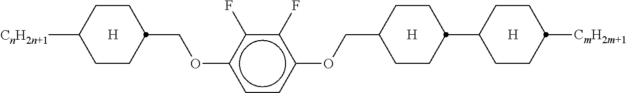

COYOICC-n-m

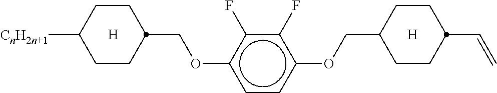

COYOIC-n-V

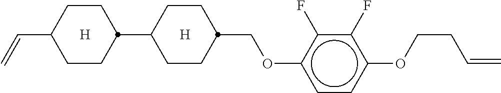

CCOY-V-O2V

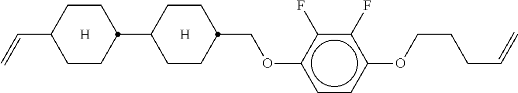

CCOY-V-O3V

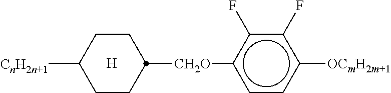

COY-n-Om

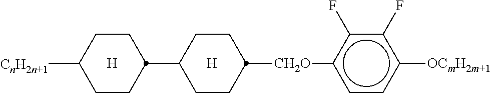

CCOY-n-Om

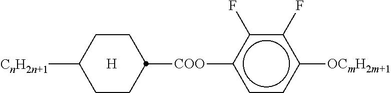

D-nOmFF

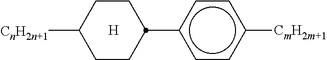

PCH-nm

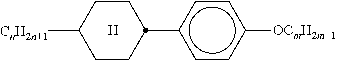

PCH-nOm

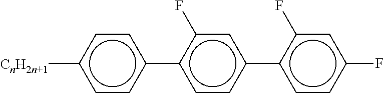

PGIGI-n-F

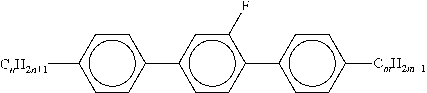

PGP-n-m

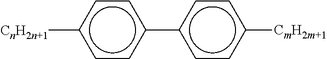

PP-n-m

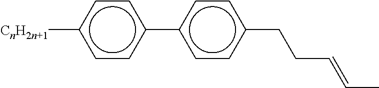

PP-n-2V1

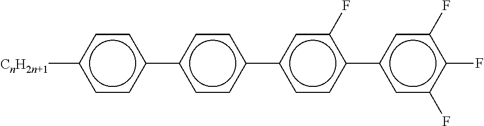

PPGU-n-F

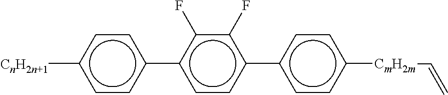

PYP-n-mV

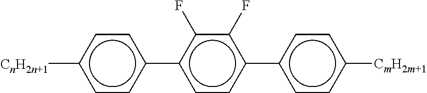

PYP-n-m

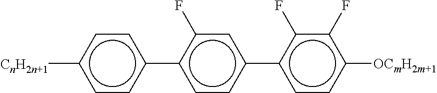

PGIY-n-Om

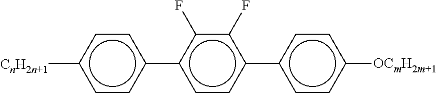

PYP-n-Om

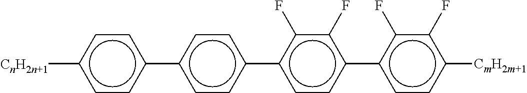

PPYY-n-m

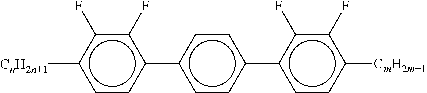

YPY-n-m

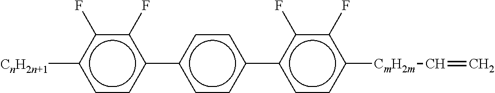

YPY-n-mV

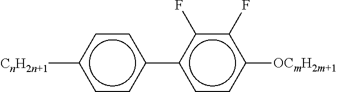

PY-n-Om

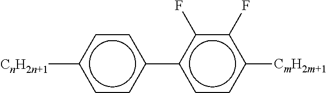

PY-n-m

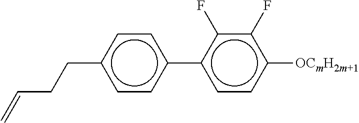

PY-V2-Om

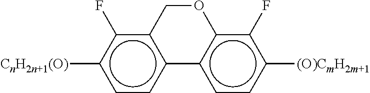

DFDBC-n(O)-(O)m

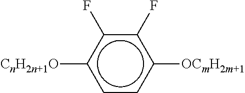

Y-nO-Om

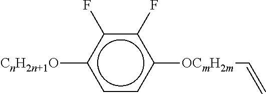

Y-nO-OmV

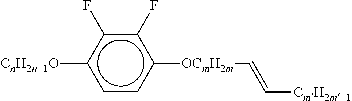

Y-nO-OmVm′

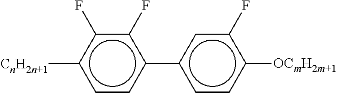

YG-n-Om

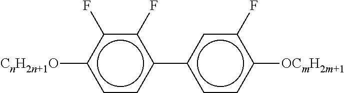

YG-nO-Om

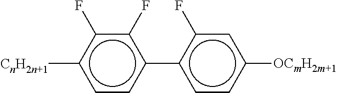

YGI-n-Om

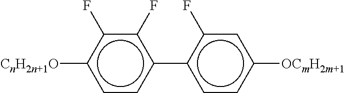

YGI-nO-Om

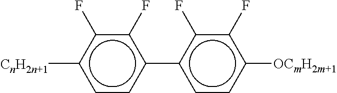

YY-n-Om

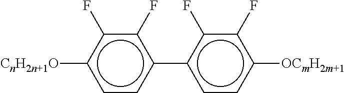

YY-nO-Om

In a preferred embodiment of the present invention, the LC media according to the invention comprise one or more compounds selected from the group consisting of compounds from Table A.

TABLE B

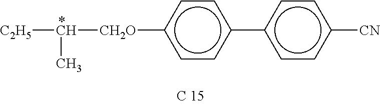

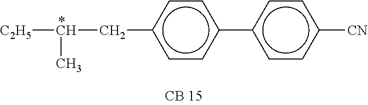

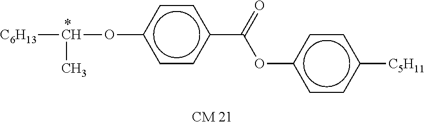

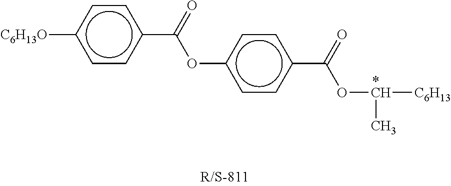

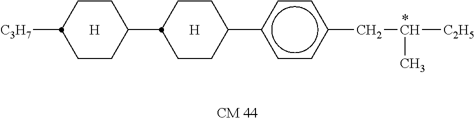

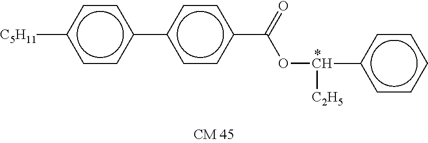

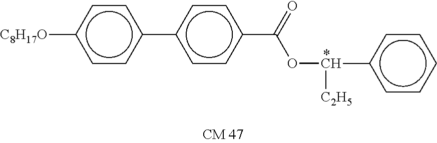

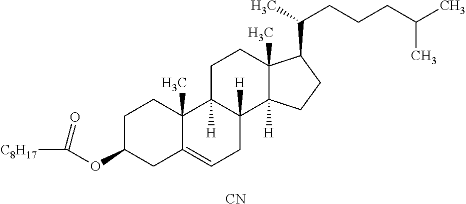

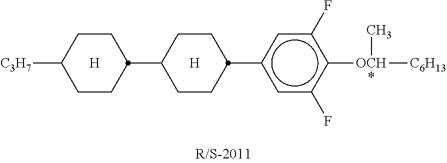

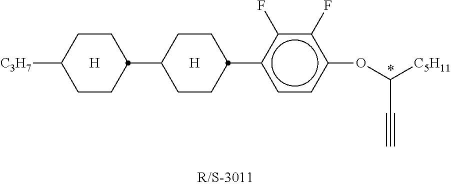

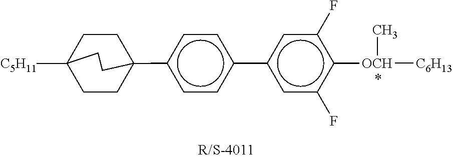

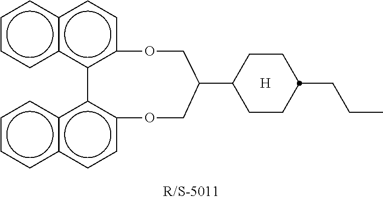

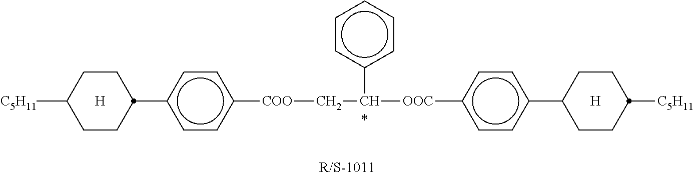

Table B shows possible chiral dopants which can be added to the LC media according to the invention. The LC media preferably comprise 0 to 10% by weight, in particular 0.01 to 5% by weight, particularly preferably 0.1 to 3% by weight, of dopants. The LC media preferably comprise one or more dopants selected from the group consisting of compounds from Table B.

TABLE C

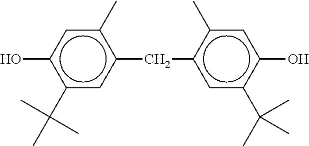

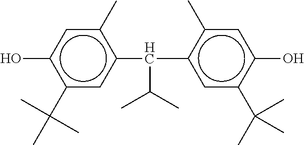

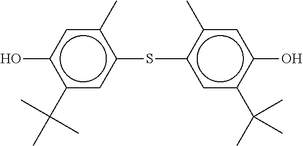

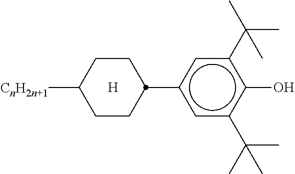

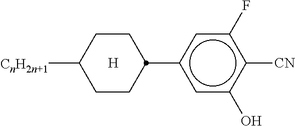

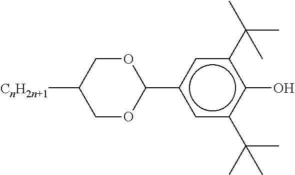

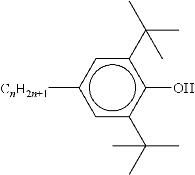

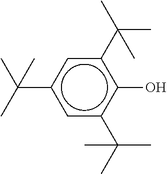

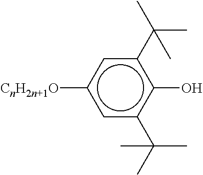

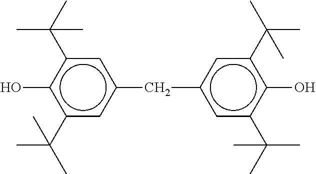

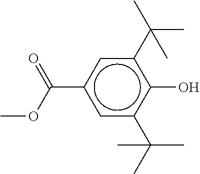

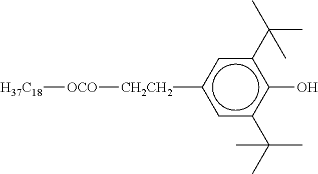

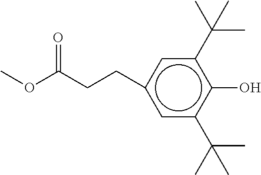

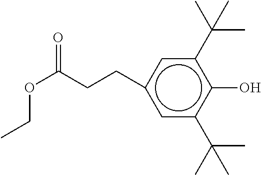

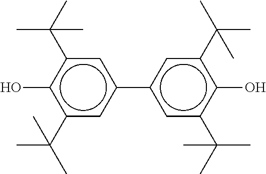

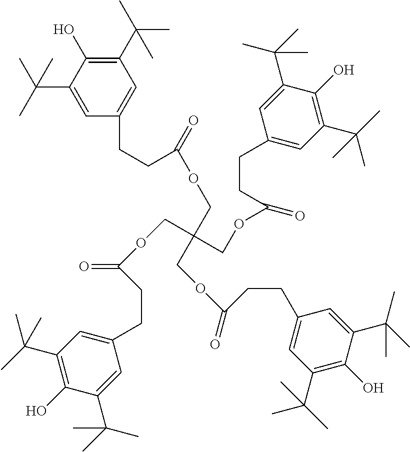 [SMILES: CC(C)(C)c1cc(CCC(=O)OCC(COC(=O)CCc2cc(C(C)(C)C)c(O)c(C(C)(C)C)c2)(COC(=O)CCc2cc(C(C)(C)C)c(O)c(C(C)(C)C)c2)COC(=O)CCc2cc(C(C)(C)C)c(O)c(C(C)(C)C)c2)cc(C(C)(C)C)c1O]

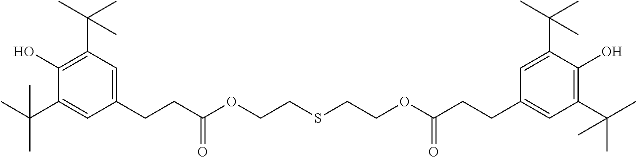 [SMILES: CC(C)(C)c1cc(CCC(=O)OCCSCCOC(=O)CCc2cc(C(C)(C)C)c(O)c(C(C)(C)C)c2)cc(C(C)(C)C)c1O]

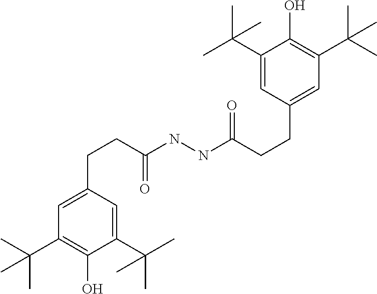 [SMILES: CC(C)(C)c1cc(CCC(=O)NNC(=O)CCc2cc(C(C)(C)C)c(O)c(C(C)(C)C)c2)cc(C(C)(C)C)c1O]

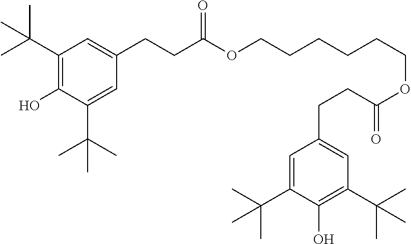 [SMILES: CC(C)(C)c1cc(CCC(=O)OCCCCCCOC(=O)CCc2cc(C(C)(C)C)c(O)c(C(C)(C)C)c2)cc(C(C)(C)C)c1O]

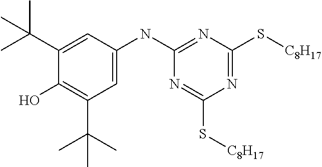

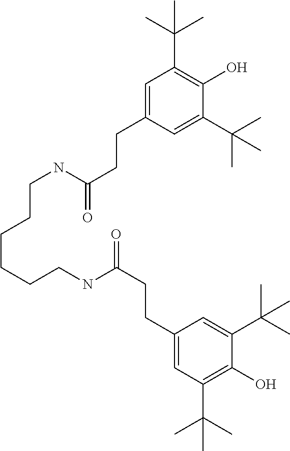 [SMILES: CC(C)(C)c1cc(CCC(=O)NCCCCCCNC(=O)CCc2cc(C(C)(C)C)c(O)c(C(C)(C)C)c2)cc(C(C)(C)C)c1O]

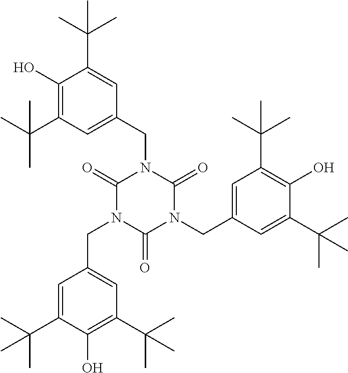 [SMILES: CC(C)(C)c1cc(Cn2c(=O)n(Cc3cc(C(C)(C)C)c(O)c(C(C)(C)C)c3)c(=O)n(Cc3cc(C(C)(C)C)c(O)c(C(C)(C)C)c3)c2=O)cc(C(C)(C)C)c1O]

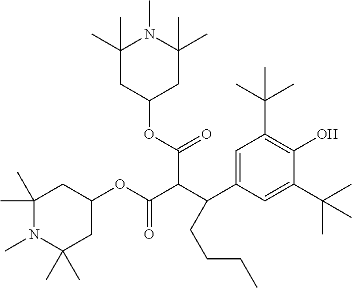 [SMILES: CCCCC(c1cc(C(C)(C)C)c(O)c(C(C)(C)C)c1)C(C(=O)OC1CC(C)(C)N(C)C(C)(C)C1)C(=O)OC1CC(C)(C)N(C)C(C)(C)C1]

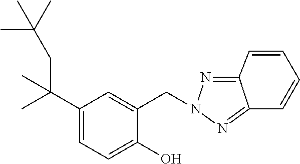 [SMILES: CC(C)(C)CC(C)(C)c1ccc(O)c(Cn2nc3ccccc3n2)c1]

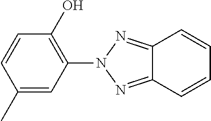 [SMILES: Cc1ccc(O)c(-n2nc3ccccc3n2)c1]

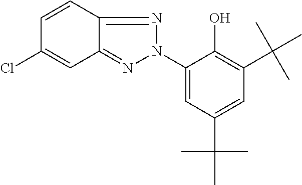 [SMILES: CC(C)(C)c1cc(-n2nc3ccc(Cl)cc3n2)c(O)c(C(C)(C)C)c1]

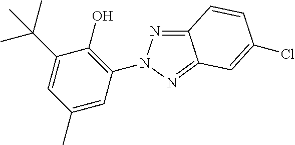 [SMILES: Cc1cc(-n2nc3ccc(Cl)cc3n2)c(O)c(C(C)(C)C)c1]

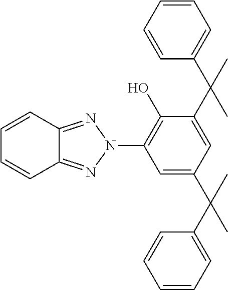 [SMILES: CC(C)(c1ccccc1)c1cc(-n2nc3ccccc3n2)c(O)c(C(C)(C)c2ccccc2)c1]

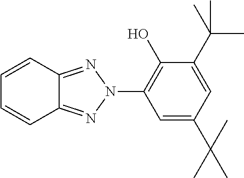 [SMILES: CC(C)(C)c1cc(-n2nc3ccccc3n2)c(O)c(C(C)(C)C)c1]

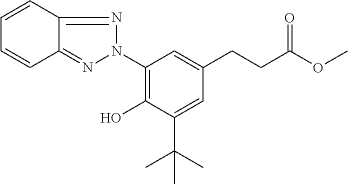 [SMILES: COC(=O)CCc1cc(-n2nc3ccccc3n2)c(O)c(C(C)(C)C)c1]

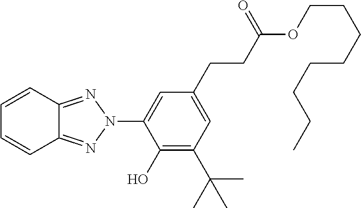 [SMILES: CCCCCCCCOC(=O)CCc1cc(-n2nc3ccccc3n2)c(O)c(C(C)(C)C)c1]

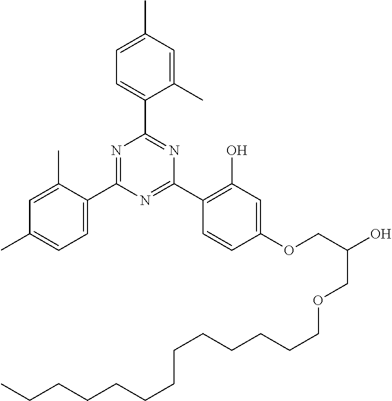 [SMILES: CCCCCCCCCCCCCOCC(O)COc1ccc(-c2nc(-c3ccc(C)cc3C)nc(-c3ccc(C)cc3C)n2)c(O)c1]

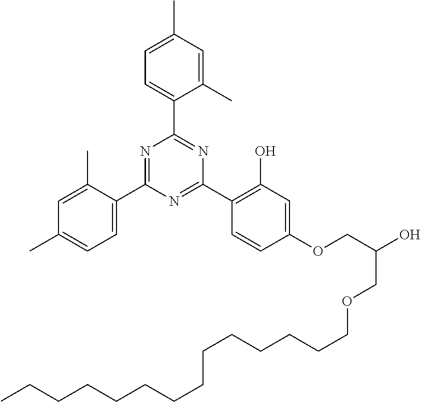 [SMILES: CCCCCCCCCCCCCCOCC(O)COc1ccc(-c2nc(-c3ccc(C)cc3C)nc(-c3ccc(C)cc3C)n2)c(O)c1]

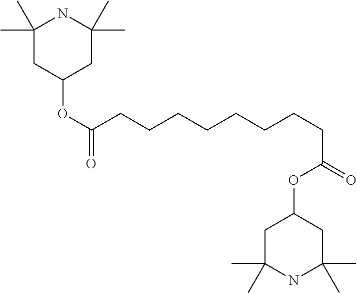

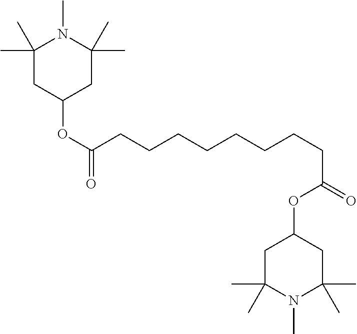

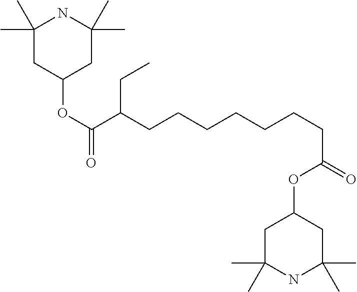

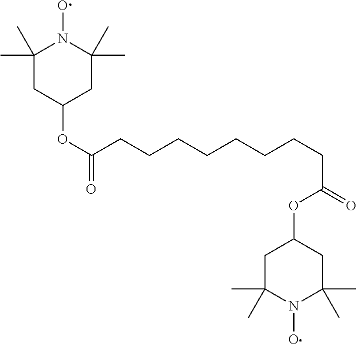

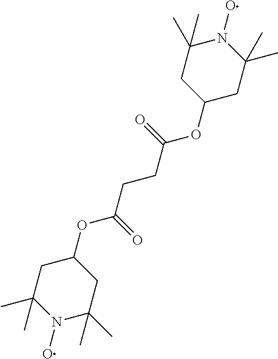

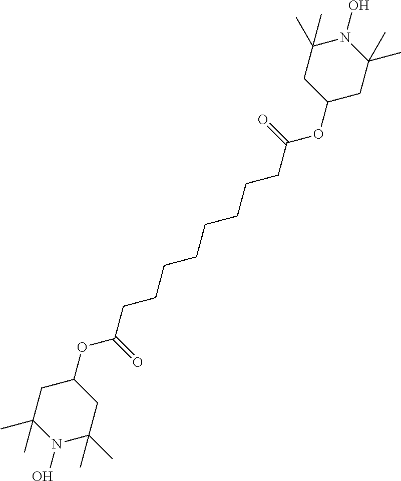

Table C shows possible stabilisers which can be added to the LC media according to the invention.

(n here denotes an integer from 1 to 12, preferably 1, 2, 3, 4, 5, 6, 7 or 8, terminal methyl groups are not shown).

The LC media preferably comprise 0 to 10% by weight, in particular 1 ppm to 5% by weight, particularly preferably 1 ppm to 1% by weight, of stabilisers. The LC media preferably comprise one or more stabilisers selected from the group consisting of compounds from Table C.

TABLE D

| | |
|---|---|
| 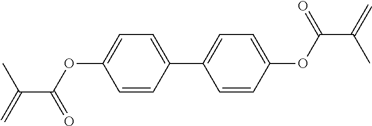 [SMILES: C=C(C)C(=O)Oc1ccc(-c2ccc(OC(=O)C(=C)C)cc2)cc1] | RM-1 |
| 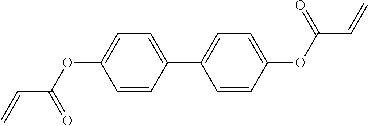 [SMILES: C=CC(=O)Oc1ccc(-c2ccc(OC(=O)C=C)cc2)cc1] | RM-2 |
| 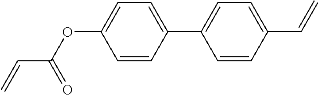 [SMILES: C=CC(=O)Oc1ccc(-c2ccc(C=C)cc2)cc1] | RM-3 |
| 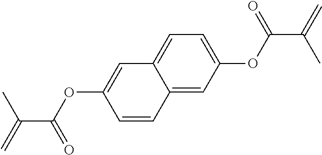 [SMILES: C=C(C)C(=O)Oc1ccc2cc(OC(=O)C(=C)C)ccc2c1] | RM-4 |
| 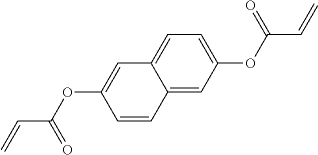 [SMILES: C=CC(=O)Oc1ccc2cc(OC(=O)C=C)ccc2c1] | RM-5 |
| 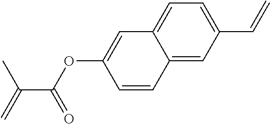 [SMILES: C=Cc1ccc2cc(OC(=O)C(=C)C)ccc2c1] | RM-6 |
| 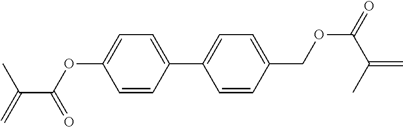 [SMILES: C=C(C)C(=O)OCc1ccc(-c2ccc(OC(=O)C(=C)C)cc2)cc1] | RM-7 |
| 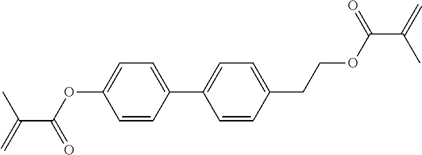 [SMILES: C=C(C)C(=O)OCCc1ccc(-c2ccc(OC(=O)C(=C)C)cc2)cc1] | RM-8 |
| 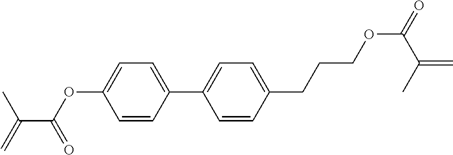 [SMILES: C=C(C)C(=O)OCCCc1ccc(-c2ccc(OC(=O)C(=C)C)cc2)cc1] | RM-9 |
| 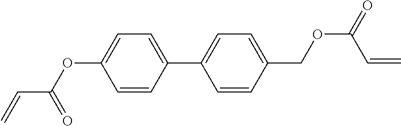 [SMILES: C=CC(=O)OCc1ccc(-c2ccc(OC(=O)C=C)cc2)cc1] | RM-10 |
| 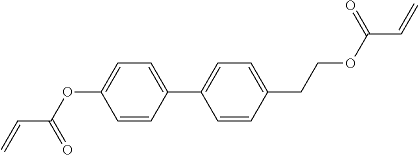 [SMILES: C=CC(=O)OCCc1ccc(-c2ccc(OC(=O)C=C)cc2)cc1] | RM-11 |
| 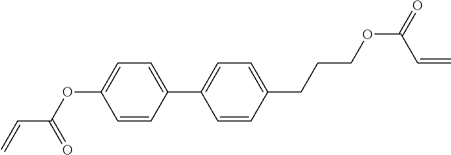 [SMILES: C=CC(=O)OCCCc1ccc(-c2ccc(OC(=O)C=C)cc2)cc1] | RM-12 |
| 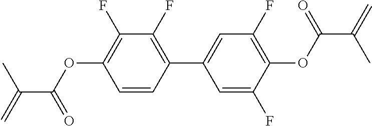 [SMILES: C=C(C)C(=O)Oc1ccc(-c2cc(F)c(OC(=O)C(=C)C)c(F)c2)c(F)c1F] | RM-13 |
| 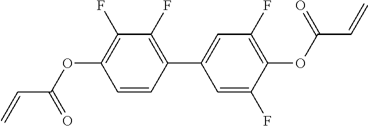 [SMILES: C=CC(=O)Oc1ccc(-c2cc(F)c(OC(=O)C=C)c(F)c2)c(F)c1F] | RM-14 |
| 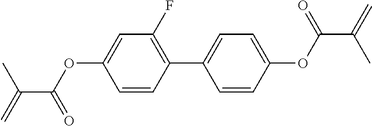 [SMILES: C=C(C)C(=O)Oc1ccc(-c2ccc(OC(=O)C(=C)C)cc2F)cc1] | RM-15 |
| 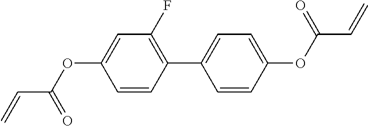 [SMILES: C=CC(=O)Oc1ccc(-c2ccc(OC(=O)C=C)cc2F)cc1] | RM-16 |
| 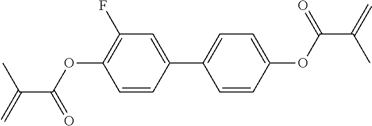 [SMILES: C=C(C)C(=O)Oc1ccc(-c2ccc(OC(=O)C(=C)C)c(F)c2)cc1] | RM-17 |
| 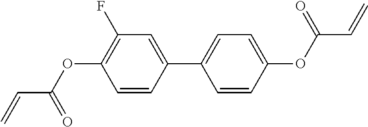 [SMILES: C=CC(=O)Oc1ccc(-c2ccc(OC(=O)C=C)c(F)c2)cc1] | RM-18 |
| 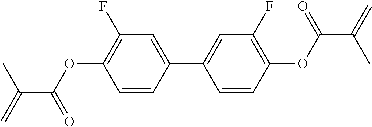 [SMILES: C=C(C)C(=O)Oc1ccc(-c2ccc(OC(=O)C(=C)C)c(F)c2)cc1F] | RM-19 |
| 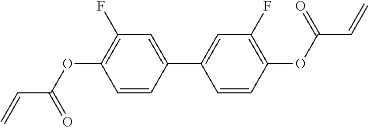 [SMILES: C=CC(=O)Oc1ccc(-c2ccc(OC(=O)C=C)c(F)c2)cc1F] | RM-20 |
| 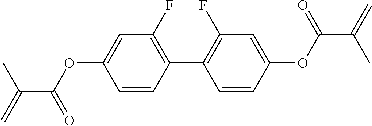 [SMILES: C=C(C)C(=O)Oc1ccc(-c2ccc(OC(=O)C(=C)C)cc2F)c(F)c1] | RM-21 |
| 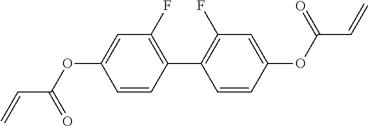 [SMILES: C=CC(=O)Oc1ccc(-c2ccc(OC(=O)C=C)cc2F)c(F)c1] | RM-22 |
| 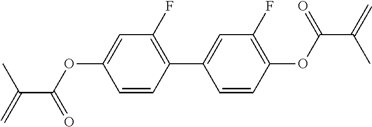 [SMILES: C=C(C)C(=O)Oc1ccc(-c2ccc(OC(=O)C(=C)C)c(F)c2)c(F)c1] | RM-23 |
| 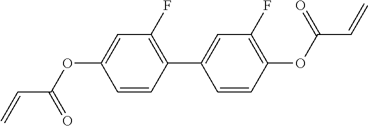 [SMILES: C=CC(=O)Oc1ccc(-c2ccc(OC(=O)C=C)c(F)c2)c(F)c1] | RM-24 |
| 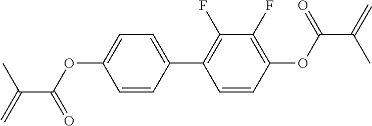 [SMILES: C=C(C)C(=O)Oc1ccc(-c2ccc(OC(=O)C(=C)C)c(F)c2F)cc1] | RM-25 |
| 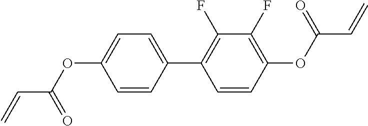 [SMILES: C=CC(=O)Oc1ccc(-c2ccc(OC(=O)C=C)c(F)c2F)cc1] | RM-26 |
| 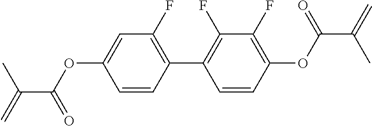 [SMILES: C=C(C)C(=O)Oc1ccc(-c2ccc(OC(=O)C(=C)C)c(F)c2F)c(F)c1] | RM-27 |
| 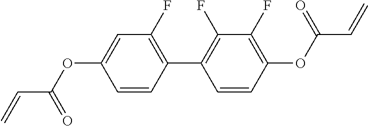 [SMILES: C=CC(=O)Oc1ccc(-c2ccc(OC(=O)C=C)c(F)c2F)c(F)c1] | RM-28 |
| 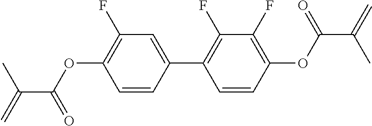 [SMILES: C=C(C)C(=O)Oc1ccc(-c2ccc(OC(=O)C(=C)C)c(F)c2F)cc1F] | RM-29 |
| 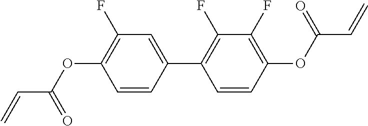 [SMILES: C=CC(=O)Oc1ccc(-c2ccc(OC(=O)C=C)c(F)c2F)cc1F] | RM-30 |
| 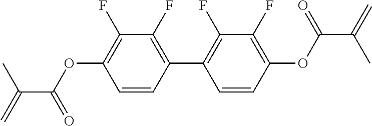 [SMILES: C=C(C)C(=O)Oc1ccc(-c2ccc(OC(=O)C(=C)C)c(F)c2F)c(F)c1F] | RM-31 |
| 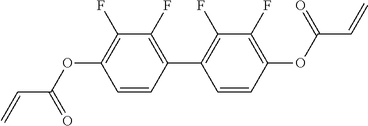 [SMILES: C=CC(=O)Oc1ccc(-c2ccc(OC(=O)C=C)c(F)c2F)c(F)c1F] | RM-32 |
| 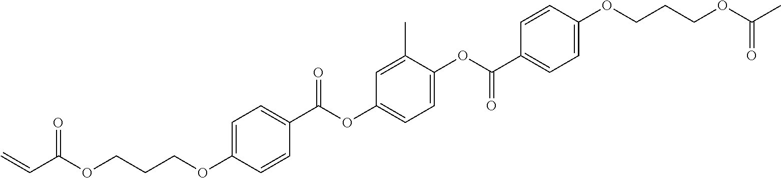 [SMILES: C=CC(=O)OCCCOc1ccc(C(=O)Oc2ccc(OC(=O)c3ccc(OCCCOC(C)=O)cc3)c(C)c2)cc1] | RM-33 |
| 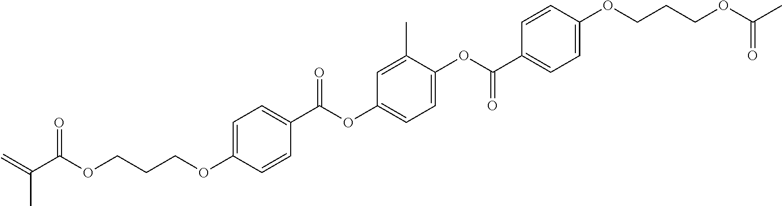 [SMILES: C=C(C)C(=O)OCCCOc1ccc(C(=O)Oc2ccc(OC(=O)c3ccc(OCCCOC(C)=O)cc3)c(C)c2)cc1] | RM-34 |
| 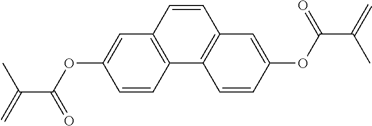 [SMILES: C=C(C)C(=O)Oc1ccc2c(ccc3cc(OC(=O)C(=C)C)ccc32)c1] | RM-35 |
| 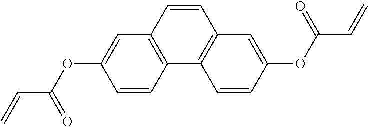 [SMILES: C=CC(=O)Oc1ccc2c(ccc3cc(OC(=O)C=C)ccc32)c1] | RM-36 |
| 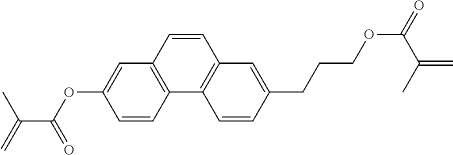 [SMILES: C=C(C)C(=O)OCCCc1ccc2c(ccc3cc(OC(=O)C(=C)C)ccc32)c1] | RM-37 |
| 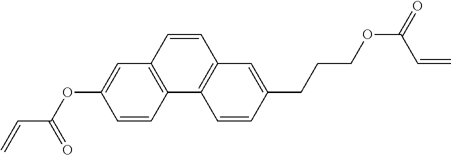 [SMILES: C=CC(=O)OCCCc1ccc2c(ccc3cc(OC(=O)C=C)ccc32)c1] | RM-38 |
| 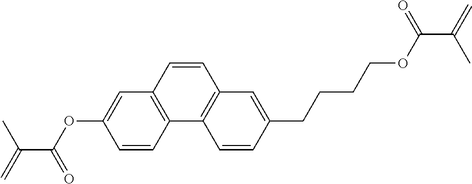 [SMILES: C=C(C)C(=O)OCCCCc1ccc2c(ccc3cc(OC(=O)C(=C)C)ccc32)c1] | RM-39 |
| 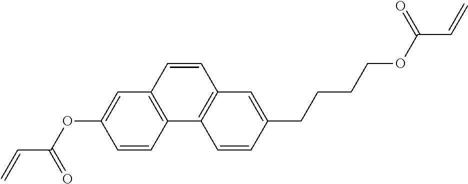 [SMILES: C=CC(=O)OCCCCc1ccc2c(ccc3cc(OC(=O)C=C)ccc32)c1] | RM-40 |
| 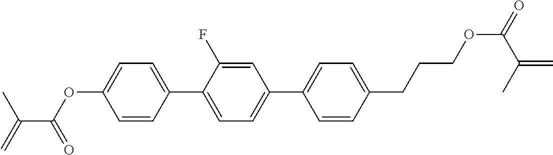 [SMILES: C=C(C)C(=O)OCCCc1ccc(-c2ccc(-c3ccc(OC(=O)C(=C)C)cc3)c(F)c2)cc1] | RM-41 |
| 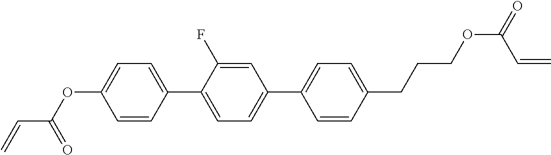 [SMILES: C=CC(=O)OCCCc1ccc(-c2ccc(-c3ccc(OC(=O)C=C)cc3)c(F)c2)cc1] | RM-42 |
| 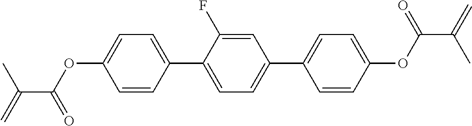 [SMILES: C=C(C)C(=O)Oc1ccc(-c2ccc(-c3ccc(OC(=O)C(=C)C)cc3)c(F)c2)cc1] | RM-43 |
| 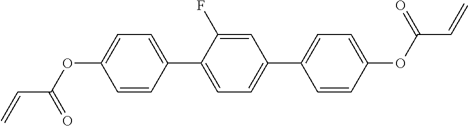 [SMILES: C=CC(=O)Oc1ccc(-c2ccc(-c3ccc(OC(=O)C=C)cc3)c(F)c2)cc1] | RM-44 |
| 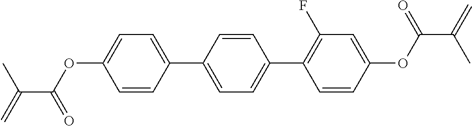 [SMILES: C=C(C)C(=O)Oc1ccc(-c2ccc(-c3ccc(OC(=O)C(=C)C)cc3F)cc2)cc1] | RM-45 |
| 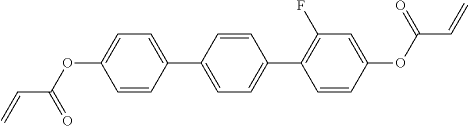 [SMILES: C=CC(=O)Oc1ccc(-c2ccc(-c3ccc(OC(=O)C=C)cc3F)cc2)cc1] | RM-46 |
| 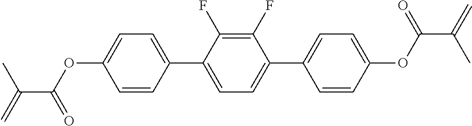 [SMILES: C=C(C)C(=O)Oc1ccc(-c2ccc(-c3ccc(OC(=O)C(=C)C)cc3)c(F)c2F)cc1] | RM-47 |
| 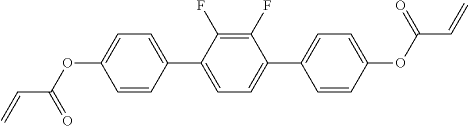 [SMILES: C=CC(=O)Oc1ccc(-c2ccc(-c3ccc(OC(=O)C=C)cc3)c(F)c2F)cc1] | RM-48 |
| 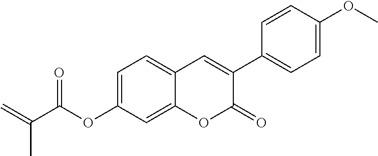 [SMILES: C=C(C)C(=O)Oc1ccc2cc(-c3ccc(OC)cc3)c(=O)oc2c1] | RM-49 |
| 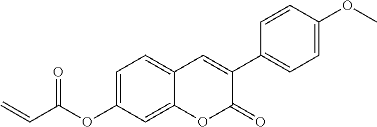 [SMILES: C=CC(=O)Oc1ccc2cc(-c3ccc(OC)cc3)c(=O)oc2c1] | RM-50 |
| 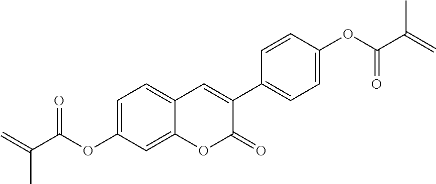 [SMILES: C=C(C)C(=O)Oc1ccc(-c2cc3ccc(OC(=O)C(=C)C)cc3oc2=O)cc1] | RM-51 |
| 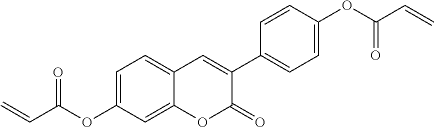 [SMILES: C=CC(=O)Oc1ccc(-c2cc3ccc(OC(=O)C=C)cc3oc2=O)cc1] | RM-52 |
| 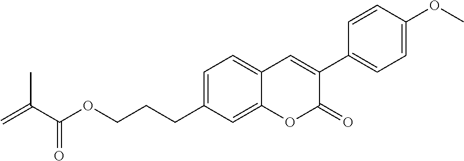 [SMILES: C=C(C)C(=O)OCCCc1ccc2cc(-c3ccc(OC)cc3)c(=O)oc2c1] | RM-53 |
| 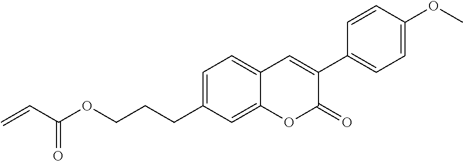 [SMILES: C=CC(=O)OCCCc1ccc2cc(-c3ccc(OC)cc3)c(=O)oc2c1] | RM-54 |
| 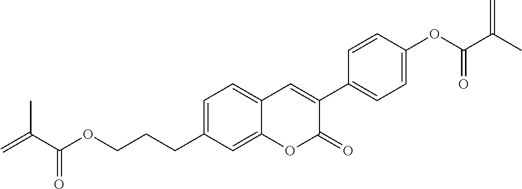 [SMILES: C=C(C)C(=O)OCCCc1ccc2cc(-c3ccc(OC(=O)C(=C)C)cc3)c(=O)oc2c1] | RM-55 |
| 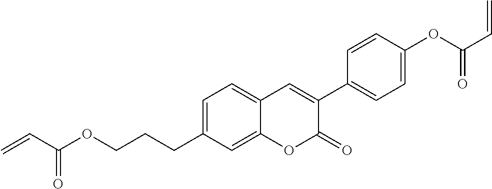 [SMILES: C=CC(=O)OCCCc1ccc2cc(-c3ccc(OC(=O)C=C)cc3)c(=O)oc2c1] | RM-56 |
| 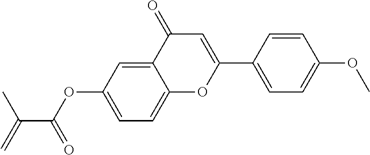 [SMILES: C=C(C)C(=O)Oc1ccc2oc(-c3ccc(OC)cc3)cc(=O)c2c1] | RM-57 |
| 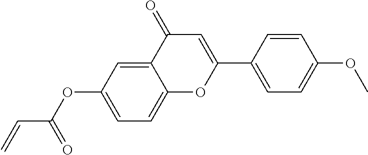 [SMILES: C=CC(=O)Oc1ccc2oc(-c3ccc(OC)cc3)cc(=O)c2c1] | RM-58 |
| 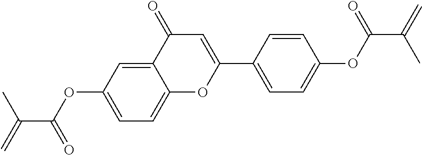 [SMILES: C=C(C)C(=O)Oc1ccc(-c2cc(=O)c3cc(OC(=O)C(=C)C)ccc3o2)cc1] | RM-59 |
| 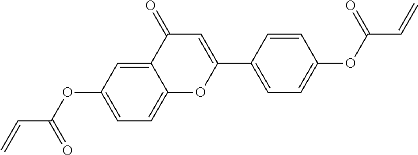 [SMILES: C=CC(=O)Oc1ccc(-c2cc(=O)c3cc(OC(=O)C=C)ccc3o2)cc1] | RM-60 |
| 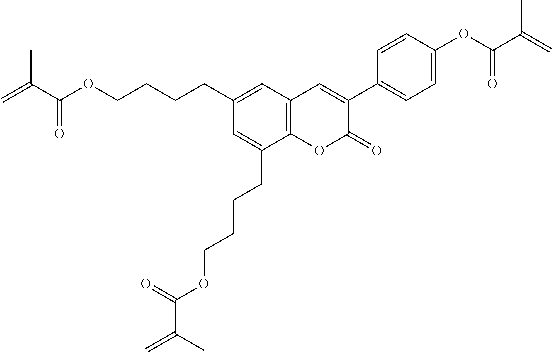 [SMILES: C=C(C)C(=O)OCCCCc1cc(CCCCOC(=O)C(=C)C)c2oc(=O)c(-c3ccc(OC(=O)C(=C)C)cc3)cc2c1] | RM-61 |
| 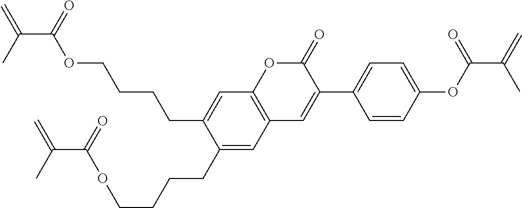 [SMILES: C=C(C)C(=O)OCCCCc1cc2cc(-c3ccc(OC(=O)C(=C)C)cc3)c(=O)oc2cc1CCCCOC(=O)C(=C)C] | RM-62 |
| 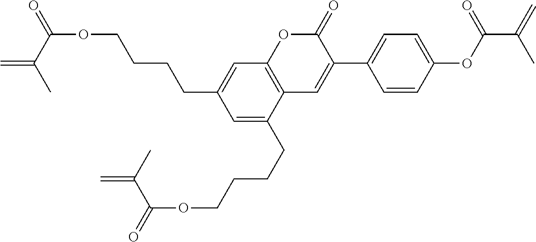 [SMILES: C=C(C)C(=O)OCCCCc1cc(CCCCOC(=O)C(=C)C)c2cc(-c3ccc(OC(=O)C(=C)C)cc3)c(=O)oc2c1] | RM-63 |
| 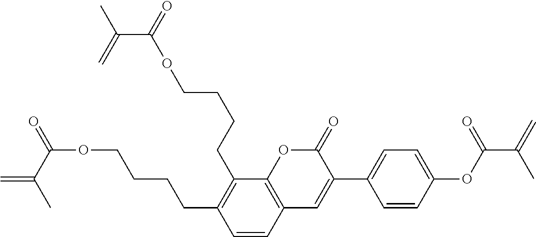 [SMILES: C=C(C)C(=O)OCCCCc1ccc2cc(-c3ccc(OC(=O)C(=C)C)cc3)c(=O)oc2c1CCCCOC(=O)C(=C)C] | RM-64 |
| 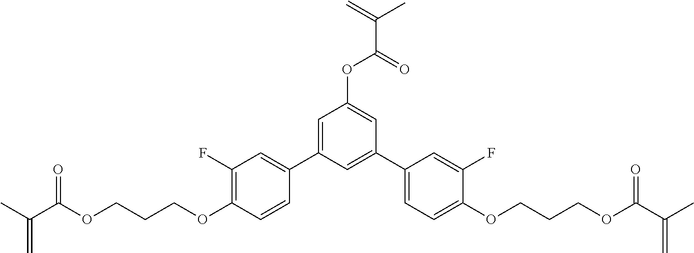 [SMILES: C=C(C)C(=O)OCCCOc1ccc(-c2cc(OC(=O)C(=C)C)cc(-c3ccc(OCCCOC(=O)C(=C)C)c(F)c3)c2)cc1F] | RM-65 |
| 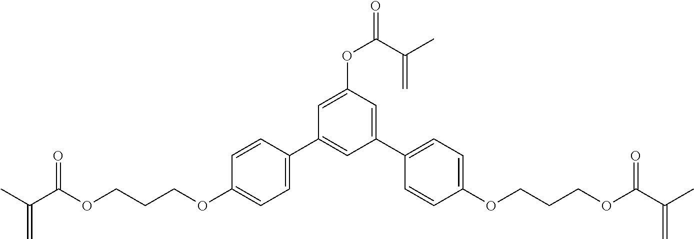 [SMILES: C=C(C)C(=O)OCCCOc1ccc(-c2cc(OC(=O)C(=C)C)cc(-c3ccc(OCCCOC(=O)C(=C)C)cc3)c2)cc1] | RM-66 |
| 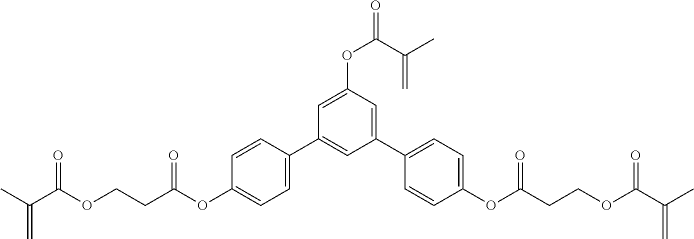 [SMILES: C=C(C)C(=O)OCCC(=O)Oc1ccc(-c2cc(OC(=O)C(=C)C)cc(-c3ccc(OC(=O)CCOC(=O)C(=C)C)cc3)c2)cc1] | RM-67 |
| 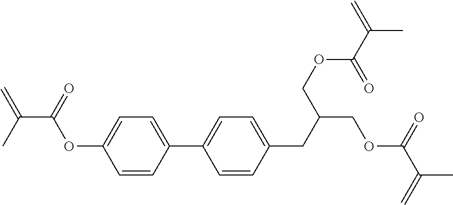 [SMILES: C=C(C)C(=O)OCC(COC(=O)C(=C)C)Cc1ccc(-c2ccc(OC(=O)C(=C)C)cc2)cc1] | RM-68 |
| 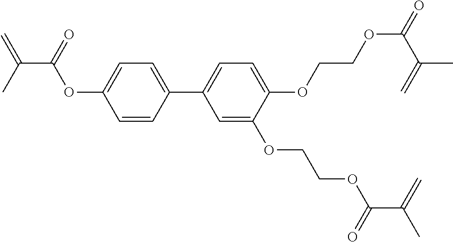 [SMILES: C=C(C)C(=O)OCCOc1ccc(-c2ccc(OC(=O)C(=C)C)cc2)cc1OCCOC(=O)C(=C)C] | RM-69 |
| 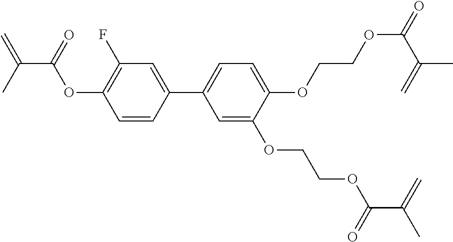 [SMILES: C=C(C)C(=O)OCCOc1ccc(-c2ccc(OC(=O)C(=C)C)c(F)c2)cc1OCCOC(=O)C(=C)C] | RM-70 |
| 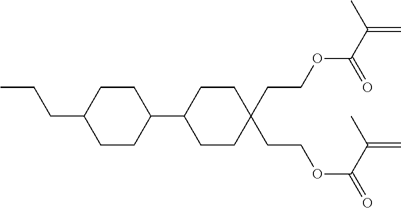 [SMILES: C=C(C)C(=O)OCCC1(CCOC(=O)C(=C)C)CCC(C2CCC(CCC)CC2)CC1] | RM-71 |
| 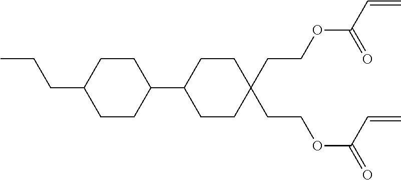 [SMILES: C=CC(=O)OCCC1(CCOC(=O)C=C)CCC(C2CCC(CCC)CC2)CC1] | RM-72 |
| 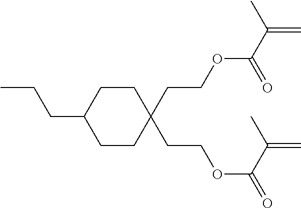 [SMILES: C=C(C)C(=O)OCCC1(CCOC(=O)C(=C)C)CCC(CCC)CC1] | RM-73 |
| 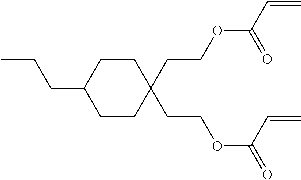 [SMILES: C=CC(=O)OCCC1(CCOC(=O)C=C)CCC(CCC)CC1] | RM-74 |
| 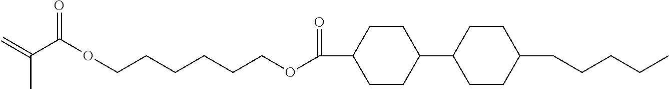 [SMILES: C=C(C)C(=O)OCCCCCCOC(=O)C1CCC(C2CCC(CCCCC)CC2)CC1] | RM-75 |
| 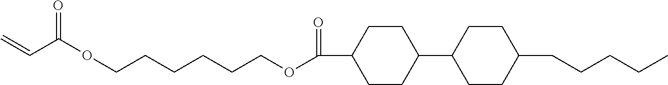 [SMILES: C=CC(=O)OCCCCCCOC(=O)C1CCC(C2CCC(CCCCC)CC2)CC1] | RM-76 |
| 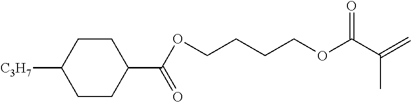 | RM-77 |
| 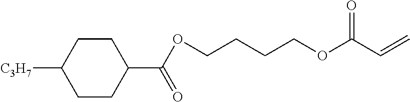 | RM-78 |

Table D shows illustrative compounds which can be used in the LC media in accordance with the present invention, preferably as polymerizable compounds.

In a preferred embodiment of the present invention, the mesogenic media comprise one or more compounds selected from the group of the compounds from Table D.

TABLE E

| | |
|---|---|
| 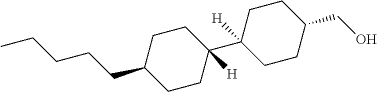 [SMILES: CCCCC[C@H]1CC[C@H]([C@H]2CC[C@H](CO)CC2)CC1] | A-1 |
| 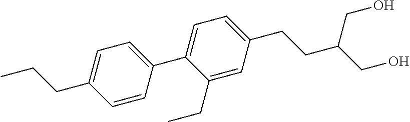 [SMILES: CCCc1ccc(-c2ccc(CCC(CO)CO)cc2CC)cc1] | A-2 |
| 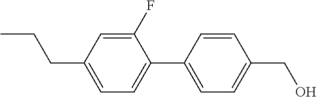 [SMILES: CCCc1ccc(-c2ccc(CO)cc2)c(F)c1] | A-3 |
| 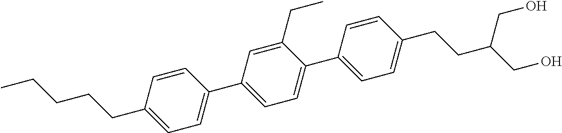 [SMILES: CCCCCc1ccc(-c2ccc(-c3ccc(CCC(CO)CO)cc3)c(CC)c2)cc1] | A-4 |
| 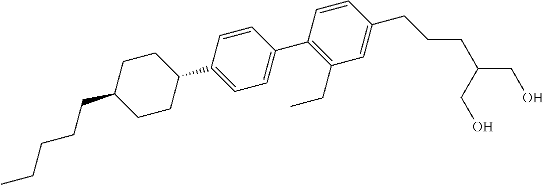 [SMILES: CCCCC[C@H]1CC[C@H](c2ccc(-c3ccc(CCCC(CO)CO)cc3CC)cc2)CC1] | A-5 |
| 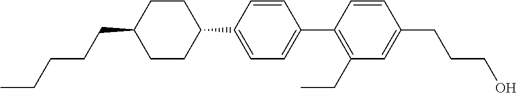 [SMILES: CCCCC[C@H]1CC[C@H](c2ccc(-c3ccc(CCCO)cc3CC)cc2)CC1] | A-6 |
| 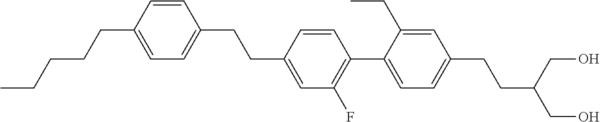 [SMILES: CCCCCc1ccc(CCc2ccc(-c3ccc(CCC(CO)CO)cc3CC)c(F)c2)cc1] | A-7 |
| 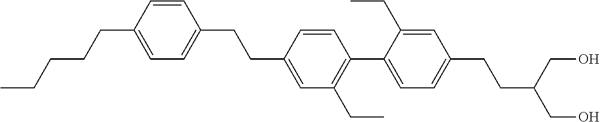 [SMILES: CCCCCc1ccc(CCc2ccc(-c3ccc(CCC(CO)CO)cc3CC)c(CC)c2)cc1] | A-8 |
| 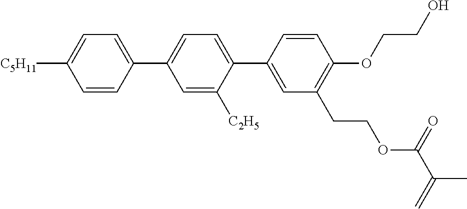 | A-9 |
| 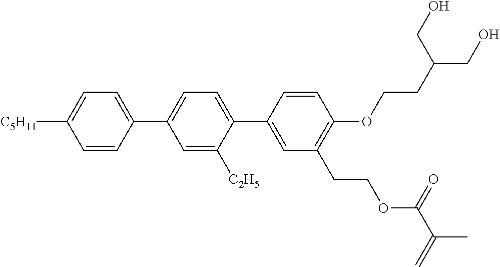 | A-10 |
| 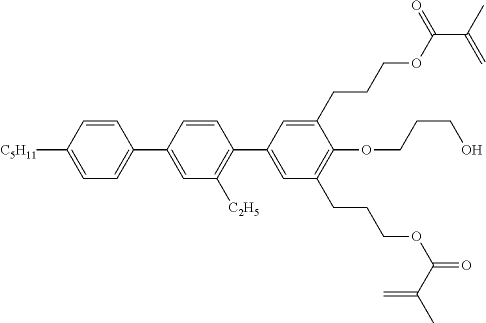 | A-11 |

Table E shows illustrative compounds which can be employed in the LC media in accordance with the present invention, preferably as further self-alignment additives.

In the present application, the term “compounds”, also written as “compound(s)”, denotes, unless explicitly indicated otherwise, both one and also a plurality of compounds. Conversely, the term “compound” generally also encompasses a plurality of compounds, if this is possible according to the definition and is not indicated otherwise. The same applies to the terms LC media and LC medium. The term “component” in each case encompasses one or more substances, compounds and/or particles.

In addition, the following abbreviations and symbols are used:
nₑ extraordinary refractive index at 20° C. and 589 nm,
nₒ ordinary refractive index at 20° C. and 589 nm,
Δn optical anisotropy at 20° C. and 589 nm,
ε_{⊥} dielectric permittivity perpendicular to the director at 20° C. and 1 kHz,
ε_{∥} dielectric permittivity parallel to the director at 20° C. and 1 kHz,
Δε dielectric anisotropy at 20° C. and 1 kHz,
cl.p., T(N,I) clearing point [° C.],
γ₁ rotational viscosity at 20° C. [mPa·s],
K₁ elastic constant, “splay” deformation at 20° C. [pN],
K₂ elastic constant, “twist” deformation at 20° C. [pN],
K₃ elastic constant, “bend” deformation at 20° C. [pN]
V₀ capacitive threshold (Freedericks threshold) at 20° C. [V].

Unless explicitly noted otherwise, all concentrations in the present application are quoted in percent by weight and relate to the corresponding mixture as a whole comprising all solid or liquid-crystalline components, without solvents.

All physical properties are and have been determined in accordance with “Merck Liquid Crystals, Physical Properties of Liquid Crystals”, Status Nov. 1997, Merck KGaA, Germany, and apply for a temperature of 20° C., and An is determined at 589 nm and Ac at 1 kHz, unless explicitly indicated otherwise in each case.

The polymerizable compounds are polymerized in the display or test cell by irradiation with UVA light (usually 365 nm) of defined intensity for a prespecified time, with a voltage optionally being applied simultaneously to the display (usually 10 to 30 V alternating current, 1 kHz). In the examples, unless indicated otherwise, a 100 mW/cm² mercury vapor lamp is used, and the intensity is measured using a standard UV meter (Ushio UNI meter) fitted with a 320 nm (optionally 340 nm) band-pass filter.

The following examples explain the present invention without intending to restrict it in any way. However, the physical properties make clear to the person skilled in the art what properties can be achieved and in what ranges they can be modified. In particular, the combination of the various properties which can preferably be achieved is thus well defined for the person skilled in the art.

Further combinations of the embodiments and variants of the invention in accordance with the description also arise from the claims.

### EXAMPLES

The compounds employed, if not commercially available, are synthesized by standard laboratory procedures. The LC media originate from Merck KGaA, Germany.

### A) Synthesis Examples

### Example 1

### Synthesis of 2-{4-[4-(4-ethylcyclohexyl)cyclohexyl]-2,3-difluorophenoxy}ethane-1-thiol 1

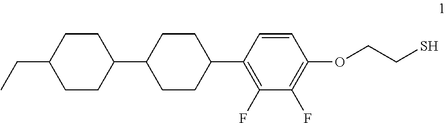 [SMILES: CCC1CCC(C2CCC(c3ccc(OCCS)c(F)c3F)CC2)CC1]

### 1) Synthesis of 1-[2-(benzyloxy)ethoxy]-4-[4-(4-ethylcyclohexyl)-cyclohexyl]-2,3-difluorobenzene A

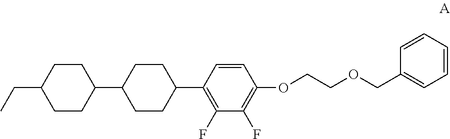 [SMILES: CCC1CCC(C2CCC(c3ccc(OCCOCc4ccccc4)c(F)c3F)CC2)CC1]

23.0 g (71.3 mmol) 4-[4-(4-ethylcyclohexyl)cyclohexyl]-2,3-difluoro-phenole, 20.0 g (90.0 mmol) (2-Brom-ethoxymethyl)benzene and 25.0 g (181 mmol) K₂CO₂ are solved in 500 mL methyl ethyl ketone and are refluxed for 16 h. The reaction mixture is filtered and further purified by column chromatography with toluene over 500 mL silica gel. The reaction product is concentrated under vacuum and further crystallized out of 400 mL ethanol to yield the product (27.5 g) as colourless crystals.

### 2) Synthesis of 2-{4-[4-(4-ethylcyclohexyl)cyclohexyl]-2,3-difluorophenoxy}ethane-1-ol

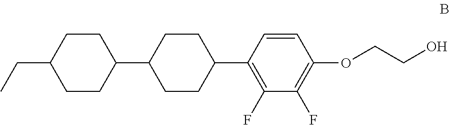 [SMILES: CCC1CCC(C2CCC(c3ccc(OCCO)c(F)c3F)CC2)CC1]

27.4 g (59.9 mmol) A are solved in 300 mL tetrahydrofuran, 2.70 g (Pd—C-5% E101 R [54% water]) are added and the reaction mixture is stirred under 1 bar hydrogen atmosphere for 16 h at room temperature. The reaction mixture is filtered and evaporated under vacuum to yield the reaction product (21.2 g) as colourless crystals.

### 3) Synthesis of 2-{4-[4-(4-ethylcyclohexyl)cyclohexyl]-2,3-difluorophenoxy}ethyl methanesulfonate C

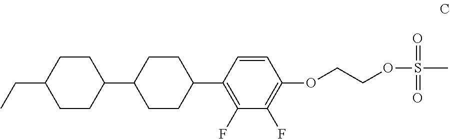 [SMILES: CCC1CCC(C2CCC(c3ccc(OCCOS(C)(=O)=O)c(F)c3F)CC2)CC1]

17.0 g (46.4 mmol) alcohol B and 500 mg (4.10 mmol) of 4-(dimethylamino)pyridine are dissolved in 200 mL dichloromethane and 8.0 mL (99.1 mmol) pyridine are added dropwise at 17-18° C. The reaction mixture is cooled to 3-4° C. and 4.0 mL (51.6 mmol) methanesufonyl-chloride are added slowly dropwise. The reaction mixture is stirred for 16 h at room temperature and cautiously treated with 2N HCl and further stirred for 1 h. The layers are separated, the water layer is extracted with dichloromethane and the combined organic layers are dried over Na₂SO₂, filtered and evaporated under vacuum. The resulting product is purified by column chromatography with dichloromethane over 400 g silica gel. The resulting product is evaporated under vacuum and crystallized out of acetonitrile at −20° C. to yield the product (20.6 g) as colourless crystals.

### 4) Synthesis of 1-[(2-{4-[4-(4-ethylcyclohexyl)cyclohexyl]-2,3-difluorophenoxy}ethyl)sulfanyl]ethan-1-one

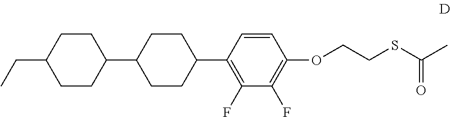 [SMILES: CCC1CCC(C2CCC(c3ccc(OCCSC(C)=O)c(F)c3F)CC2)CC1]

5.0 g (11.2 mmol) C and 10.0 g (87.6 mmol) of potassium-thioacetate are dissolved in 100 mL N,N-Dimethylformamide and stirred for 1 h at room temperature. The reaction mixture is cautiously poured in water and extracted with toluene. The combined organic layers are washed with brine, dried over Na₂SO₄, filtered and evaporated under vacuum. The obtained product is crystallized out of 100 mL acetonitrile at 5° C. to yield the product (3.5 g) as slightly yellow crystals.

### 5) Synthesis of 2-{4-[4-(4-ethylcyclohexyl)cyclohexyl]-2,3-difluorophenoxy}ethane-1-thiol 1

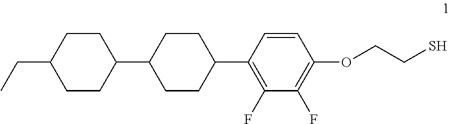 [SMILES: CCC1CCC(C2CCC(c3ccc(OCCS)c(F)c3F)CC2)CC1]

3.40 g (8.01 mmol) D are suspended in 150 mL of methanol, cooled to 2-3° C. and dropwise added with 7.0 ml of sodium methylate (30% solution in methanol). The reaction mixture is stirred for 30 min and cautiously neutralized with glacial acetic acid. The mixture is extracted with methyl-tertbutyl ether, washed with brine, dried over Na₂SO₄, filtered and evaporated under vacuum. The product is purified via column chromatography with heptane/toluene (8:2) over 150 mL silica gel. The obtained product is evaporated under vacuum and crystallized out of heptane at −25° C. to yield the product (1.8 g) as colourless crystals.

Phases: Tm 58° C./SmB 59° C./N 60.0° C. isotropic.

MS(EI): M⁺=382.3

¹H NMR (500 MHz, DMSO-d6):

δ=0.85 (t_{(overlapped with multiplet)}, 7.51 Hz, 5H, CH₃, CH₂), 0.92-1.09 (m, 4H, CH₂), 1.21-1.10 (m, 5H, CH₂, CH), 1.43 (me, 2H, CH₂), 1.84-1.68 (m, 8H, CH₂), 2.49 (t, 8.27 Hz_{(overlapped with DMSO)}, 1 H, SH), 2.67 (me, 1H, CH), 2.84 (m, 2H, CH₂S), 4.14 (t, 6.63 Hz, 2H, OCH₂), 6.48 (dt, 8.30, 1.23 Hz, 1H, arom.-H), 7.01 (dt, 8.20, 1.57 Hz, 1H, arom.-H).

### B) Mixture Examples

LC media according to the invention are prepared using the following liquid-crystalline mixtures consisting of low-molecular-weight components in the percentage proportions by weight indicated.

### H1: Nematic Host Mixture (Δε<0)

| | | | |
|---|---|---|---|
| CY-3-O2 | 15.50% | Clearing point [° C.]: | 75.1 |
| CCY-3-O3 | 8.00% | Δn [589 nm, 20° C.]: | 0.098 |
| CCY-4-O2 | 10.00% | Δε [1 kHz, 20° C.]: | −3.0 |
| CPY-2-O2 | 5.50% | ε_{\|\|} [1 kHz, 20° C.]: | 3.4 |
| CPY-3-O2 | 11.50% | ε_{⊥} [1 kHz, 20° C.]: | 6.4 |
| CCH-34 | 9.25% | K₁ [pN, 20° C.]: | 13.1 |
| CCH-23 | 24.50% | K₃ [pN, 20° C.]: | 13.3 |
| PYP-2-3 | 8.75% | γ₁ [mPa · s, 20° C.]: | 113 |
| PCH-3O1 | 7.00% | V₀ [20° C., V]: | 2.22 |

### H2: Nematic Host Mixture (Δε<0)

| | | | |
|---|---|---|---|
| CY-3-O4 | 14.00% | Clearing point [° C.]: | 80.0 |
| CCY-3-O2 | 9.00% | Δn [589 nm, 20° C.]: | 0.090 |
| CCY-3-O3 | 9.00% | Δε [1 kHz, 20° C.]: | −3.3 |
| CPY-2-O2 | 10.00% | ε_{\|\|} [1 kHz, 20° C.]: | 3.4 |
| CPY-3-O2 | 10.00% | ε_{⊥} [1 kHz, 20° C.]: | 6.7 |
| CCY-3-1 | 8.00% | K₁ [pN, 20° C.]: | 15.1 |
| CCH-34 | 9.00% | K₃ [pN, 20° C.]: | 14.6 |
| CCH-35 | 6.00% | γ₁ [mPa · s, 20° C.]: | 140 |
| PCH-53 | 10.00% | V₀ [20° C., V]: | 2.23 |
| CCH-3O1 | 6.00% | | |
| CCH-3O3 | 9.00% | | |

### H3: Nematic Host Mixture (Δε<0)

| | | | |
|---|---|---|---|
| CC-3-V1 | 9.00% | Clearing point [° C.]: | 74.7 |
| CCH-23 | 18.00% | Δn [589 nm, 20° C.]: | 0.098 |
| CCH-34 | 3.00% | Δε [1 kHz, 20° C.]: | −3.4 |
| CCH-35 | 7.00% | ε_{\|\|} [1 kHz, 20° C.]: | 3.5 |
| CCP-3-1 | 5.50% | ε_{⊥} [1 kHz, 20° C.]: | 6.9 |
| CCY-3-O2 | 11.50% | K₁ [pN, 20° C.]: | 14.9 |
| CPY-2-O2 | 8.00% | K₃ [pN, 20° C.]: | 15.9 |
| CPY-3-O2 | 11.00% | γ₁ [mPa · s, 20° C.]: | 108 |
| CY-3-O2 | 15.50% | V₀ [20° C., V]: | 2.28 |
| PY-3-O2 | 11.50% | | |

### H4: Nematic Host Mixture (Δε<0)

| | | | |
|---|---|---|---|
| CC-3-V | 37.50% | Clearing point [° C.]: | 74.8 |
| CC-3-V1 | 2.00% | Δn [589 nm, 20° C.]: | 0.099 |
| CCY-4-O2 | 14.50% | Δε [1 kHz, 20° C.]: | −2.9 |
| CPY-2-O2 | 10.50% | ε_{\|\|} [1 kHz, 20° C.]: | 3.7 |
| CPY-3-O2 | 9.50% | ε_{⊥} [1 kHz, 20° C.]: | 6.6 |
| CY-3-O2 | 15.00% | K₁ [pN, 20° C.]: | 12.2 |
| CY-3-O4 | 4.50% | K₃ [pN, 20° C.]: | 13.4 |
| PYP-2-4 | 5.50% | γ₁ [mPa · s, 20° C.]: | 92 |
| PPGU-3-F | 1.00% | V₀ [20° C., V]: | 2.28 |

### H5: Nematic Host Mixture (Δε<0)

| | | | |
|---|---|---|---|
| CCH-23 | 20.00% | Clearing point [° C.]: | 74.8 |
| CCH-3O1 | 6.00% | Δn [589 nm, 20° C.]: | 0.105 |
| CCH-34 | 6.00% | Δε [1 kHz, 20° C.]: | −3.2 |
| CCP-3-1 | 3.00% | ε_{\|\|} [1 kHz, 20° C.]: | 3.5 |
| CCY-3-O2 | 11.00% | ε_{⊥} [1 kHz, 20° C.]: | 6.8 |
| CPY-2-O2 | 12.00% | K₁ [pN, 20° C.]: | 12.7 |
| CPY-3-O2 | 11.00% | K₃ [pN, 20° C.]: | 13.6 |
| CY-3-O2 | 14.00% | γ₁ [mPa · s, 20° C.]: | 120 |
| CY-3-O4 | 4.00% | V₀ [20° C., V]: | 2.16 |
| PCH-3O1 | 4.00% | | |
| PYP-2-3 | 9.00% | | |

### H6: Nematic Host Mixture (Δε<0)

| | | | |
|---|---|---|---|
| CC-4-V | 17.00% | Clearing point [° C.]: | 106.1 |
| CCP-V-1 | 15.00% | Δn [589 nm, 20° C.]: | 0.120 |
| CCPC-33 | 2.50% | Δε [1 kHz, 20° C.]: | −3.6 |
| CCY-3-O2 | 4.00% | ε_{\|\|} [1 kHz, 20° C.]: | 3.5 |
| CCY-3-O3 | 5.00% | ε_{⊥} [1 kHz, 20° C.]: | 7.0 |
| CCY-4-O2 | 5.00% | K₁ [pN, 20° C.]: | 16.8 |
| CLY-3-O2 | 3.50% | K₃ [pN, 20° C.]: | 17.3 |
| CLY-3-O3 | 2.00% | γ₁ [mPa · s, 20° C.]: | 207 |
| CPY-2-O2 | 8.00% | V₀ [20° C., V]: | 2.33 |
| CPY-3-O2 | 10.00% | | |
| CY-3-O4 | 17.00% | | |
| PYP-2-3 | 11.00% | | |

### H7: Nematic Host Mixture (Δε<0)

| | | | |
|---|---|---|---|
| CY-3-O2 | 15.00% | Clearing point [° C.]: | 75.5 |
| CCY-4-O2 | 9.50% | Δn [589 nm, 20° C.]: | 0.108 |
| CCY-5-O2 | 5.00% | Δε [1 kHz, 20° C.]: | −3.0 |
| CPY-2-O2 | 9.00% | ε_{\|\|} [1 kHz, 20° C.]: | 3.5 |
| CPY-3-O2 | 9.00% | ε_{⊥} [1 kHz, 20° C.]: | 6.5 |
| CCH-34 | 9.00% | K₁ [pN, 20° C.]: | 12.9 |
| CCH-23 | 22.00% | K₃ [pN, 20° C.]: | 13.0 |
| PYP-2-3 | 7.00% | γ₁ [mPa · s, 20° C.]: | 115 |
| PYP-2-4 | 7.50% | V₀ [20° C., V]: | 2.20 |
| PCH-3O1 | 7.00% | | |

### H8: Nematic Host Mixture (Δε<0)

| | | | |
|---|---|---|---|
| CY-3-O2 | 15.00% | Clearing point [° C.]: | 74.7 |
| CY-5-O2 | 6.50% | Δn [589 nm, 20° C.]: | 0.108 |
| CCY-3-O2 | 11.00% | Δε [1 kHz, 20° C.]: | −3.0 |
| CPY-2-O2 | 5.50% | ε_{\|\|} [1 kHz, 20° C.]: | 3.6 |
| CPY-3-O2 | 10.50% | ε_{⊥} [1 kHz, 20° C.]: | 6.6 |
| CC-3-V | 28.50% | K₁ [pN, 20° C.]: | 12.9 |
| CC-3-V1 | 10.00% | K₃ [pN, 20° C.]: | 15.7 |
| PYP-2-3 | 12.50% | γ₁ [mPa · s, 20° C.]: | 97 |
| PPGU-3-F | 0.50% | V₀ [20° C., V]: | 2.42 |

### H9: Nematic Host Mixture (Δε<0)

| | | | |
|---|---|---|---|
| CCH-35 | 9.50% | Clearing point [° C.]: | 79.1 |
| CCH-5O1 | 5.00% | Δn [589 nm, 20° C.]: | 0.091 |
| CCY-2-1 | 9.50% | Δε [1 kHz, 20° C.]: | −3.6 |
| CCY-3-1 | 10.50% | ε_{\|\|} [1 kHz, 20° C.]: | 3.5 |
| CCY-3-O2 | 10.50% | ε_{⊥} [1 kHz, 20° C.]: | 7.1 |
| CCY-5-O2 | 9.50% | K₁ [pN, 20° C.]: | 14.6 |
| CPY-2-O2 | 12.00% | K₃ [pN, 20° C.]: | 14.5 |
| CY-3-O4 | 9.00% | γ₁ [mPa · s, 20° C.]: | 178 |
| CY-5-O4 | 11.00% | V₀ [20° C., V]: | 2.12 |
| PCH-53 | 13.50% | | |

### H10: Nematic Host Mixture (Δε<0)

| | | | |
|---|---|---|---|
| BCH-32 | 4.00% | Clearing point [° C.]: | 74.8 |
| CC-3-V1 | 8.00% | Δn [589 nm, 20° C.]: | 0.106 |
| CCH-23 | 13.00% | Δε [1 kHz, 20° C.]: | −3.5 |
| CCH-34 | 7.00% | ε_{\|\|} [1 kHz, 20° C.]: | 3.6 |
| CCH-35 | 7.00% | ε_{⊥} [1 kHz, 20° C.]: | 7.1 |
| CCY-3-O2 | 13.00% | K₁ [pN, 20° C.]: | 14.8 |
| CPY-2-O2 | 7.00% | K₃ [pN, 20° C.]: | 15.8 |
| CPY-3-O2 | 12.00% | γ₁ [mPa · s, 20° C.]: | 115 |
| CY-3-O2 | 12.00% | V₀ [20° C., V]: | 2.23 |
| PCH-3O1 | 2.00% | | |
| PY-3-O2 | 15.00% | | |

### H11: Nematic Host Mixture (Δε<0)

| | | | |
|---|---|---|---|
| CY-3-O4 | 22.00% | Clearing point [° C.]: | 86.9 |
| CY-5-O4 | 12.00% | Δn [589 nm, 20° C.]: | 0.111 |
| CCY-3-O2 | 6.00% | Δε [1 kHz, 20° C.]: | −4.9 |
| CCY-3-O3 | 6.00% | ε_{\|\|} [1 kHz, 20° C.]: | 3.8 |
| CCY-4-O2 | 6.00% | ε_{⊥} [1 kHz, 20° C.]: | 8.7 |
| CPY-2-O2 | 10.00% | K₁ [pN, 20° C.]: | 14.9 |
| CPY-3-O2 | 10.00% | K₃ [pN, 20° C.]: | 15.9 |
| PYP-2-3 | 7.00% | γ₁ [mPa · s, 20° C.]: | 222 |
| CC-3-V1 | 7.00% | V₀ [20° C., V]: | 1.91 |
| CC-5-V | 10.00% | | |
| CCPC-33 | 2.00% | | |
| CCPC-35 | 2.00% | | |

### H12: Nematic Host Mixture (Δε<0)

| | | | |
|---|---|---|---|
| CY-3-O4 | 12.00% | Clearing point [° C.]: | 86.0 |
| CY-5-O2 | 10.00% | Δn [589 nm, 20° C.]: | 0.110 |
| CY-5-O4 | 8.00% | Δε [1 kHz, 20° C.]: | −5.0 |
| CCY-3-O2 | 8.00% | ε_{\|\|} [1 kHz, 20° C.]: | 3.8 |
| CCY-4-O2 | 7.00% | ε_{⊥} [1 kHz, 20° C.]: | 8.8 |
| CCY-5-O2 | 6.00% | K₁ [pN, 20° C.]: | 14.7 |
| CCY-2-1 | 8.00% | K₃ [pN, 20° C.]: | 16.0 |
| CCY-3-1 | 7.00% | γ₁ [mPa · s, 20° C.]: | 250 |
| CPY-3-O2 | 9.00% | V₀ [20° C., V]: | 1.90 |
| CPY-3-O2 | 9.00% | | |
| BCH-32 | 6.00% | | |
| PCH-53 | 10.00% | | |

### H13: Nematic Host Mixture (Δε<0)

| | | | |
|---|---|---|---|
| CC-3-V1 | 10.25% | Clearing point [° C.]: | 74.7 |
| CCH-23 | 18.50% | Δn [589 nm, 20° C.]: | 0.103 |
| CCH-35 | 6.75% | Δε [1 kHz, 20° C.]: | −3.1 |
| CCP-3-1 | 6.00% | ε_{\|\|} [1 kHz, 20° C.]: | 3.4 |
| CCY-3-1 | 2.50% | ε_{⊥} [1 kHz, 20° C.]: | 6.4 |
| CCY-3-O2 | 12.00% | K₁ [pN, 20° C.]: | 15.4 |
| CPY-2-O2 | 6.00% | K₃ [pN, 20° C.]: | 16.8 |
| CPY-3-O2 | 9.75% | γ₁ [mPa · s, 20° C.]: | 104 |
| CY-3-O2 | 11.50% | V₀ [20° C., V]: | 2.46 |
| PP-1-2V1 | 3.75% | | |
| PY-3-O2 | 13.00% | | |

### H14: Nematic Host Mixture (Δε<0)

| | | | |
|---|---|---|---|
| CC-3-V | 27.50% | Clearing point [° C.]: | 74.7 |
| CC-3-V1 | 10.00% | Δn [589 nm, 20° C.]: | 0.104 |
| CCH-35 | 8.00% | Δε [1 kHz, 20° C.]: | −3.0 |
| CCY-3-O2 | 9.25% | ε_{\|\|} [1 kHz, 20° C.]: | 3.4 |
| CLY-3-O2 | 10.00% | ε_{⊥} [1 kHz, 20° C.]: | 6.4 |
| CPY-3-O2 | 11.75% | K₁ [pN, 20° C.]: | 15.3 |
| PY-3-O2 | 14.00% | K₃ [pN, 20° C.]: | 16.2 |
| PY-4-O2 | 9.00% | γ₁ [mPa · s, 20° C.]: | 88 |
| PYP-2-4 | 0.50% | V₀ [20° C., V]: | 2.44 |

The following self-alignment additives are particularly used:

| Self-alignment | |
|---|---|
| additive No. | Structure |
| 1 | 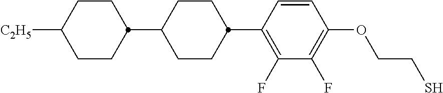 |
| 2 | 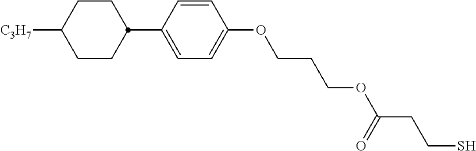 |

Compound 2 is commercially available from Angene (England).

The following polymerizable compound is used:

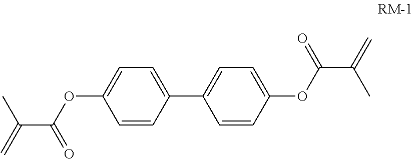 [SMILES: C=C(C)C(=O)Oc1ccc(-c2ccc(OC(=O)C(=C)C)cc2)cc1]

### Mixture Example 1

Self-alignment additive 1 (2.0% by weight) is added to a nematic LC medium H1 of the VA type (Δε<0) and the mixture is homogenized.

Low temperature stability (LTS) in a glass flask (−20° C., 1000 h): Passed. The LTS value is strongly improved over mixtures doped with the equivalent additive substituted with a hydroxyl group.

Use in Test Cells without Pre-Alignment Layer:

The mixture formed is introduced into a test cell (without polyimide alignment layer, layer thickness d=4.0 μm, ITO coated center on both sides, without passivation layer). The LC medium initially has partial spontaneous homeotropic (vertical) alignment with respect to the substrate surfaces. After heat treatment of the cell at 120° C. for 1 h, complete vertical alignment is observed between the ITO coated regions (dark region) of the cell, while the remaining part with pure glass substrates remains planar aligned (bright region). This alignment remains stable up to the clearing point, and the VA cell formed can be switched reversibly by application of a voltage.

### V-T-Curve at Different Temperatures:

Voltage versus transmittance (0-10 V) was measured at various temperatures (20, 40, 60° C.). Switching is stable up to 60° C. and no hysteresis of the curves is observed even at higher temperatures. The performance was not diminished after heat stress or electric stress, which indicates a good long-term stability.

### Mixture Example 2

Self-alignment additive 2 (5.0% by weight) and RM-1 (0.2% by weight) are added to a nematic LC medium H7 of the VA-type (Δε<0) and the mixture is homogenized.

Low temperature stability (LTS) in a glass flask (−25° C., 120 h): Passed.

Use in Test Cells without Pre-Alignment Layer:

The mixture formed is introduced into a test cell (as in Mixture Example 1). The LC medium initially has no spontaneous homeotropic (vertical) alignment with respect to the substrate surfaces. After heat treatment of the cell at 120° C. for 1 h, complete vertical alignment is observed between the ITO coated regions (dark region) of the cell, while the remaining part with pure glass substrates remains planar aligned (bright region). This alignment remains stable up to the clearing point, and the VA cell formed can be switched reversibly by application of a voltage.

### Mixture Example 3: Polymer Stabilization of Mixture Example 2

Self-alignment additive 2 (5.0% by weight) and RM-1 (0.2% by weight) are added to a nematic LC medium H7 of the VA-type (Δε<0) and the mixture is homogenized.

### Polymer Stabilization:

The mixture formed is introduced into a test cell (as in Mixture Example 2). The LC medium initially has no spontaneous homeotropic (vertical) alignment with respect to the substrate surfaces. After heat treatment of the cell at 120° C. for 1 h complete vertical alignment is observed between the ITO coated regions (dark region) of the cell. UV-curing process is performed by applying 6 J of UV light (50 mW/cm², 120 s) under the application of an electric field of 14 Vpp 60 Hz. The quality of the vertical alignment is not affected by the UV-step.

### V-T-Curve at Different Temperatures:

Voltage versus transmittance (0-30 V) was measured at various temperatures (20, 40, 60, 70° C.). Switching is stable up to 70° C. and no hysteresis of the curves is observed even at higher temperatures.

1. A liquid-crystal (LC) medium comprising a low-molecular-weight, non-polymerizable liquid-crystalline component and one or more compounds of formula I
R¹-[A³-Z³]ₘ[A²-Z²]ₙ-A¹-R^{a} (I)
in which
A¹, A², A³ each, independently of one another, denote an aromatic, heteroaromatic, alicyclic or heterocyclic group, which may also contain fused rings, and which may also be mono- or polysubstituted by a group L or -Sp-P,
L in each case, independently of one another, denotes H, F, Cl, Br, I, —CN, —NO₂, —NCO, —NCS, —OCN, —SCN, —C(═O)N(R⁰)₂, —C(═O)R⁰, optionally substituted silyl, optionally substituted aryl or cycloalkyl having 3 to 20 C atoms, or straight-chain or branched alkyl, alkoxy, alkylcarbonyl, alkoxycarbonyl, alkylcarbonyloxy or alkoxycarbonyloxy having 1 to 25 C atoms, in which, in addition, one or more H atoms may each be replaced by F or Cl,
P denotes a polymerizable group,
Sp denotes a spacer group or a single bond,
Z², Z³ in each case, independently of one another, denotes a single bond, —O—, —S—, —CO—, —CO—O—, —OCO—, —O—CO—O—, —OCH₂—, —CH₂O—, —SCH₂—, —CH₂S—, —CF₂O—, —OCF₂—, —CF₂S—, —SCF₂—, —(CH₂)ₙ₁—, —CF₂CH₂—, —CH₂CF₂—, —(CF₂)ₙ₁—, —CH═CH—, —CF═CF—, —C≡C—, —CH═CH—COO—, —OCO—CH═CH—, —(CR⁰R⁰⁰)ₙ₁—, —CH(-Sp-P)—, —CH₂CH(-Sp-P)—, or —CH(-Sp-P)CH(Sp-P)—,
n1 denotes 1, 2, 3 or 4,
m denotes 0, 1, 2, 3, 4, 5 or 6,
n denotes 0 or 1,
R⁰ in each case, independently of one another, denotes alkyl having 1 to 12 C atoms,
R⁰⁰ in each case, independently of one another, denotes H or alkyl having 1 to 12 C atoms,
R¹ denotes H, halogen, straight-chain, branched or cyclic alkyl having 1 to 25 C atoms, in which, in addition, one or more non-adjacent CH₂ groups may each be replaced by —O—, —S—, —CO—, —CO—O—, —O—CO—, or —O—CO—O— in such a way that O and/or S atoms are not linked directly to one another and in which, in addition, one or more H atoms may each be replaced by F or Cl, or a group -Sp-P,
R^{a} denotes an anchor group of the formula 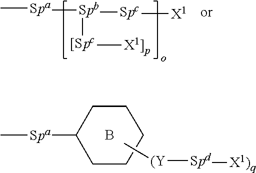
p denotes 1 or 2,
q denotes 2 or 3,
B denotes a substituted or unsubstituted ring system or condensed ring system,
Y, independently of one another, denotes —O—, —S—, —C(O)—, —C(O)O—, —OC(O)—, —NR¹¹— or a single bond,
o denotes 0 or 1,
X¹, independently of one another, denotes —SH, H, alkyl or fluoroalkyl, where at least one group X¹ denotes —SH,
R¹¹ denotes alkyl having 1 to 12 C atoms,
Sp^{a}, Sp^{c}, Sp^{d} each, independently of one another, denote a spacer group or a single bond, and
and
Sp^{b} denotes a tri- or tetravalent group.

2. LC medium according to claim 1, characterised in that it additionally comprises a polymerizable or polymerized component, where the polymerized component is obtainable by polymerization of a polymerizable component.

3. The medium according to claim 1, wherein, in formula I,
A¹, A², A³ each, independently of one another, denote 1,4-phenylene, naphthalene-1,4-diyl or naphthalene-2,6-diyl, where, in addition, one or more CH groups in these groups may each be replaced by N, cyclohexane-1,4-diyl, in which, in addition, one or more non-adjacent CH₂ groups may each be replaced by O or S, 3,3′-bicyclobutylidene, 1,4-cyclohexenylene, bicyclo[1.1.1]pentane-1,3-diyl, bicyclo[2.2.2]octane-1,4-diyl, spiro[3.3]heptane-2,6-diyl, piperidine-1,4-diyl, decahydronaphthalene-2,6-diyl, 1,2,3,4-tetrahydronaphthalene-2,6-diyl, indane-2,5-diyl or octahydro-4,7-methanoindane-2,5-diyl, perhydrocyclopenta[a]phenanthrene-3,17-diyl (in particular gonane-3,17-diyl),
where all these groups may be unsubstituted or mono- or polysubstituted by a group L or -Sp-P.

4. The medium according to claim 1, wherein the compound of the formula I is a compound of formula I1, 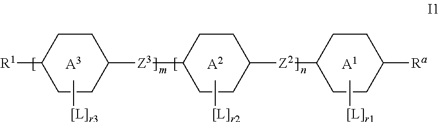
in which
R¹, R^{a}, A¹, A², A³, Z², Z³, L, m and n independently are as defined, and
r1, r2, r3 independently denote 0, 1, 2 or 3.

5. The medium according to claim 1, wherein the one or more compounds of the formula I are selected from compounds of formulae IA, IB, IC, ID and IE: 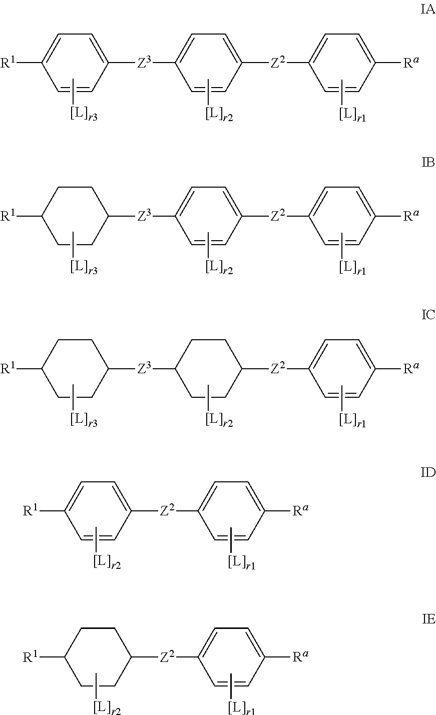
in which R¹, R^{a}, Z², Z³, L independently are as defined, and
r1, r2, r3 independently denote 0, 1, 2 or 3.

6. The medium according to claim 1, wherein, besides said one or more compounds of formula I, said medium further comprises one or more compounds of formula IX,
R¹²-[A³¹-Z³¹]ₘ-[A²¹-Z²¹]ₙ-A¹¹-R^{a1} (IX)
in which
A¹¹, A²¹, A³¹ each, independently of one another, denote an aromatic, heteroaromatic, alicyclic or heterocyclic group, which may also contain fused rings, and which may also be mono- or polysubstituted by a group L or -Sp-P,
P denotes a polymerizable group,
Sp denotes a spacer group or a single bond,
Z²¹, Z³¹ in each case, independently of one another, denotes a single bond, —O—, —S—, —CO—, —CO—O—, —OCO—, —O—CO—O—, —OCH₂—, —CH₂O—, —SCH₂—, —CH₂S—, —CF₂O—, —OCF₂—, —CF₂S—, —SCF₂—, —(CH₂)ₙ₁—, —CF₂CH₂—, —CH₂CF₂—, —(CF₂)ₙ₁—, —CH═CH—, —CF═CF—, —C≡C—, —CH═CH—COO—, —OCO—CH═CH—, —(CR⁰R⁰⁰)ₙ₁—, —CH(-Sp-P)—, —CH₂CH(-Sp-P)—, or —CH(-Sp-P)CH(-Sp-P)—,
n1 denotes 1, 2, 3 or 4,
L in each case, independently of one another, denotes H, F, Cl, Br, I, —CN, —NO₂, —NCO, —NCS, —OCN, —SCN, —C(═O)N(R⁰)₂, —C(═O)R⁰, optionally substituted silyl, optionally substituted aryl or cycloalkyl having 3 to 20 C atoms, or straight-chain or branched alkyl, alkoxy, alkylcarbonyl, alkoxycarbonyl, alkylcarbonyloxy or alkoxycarbonyloxy having 1 to 25 C atoms, in which, in addition, one or more H atoms may each be replaced by F or Cl,
R⁰ in each case, independently of one another, denotes alkyl having 1 to 12 C atoms, and
R⁰⁰ in each case, independently of one another, denotes H or alkyl having 1 to 12 C atoms,
m denotes 0, 1, 2, 3, 4, 5 or 6,
n denotes 0 or 1,
R¹² denotes H, halogen, straight-chain, branched or cyclic alkyl having 1 to 25 C atoms, in which, in addition, one or more non-adjacent CH₂ groups may each be replaced by —O—, —S—, —CO—, —CO—O—, —O—CO—, or —O—CO—O— in such a way that O and/or S atoms are not linked directly to one another and in which, in addition, one or more H atoms may each be replaced by F or Cl, or a group -Sp-P,
R^{a1} denotes an anchor group of the formula 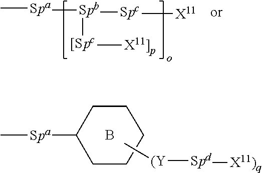
p denotes 1 or 2,
q denotes 2 or 3,
B denotes a substituted or unsubstituted ring system or condensed ring system,
Y independently of one another, denotes —O—, —S—, —C(O)—, —C(O)O—, —OC(O)—, —NR¹¹— or a single bond,
o denotes 0 or 1,
X¹¹, independently of one another, denotes H, alkyl, fluoroalkyl, OH, NH₂, NHR¹¹, NR¹¹₂, OR^{aa}, C(O)OH, or —CHO,
where at least one group X¹ denotes a radical selected from —OH, —NH₂, NHR¹¹, C(O)OH and —CHO,
R¹¹ denotes alkyl having 1 to 12 C atoms,
Sp^{a}, Sp^{c}, Sp^{d} each, independently of one another, denote a spacer group or a single bond,
and
Sp^{b} denotes a tri- or tetravalent group, preferably CH, N or C.

7. The medium according to claim 1, wherein said one or more compounds of formula I comprise one or more compounds selected from the following formulae IA to IE: 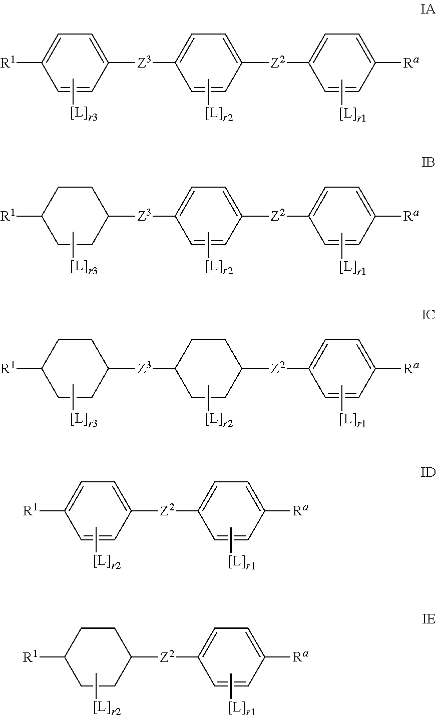
in which L, R^{a} and Z² independently are as defined in claim 1, and
Z³ denotes a single bond or —CH₂CH₂—,
r1, r2, r3 independently denote 0, 1, 2 or 3, and
R¹ denotes H, halogen, straight-chain, branched or cyclic alkyl having 1 to 25 C atoms, in which, in addition, one or more non-adjacent CH₂ groups may each be replaced by —O—, —S—, —CO—, —CO—O—, —O—CO—, or —O—CO—O— in such a way that O and/or S atoms are not linked directly to one another and in which, in addition, one or more H atoms may each be replaced by F or Cl.

8. The medium according to claim 1, wherein group R^{a} in formula I contains one, two or three SH groups.

9. The medium according to claim 1, wherein group R^{a} denotes a group selected from
Sp^{a}-X¹ and 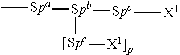
in which Sp^{a}, Sp^{b}, Sp^{c}, p and X¹ have the meaning as defined in claim 1.

10. The medium according to claim 1, wherein group R^{a} denotes a group selected from the following part-formulae:

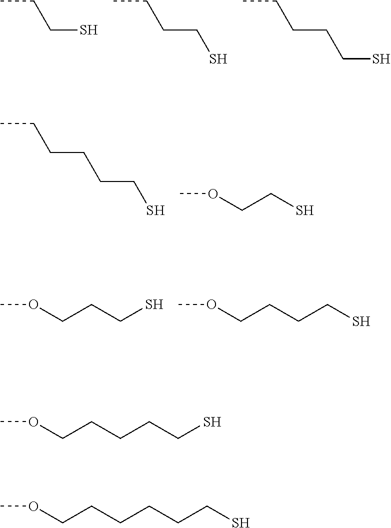

11. The medium according to claim 1, wherein, for the compound of the formula I, Z² is a single bond.

12. The medium according to claim 1, wherein said medium comprises compounds of formula I in a concentration of less than 10% by weight.

13. The medium according to claim 1, wherein said medium comprises one or more polymerizable compounds of formula M or a (co)polymer comprising compounds of formula M:
P¹-Sp¹-A²-(Z¹-A¹)ₙ-Sp²-P² M
in which the individual radicals have the following meanings:
P¹, P² each independently denote a polymerizable group,
Sp¹, Sp² each independently denote a spacer group,
A¹, A² each, independently of one another, denote a radical selected from the following groups:
a) the group consisting of trans-1,4-cyclohexylene, 1,4-cyclohexenylene and 4,4′-bicyclohexylene, in which, in addition, one or more non-adjacent CH₂ groups may each be replaced by —O— or —S— and in which, in addition, one or more H atoms may each be replaced by a group L, or selected from 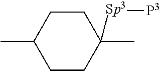
b) the group consisting of 1,4-phenylene and 1,3-phenylene, in which, in addition, one or two CH groups may each be replaced by N and in which, in addition, one or more H atoms may each be replaced by a group L or -Sp³-P,
c) the group consisting of tetrahydropyran-2,5-diyl, 1,3-dioxane-2,5-diyl, tetrahydrofuran-2,5-diyl, cyclobutane-1,3-diyl, piperidine-1,4-diyl, thiophene-2,5-diyl and selenophene-2,5-diyl, each of which may also be mono- or polysubstituted by a group L,
d) the group consisting of saturated, partially unsaturated or fully unsaturated, and optionally substituted, polycyclic radicals having 5 to 20 cyclic C atoms, one or more of which may, in addition, be replaced by heteroatoms, preferably selected from the group consisting of bicyclo[1.1.1]pentane-1,3-diyl, bicyclo[2.2.2]octane-1,4-diyl, spiro[3.3]heptane-2,6-diyl, 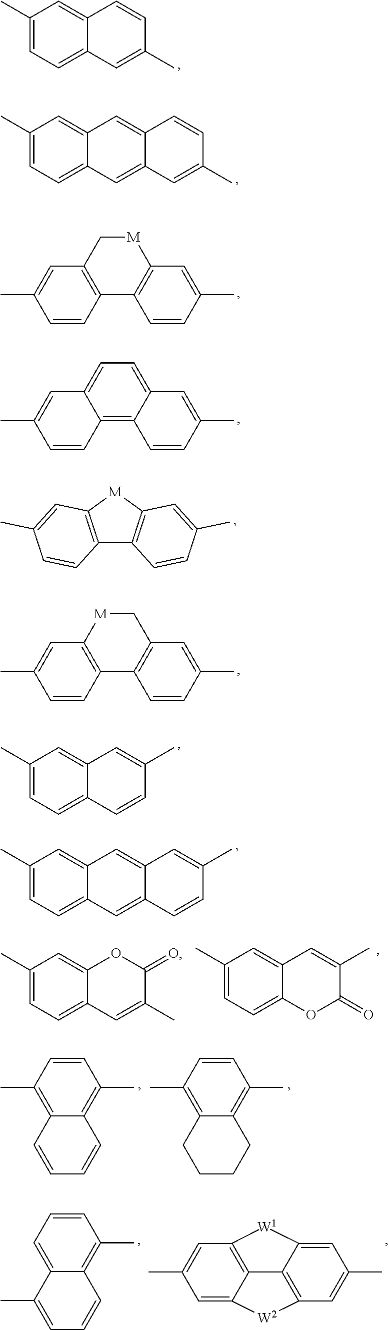 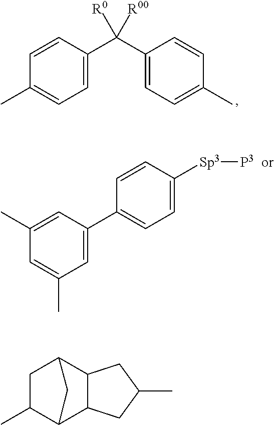
where, in addition, one or more H atoms in these radicals may each be replaced by a group L or -Sp³-P, and/or one or more double bonds may each be replaced by single bonds, and/or one or more CH groups may each be replaced by N,
P³ denotes a polymerizable group,
Sp³ denotes a spacer group,
n denotes 0, 1, 2 or 3,
Z¹ in each case, independently of one another, denotes —CO—O—, —O—CO—, —CH₂O—, —OCH₂—, —CF₂O—, —OCF₂—, —(CH₂)ₙ— where n is 2, 3 or 4, —O—, —CO—, —C(R^{c}R^{d})—, —CH₂CF₂—, —CF₂CF₂— or a single bond,
L on each occurrence, identically or differently, denotes F, Cl, CN, SCN, SF₅ or straight-chain or branched, in each case optionally fluorinated, alkyl, alkoxy, alkylcarbonyl, alkoxycarbonyl, alkylcarbonyloxy or alkoxycarbonyloxy having 1 to 12 C atoms,
M denotes —O—, —S—, —CH₂—, —CHY¹— or —CY¹Y²—,
Y¹ and Y² each, independently of one another, have one of the meanings indicated above for R⁰ or denote Cl or CN,
W¹, W² each, independently of one another, denote —CH₂CH₂—, —CH═CH—, —CH₂—O—, —O—CH₂—, —C(R^{c}R^{d})— or —O—,
R^{c} and R^{d} each, independently of one another, denote H, F, CF₃, or alkyl having 1 to 6 C atoms, preferably H, methyl or ethyl,
where one or more of the groups P¹—Sp¹-, -Sp²-P² and -Sp³-P³ may denote a radical R^{aa}, with the proviso that at least one of the groups P¹—Sp¹-, -Sp²-P² and -Sp³-P³ present does not denote R^{aa},
R^{aa} denotes H, F, Cl, CN or straight-chain or branched alkyl having 1 to 25 C atoms, in which, in addition, one or more non-adjacent CH₂ groups may each be replaced, independently of one another, by C(R⁰)═C(R⁰), —C≡C—, —O—, —S—, —CO—, —CO—O—, —O—CO—, or —O—CO—O— in such a way that O and/or S atoms are not linked directly to one another, and in which, in addition, one or more H atoms may each be replaced by F, Cl, CN or P¹—Sp¹-, where the groups —OH, —NH₂, —SH, —NHR, —C(O)OH and —CHO are not present in R^{aa}, and
R⁰, R⁰⁰ each, independently of one another, denote H, F or straight-chain or branched alkyl having 1 to 12 C atoms, in which, in addition, one or more H atoms each may be replaced by F.

14. The medium according to claim 13, wherein the polymerizable or polymerized component comprises 0.01 to 5% by weight of one or more compounds of the formula M.

15. A liquid-crystal (LC) display comprising an LC cell having two substrates and at least two electrodes, where at least one substrate is transparent to light and at least one substrate has one or two electrodes, and having a layer of an LC medium according to claim 1 located between the substrates,
where the compound of the formula I is suitable for effecting homeotropic alignment of the LC medium with respect to the substrate surfaces.

16. The display according to claim 15, wherein the substrates have no alignment layers for homeotropic alignment.

17. The display according to claim 15, wherein one or two of the substrates is coated with indium-tin oxide.

18. The display according to claim 15, wherein said display is a VA display containing an LC medium having negative dielectric anisotropy and electrodes arranged on opposite substrates.

19. A process for the preparation of a liquid-crystal medium, said process comprising mixing one or more compounds of the formula I according to claim 1 with a low-molecular-weight liquid-crystalline component, and
optionally one or more polymerizable compounds, and/or one or more compounds of the formula IX, and/or other additives are added.

20. A compound of formula I
R¹-[A³-Z³]ₘ-[A²-Z²]ₙ-A¹-R^{a} (I)
in which
A¹, A², A³ each, independently of one another, denote an aromatic, heteroaromatic, alicyclic or heterocyclic group, which may also contain fused rings, and which may also be mono- or polysubstituted by a group L or -Sp-P,
L in each case, independently of one another, denotes H, F, Cl, Br, I, —CN, —NO₂, —NCO, —NCS, —OCN, —SCN, —C(═O)N(R⁰)₂, —C(═O)R⁰, optionally substituted silyl, optionally substituted aryl or cycloalkyl having 3 to 20 C atoms, or straight-chain or branched alkyl, alkoxy, alkylcarbonyl, alkoxycarbonyl, alkylcarbonyloxy or alkoxycarbonyloxy having 1 to 25 C atoms, in which, in addition, one or more H atoms may each be replaced by F or Cl,
P denotes a polymerizable group,
Sp denotes a spacer group or a single bond,
Z² in each case, independently of one another, denotes —O—, —S—, —CO—, —CO—O—, —OCO—, —O—CO—O—, —OCH₂—, —CH₂O—, —SCH₂—, —CH₂S—, —CF₂O—, —OCF₂—, —CF₂S—, —SCF₂—, —(CH₂)ₙ₁—, —CF₂CH₂—, —CH₂CF₂—, —(CF₂)ₙ₁—, —CH═CH—, —CF═CF—, —C≡C—, —CH═CH—COO—, —OCO—CH═CH—, —(CR⁰R⁰⁰)ₙ₁—, —CH(-Sp-P)—, —CH₂CH(-Sp-P)—, or —CH(-Sp-P)CH(-Sp-P)—,
Z³ in each case, independently of one another, denotes a single bond, —O—, —S—, —CO—, —CO—O—, —OCO—, —O—CO—O—, —OCH₂—, —CH₂O—, —SCH₂—, —CH₂S—, —CF₂O—, —OCF₂—, —CF₂S—, —SCF₂—, —(CH₂)ₙ₁—, —CF₂CH₂—, —CH₂CF₂—, —(CF₂)ₙ₁—, —CH═CH—, —CF═CF—, —C≡C—, —CH═CH—COO—, —OCO—CH═CH—, —(CR⁰R⁰⁰)ₙ₁—, —CH(-Sp-P)—, —CH₂CH(-Sp-P)—, or —CH(-Sp-P)CH(-Sp-P)—,
n1 denotes 1, 2, 3 or 4,
m denotes 1, 2, 3, 4, 5 or 6,
n denotes 1,
R⁰ in each case, independently of one another, denotes alkyl having 1 to 12 C atoms,
R⁰⁰ in each case, independently of one another, denotes H or alkyl having 1 to 12 C atoms,
R¹, independently of one another, denotes H, halogen, straight-chain, branched or cyclic alkyl having 1 to 25 C atoms, in which, in addition, one or more non-adjacent CH₂ groups may each be replaced by —O—, —S—, —CO—, —CO—O—, —O—CO—, or —O—CO—O— in such a way that O and/or S atoms are not linked directly to one another and in which, in addition, one or more H atoms may each be replaced by F or Cl,
or a group -Sp-P,
R^{a} denotes an anchor group of the formula 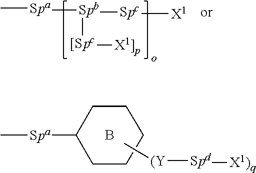
p denotes 1 or 2,
q denotes 2 or 3,
B denotes a substituted or unsubstituted ring system or condensed ring system,
Y, independently of one another, denotes —O—, —S—, —C(O)—, —C(O)O—, —OC(O)—, —NR¹¹— or a single bond,
o denotes 0 or 1,
X¹, independently of one another, denotes —SH, H, alkyl, fluoroalkyl, OH, NH₂, NHR¹¹, NR¹¹₂, OR¹¹, C(O)OH, —CHO,
where at least one group X¹ denotes a —SH,
R¹¹ denotes alkyl having 1 to 12 C atoms,
Sp^{a}, Sp^{c}, Sp^{d} each, independently of one another, denote a spacer group or a single bond, and
Sp^{b} denotes a tri- or tetravalent group.

21. A compound according to claim 20, wherein m is 1.

22. A compound according to claim 21, wherein A¹ and A² independently denote 1,4-phenylene or cyclohexane-1,4-diyl, each of which may be mono- or polysubstituted by a group L or -Sp-P.

23. A method for effecting homeotropic alignment of a liquid-crystal medium with respect to a surface delimiting the liquid-crystal medium, comprising adding to said medium one or more compounds of formula I according to claim 1.

24. A process for the production of an LC display comprising an LC cell having two substrates and at least two electrodes, where at least one substrate is transparent to light and at least one substrate has one or two electrodes, said process comprising the steps:
filling of the cell with a liquid-crystal medium according to claim 1, where homeotropic alignment of the liquid-crystal medium with respect to the substrate surfaces is established,
optionally heating the medium, and
optionally polymerizing the polymerizable component(s), optionally with application of a voltage to the cell or under the action of an electric field, in one or more process steps.
